(19) United States
(12) Patent Application Publication
(10) Pub. No.: US 2014/0120331 A1
(43) Pub. Date: May 1, 2014

(54) INK FOR INKJET RECORDING

(71) Applicants: Yuusuke KOIZUKA, Shizuoka (JP); Kazukiyo Nagai, Shizuoka (JP); Mitsuru Naruse, Shizuoka (JP); Masayasu Nonogaki, Shizuoka (JP); Minoru Hakiri, Shizuoka (JP); Akihiko Matsuyama, Shizuoka (JP); Keita Katoh, Shizuoka (JP)

(72) Inventors: Yuusuke KOIZUKA, Shizuoka (JP); Kazukiyo Nagai, Shizuoka (JP); Mitsuru Naruse, Shizuoka (JP); Masayasu Nonogaki, Shizuoka (JP); Minoru Hakiri, Shizuoka (JP); Akihiko Matsuyama, Shizuoka (JP); Keita Katoh, Shizuoka (JP)

(21) Appl. No.: 14/044,252

(22) Filed: Oct. 2, 2013

(30) Foreign Application Priority Data
Oct. 31, 2012 (JP) 2012-239935
Dec. 19, 2012 (JP) 2012-276871
Mar. 15, 2013 (JP) 2013-052710

(51) Int. Cl. C09D 11/00

(52) U.S. Cl. CPC C09D 11/30
USPC 428/207; 524/547; 347/86; 347/20

(57) ABSTRACT

An ink for inkjet recording includes water, a water-soluble solvent, a pigment and a copolymer including a salt of phosphonic acid group. The copolymer including a salt of phosphonic acid group includes structural units having the following formulae (1) and (2) or (3):

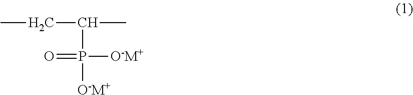

wherein not less than half or all of M⁺ represent a cation of alkali metals or an organic ammonium ion, and the rest represents proton;

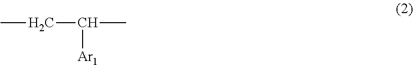

wherein Ar₁ represents a monovalent group of benzene or naphthalene; and

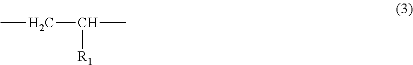

wherein R₁ represents an alkyl group having 5 to 20 carbon atoms.

### CROSS-REFERENCE TO RELATED APPLICATIONS

This patent application is based on and claims priority pursuant to 35 U.S.C. §119 to Japanese Patent Application Nos. 2012-239935, 2012-276871 and 2013-052710, filed on Oct. 31, 2012, Dec. 19, 2012 and Mar. 15, 2013, respectively in the Japan Patent Office, the entire disclosure of which is hereby incorporated by reference herein.

### BACKGROUND

1. Technical Field

The present invention relates to an ink for inkjet recording.

2. Description of the Related Art

Recently, inkjet recording methods have been popular as image forming methods because of having advantages of having simpler process and easier full-colorization than the other recording methods, and producing high-resolution images even with an apparatus having simple composition. The inkjet recording methods have a small amount of ink soar and adhere to recording media such as papers to form images thereon with an inkjet recorder, and applications thereof are expanding, e.g., personal and industrial printers and printings.

In the inkjet recorder, an aqueous ink using a water-soluble dye is mostly used as a colorant. However, the ink has disadvantages of having poor weatherability and water resistance. Therefore, a pigment ink using a pigment instead of the water-soluble dye has been studied recently. However, the pigment ink is still inferior to the dye ink in colorability, ink discharge stability and preservation stability. In company with improvement of higher-quality image technology of OA printers, even when recorded on plain papers as recording media with the pigment ink, image density equivalent to that of the dye ink is required. However, the pigment ink penetrates into a plain paper as a recording medium and pigment density at the surface of the paper lowers, resulting in lower image density. In order to dry the ink adhering to the recording medium quicker to print quicker, a penetrant is added to the ink for water to penetrate into the recording medium. Then, not only water but also pigment penetrates deeper into the recording medium, resulting in lower image density.

Various methods are disclosed to improve image density. For example, Japanese published unexamined application No. JP-2011-122072-A discloses an ink used for recording on a paper including a water-soluble multivalent metal salt. The ink includes (a) a pigment and (b) at least one compound having no surface activating ability, a molecular weight of from 150 to 10,000, and a content rate of phosphorous ((p/molecular weight)×100) from a functional group selected from a functional group having a basic skeleton of phosphoric acid and functional group having a basic skeleton of phosphonic acid not less than 1.4. Further, the ink includes the (b) compound of from 1.5 to 10.0% by weight.

However, the method disclosed in Japanese published unexamined application No. JP-2011-122072-A doe not sufficiently improve image density on a plain paper having a low content rate of a water-soluble multivalent metal salt. When the compound having a functional group selected from a functional group having a basic skeleton of phosphoric acid and functional group having a basic skeleton of phosphonic acid, the image density improves, but a pigment is not stably dispersed in an ink. The unstably-dispersed pigment in an ink deteriorates preservation stability thereof.

Namely, Japanese published unexamined application No. JP-2011-122072-A does not achieve high image density and stable dispersion of a pigment in an ink.

Because of these reasons, a need exists for an ink for inkjet recording producing images having high image density, and in which a pigment is stably dispersed to have good preservation stability.

### SUMMARY

Accordingly, one object of the present invention is to provide an ink for inkjet recording producing images having high image density, and in which a pigment is stably dispersed to have good preservation stability.

Another object of the present invention is to provide an ink container containing the ink.

A further object of the present invention is to provide an inkjet recorder using the ink.

Another object of the present invention is to provide a method of preparing recorded matters using the ink.

A further object of the present invention is to provide a recorded matter using the ink.

These objects and other objects of the present invention, either individually or collectively, have been satisfied by the discovery of an ink for inkjet recording, including water; a water-soluble solvent; a pigment; and a copolymer including a salt of phosphonic acid group. The copolymer including a salt of phosphonic acid group includes structural units having the following formulae (1) and (2) or (3):

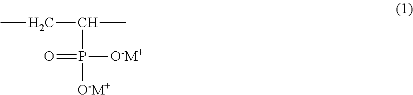

wherein not less than half or all of M⁺ represent a cation of alkali metals or an organic ammonium ion, and the rest represents proton;

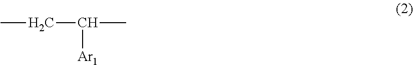

wherein Ar₁ represents a monovalent group of benzene or naphthalene; and

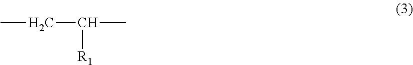

wherein R₁ represents an alkyl group having 5 to 20 carbon atoms.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic plain view illustrating an embodiment of the ink container of the present invention;

FIG. 2 is a schematic plain view illustrating the ink container of the present invention including a case (outer package) in FIG. 1;

FIG. 3 is a perspective view illustrating an embodiment of the inkjet recorder of the present invention;

FIG. 4 is a schematic view illustrating an overall structure of the inkjet recorder in FIG. 3;

FIG. 5 is an enlarged partial view of the inkjet recorder in FIG. 3;

FIG. 6 is a schematic plain view illustrating an embodiment of a recording head (two-head type) equipped in the inkjet recorder of the present invention;

FIG. 7 is a schematic plain view illustrating another embodiment of a recording head (four-head type) equipped in the inkjet recorder of the present invention;

FIG. 8 is a perspective view illustrating an embodiment of the inkjet recorder having a maintenance and recovery device of the present invention;

FIG. 9 is a schematic view illustrating an overall structure of the inkjet recorder in FIG. 8;

FIG. 10 is a schematic plain view illustrating a main part of the inkjet recorder in FIG. 8;

FIG. 11 is a schematic plain view illustrating a main part of a subsystem 91 including the maintenance and recovery device in the inkjet recorder of the present invention;

FIG. 12 is a schematic view illustrating the subsystem in FIG. 11;

FIG. 13 is a schematic view illustrating the right side of the subsystem in FIG. 11; and

FIG. 14 is a schematic view illustrating a side of holding and elevating mechanism of a cap 92.

### DETAILED DESCRIPTION

The present invention provides an ink for inkjet recording producing images having high image density, and in which a pigment is stably dispersed to have good preservation stability.

The structural unit having the formula (1) reacts with the multivalent metal ion eluted from recording media when the ink lands on recording media such as plain papers to form aggregation of the pigment. As a result, penetration of the pigment into a paper is prevented and the image density becomes high.

The structural unit having the formula (2) or (3) is a hydrophobic structural unit, and the copolymer including a salt of phosphonic acid group has high affinity with a pigment when including the structural unit having the formula (2) or (3). As a result, dispersion of a pigment in the ink is improved and the ink has low viscosity. Further, dispersion stability of the pigment is improved and preservation stability of the ink is improved as well.

Mechanism of the aggregation of the pigment is not clarified, but is assumed as follows.

The phosphonic acid group or salt thereof in the structural unit having the formula (1) has high affinity with the multivalent metal ion and quickly coordinates with the multivalent metal ion eluted from the recording media.

When the copolymer including a salt of phosphonic acid group of the present invention is used as a dispersant, most thereof are adsorbed to the pigment in the ink. When the phosphonic acid group or salt thereof in the structural unit having the formula (1) coordinates with the multivalent metal ion eluted from the recording media, dispersion stability of the pigment in the ink deteriorates due to one of or all of the following factors (1) to (3), resulting in aggregation of the pigment.

(1) The number of valences to ions increases and electrostatic repulsions between pigments decreases.

(2) The copolymer including a salt of phosphonic acid group of the present invention lowers in solubility in media, and polymer adsorption layer decreases and dimensional repulsions between pigments decreases.

(3) The copolymer including a salt of phosphonic acid group of the present invention lowers in solubility in media, and the pigment including it lowers in hydration stability. When the copolymer including a salt of phosphonic acid group of the present invention is used as an additive, it itself coordinates with the multivalent metal ion eluted from the recording media to form an insoluble matter, which becomes an aggregation core to cause aggregation of the pigment.

When the content rate of the structural unit having the formula (1) is low in the copolymer including a salt of phosphonic acid group of the present invention, the copolymer lowers in reactivity with the multivalent metal ion eluted from the recording media, resulting in deterioration of image density. In this respect, the content rate is preferably from 20 to 60% by weight, and more preferably from 30 to 60% by weight to improve image density and stabilize dispersion of the pigment in the ink. When greater than 60% by weight, dispersion stability of the pigment deteriorates, resulting in possible increase of viscosity and deterioration of preservation stability of the ink.

The content rate of the structural unit having the formula (2) is preferably from 15 to 70% by weight to improve dispersibility of the pigment, and viscosity and preservation stability of the ink.

The content rate of the structural unit having the formula (3) is preferably from 5 to 50% by weight to improve dispersibility of the pigment, and viscosity and preservation stability of the ink.

The copolymer including a salt of phosphonic acid group of the present invention preferably has an aqueous solution viscosity (10% by weight at 25° C.) of from 2.0 to 35 mPa·s.

The viscosity is measured by viscometer RE500L from TOKI SANGYO CO., LTD. while the number of revolution is adjusted according to the viscosity of a sample.

When the viscosity is not less than 2.0 mPa·s, the image density tends to improve. When less than 2.0 mPa·s, the copolymer including a salt of phosphonic acid group is thought to have low polymerization degree. In that case, when the copolymer reacts with multivalent metal ion eluted from the recording media, the pigment lowers in aggregating. When not greater than 35 mPa·s, dispersion stability of the pigment or preservation stability of the ink does not deteriorate.

In the copolymer including a salt of phosphonic acid group, it is essential that half or more of the phosphonic acid groups are neutralized by a base to be ionized by a cation of alkali metals or organic ammonium. All of them may be neutralized by a base to be ionized. Specific examples of the base neutralizing the phosphonic acid groups include inorganic alkaline agents, e.g., alkali metal hydroxides such as lithium hydroxide, potassium hydroxide and a sodium hydroxide, and organic amines. Specific examples of the organic amines include alkyl amines such as mono, di or trimethylamine and mono, di or triethylamine; alcohol amines such as ethanol amine, diethanolamine, triethanolamine, methylethanolamine (2-(methylamine)ethanol), methyldiethanolamine, dimethylethanolamine, monopropanolamine, dipropanolamine, tripropanolamine, isopropanolamine, trishydroxymethylaminomethane and 2-amino-2-ethyl-1,3propanedil (AEPD); and cyclic amine such as choline, morpholine, N-methylmorpholine, N-methyl-2-pyrrolidone and 2-pyrrolidone, etc.

M⁺ in the formula (1) includes alkali metal ions such as sodium ion and potassium ion, and an ammonium ion having the following formula (6):

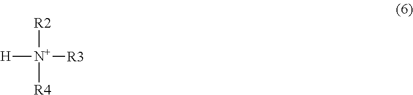

wherein each of R2, R3 and R4 represents a hydrogen atom, an alkyl group having 1 to 4 carbon atoms or a 2-hydroxyethyl group.

The copolymer including a salt of phosphonic acid group of the present invention is preferably synthesized from a vinyl phosphonic acid and a monomer having the following (4) or (5) as starting materials.

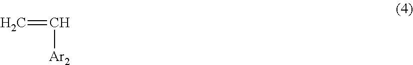

wherein Ar₂ represents a monovalent group of benzene or naphthalene;

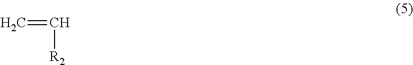

R₂ represents an alkyl group having 5 to 20 carbon atoms.

Monomers having the formula (4) include styrene, 1-vinylnaphthalene, 2-vinylnaphthalene, etc.

Monomers having the formula (5) include 1-heptene, 3,3-dimethyl-1-pentene, 4,4-dimethyl-1-pentene, 3-methyl-1-hexene, 4-methyl-1-hexene, 5-methyl-1-hexene, 1-octene, 3,3-dimethyl-1-hexene, 3,4-dimethyl-1-hexene, 4,4-dimethyl-1-hexene, 1-nonene, 3,5,5-trimethyl-1-hexene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosen, 1-dococene, etc.

The copolymer including a salt of phosphonic acid group of the present invention is polymerized by known polymerization methods such as bulk polymerization methods, solution polymerization methods, suspension polymerization methods and emulsification polymerization methods. The methods are not limited thereto, but methods using a radical polymerization initiator are preferably used because polymerization operation and molecular weight adjustment are simple. The solution polymerization methods in an organic solvent are more preferably used because the monomers having the formulae (4) and (5) are difficult to dissolve in water.

Specific preferred examples of solvents used in radical solution polymerization methods include ketone solvents such as acetone, methyl ethyl ketone and methyl isobutyl ketone; ester acetate solvents such as ethylacetate and butylacetate; aromatic hydrocarbon solvents such as benzene, toluene and xylene; isopropanol; ethanol; cyclohexane; tetrahydrofuran; dimethylformamide; dimethyl sulfoxide; hexamethylphosphoramide; etc. Ketone solvents, ester acetate solvents and alcohol solvents are more preferably used. These can be used alone or in combination.

Specific examples of radical polymerization initiators include known materials such as peroxyketal, hydroperoxide, dialkylperoxide, diacylperoxide, peroxydicarbonate, peroxyester, cyano azobisisobutylonitrile, azobis(2,2′-isovaleronitrile), non-cyano dimethyl-2,2′-azobisisobutylate, etc. Organic peroxides and azo compounds having an easily-controllable molecular weight and a low decomposition temperature are preferably used, and the azo compounds are more preferably used. The polymerization initiators are preferably used in an amount of from 1 to 10% by weight based on total weight of polymerizable monomers.

In order to control a molecular weight of the copolymer including a salt of phosphonic acid group, chain transfer agents such as mercaptoacetate, mercaptopropionate, 2-propanethiol, thiophenol, dodecylmercaptane, 1-dodecanethiol and thioglycerol may be added in a proper amount.

These monomers, initiators, chain transfer agents and solvents used in the polymerization reaction are used after refined by known methods such as dilution and chromatographic methods.

The monomers, initiators, chain transfer agents and solvents may be added at once or continuously fed through a drip funnel. The initiators may be added during the polymerization reaction when necessary.

The polymerization conditions are not simply fixed because of depending the initiators, monomers and solvents used. Typically, the polymerization temperature is preferably from 50 to 150° C., and more preferably from 60 to 100° C. The polymerization temperature may be changed during the polymerization when necessary. The polymerization time is preferably from 3 to 48 hrs.

After the polymerization reaction is finished, the produced copolymer including a salt of phosphonic acid group is isolated from the reacted solution by known methods such as reprecipitaion and solvent removal. Further, the repeated reprecipitaion, film separation, chromatographic methods, extraction methods, etc. remove unreacted monomers and low-molecular-weight components to refine the copolymer including a salt of phosphonic acid group.

A neutralizer is, for example, mixed with the copolymer including a phosphonic acid group in a solution. The copolymer including a phosphonic acid group is dissolved in an organic solvent or water to prepare a solution, and the neutralizer is directly added thereto or a solution including an organic solvent or water and the neutralizer dissolved therein is added thereto and stirred therein. Then, an organic solvent is removed therefrom to obtain the copolymer including a salt of phosphonic acid group.

The neutralizer is added such that a half or more of M in the copolymer including a phosphonic acid group is an alkali metal salt or an organic ammonium salt.

A neutralization index of the phosphonic acid group in the copolymer including a salt of phosphonic acid group is defined by the following formula in the present invention.

Neutralization index X (%)=(molar number of added base*valence of cation of base)/(molar number of vinyl phosphonic acid included in the copolymer*2)*100

Molar number of added base=Added amount of base Y g/Molecular weight of base

Molar number of vinyl phosphonic acid included in the copolymer=Added amount of vinyl phosphonic acid Z g/Molecular weight of vinyl phosphonic acid

Therefore, the amount of base required to obtain the neutralization index X % is as follows.

Added amount of base Y g=Neutralization index X (%)*(Added amount of vinyl phosphonic acid Z g*2)*Molecular weight of base/(valence of cation of base*100*Molecular weight of vinyl phosphonic acid)

A neutralization index of a phosphoric acid group in a copolymer including a salt of phosphoric acid group is defined by the same formula in which vinyl phosphonic acid is replaced with a monomer including a phosphoric acid group.

Specific compositional combinations of M in the formula (1) and Ar₁ in the formula (2) when the copolymer including a salt of phosphonic acid group in the present invention has structural units having the formulae (1) and (2) are shown in Tables 1-1 and 1-2.

TABLE 1-1

| | M | Ar1 |
|---|---|---|
| 1-1 | Na | 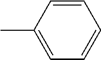 |
| 1-2 | Na, H | 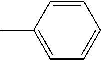 |
| 1-3 | K | 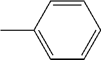 |
| 1-4 | K, H | 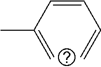 |
| 1-5 | NH(CH2CH2OH)3 | 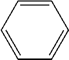 |
| 1-6 | NH(Me)3, H | 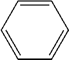 |
| 1-7 | NH2(CH2CH2OH)2 | 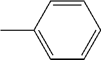 |
| 1-8 | NH(Et)3, H | 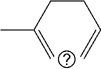 |
| 1-9 | Na | 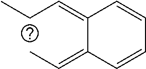 |
| 1-10 | Na, H | 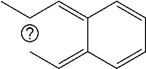 |
| 1-11 | K | 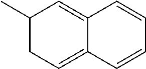 |
| 1-12 | K, H | 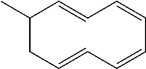 |
| 1-13 | NH(CH2CH2OH)3 | 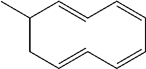 |
| 1-14 | NH(Me)3, H | 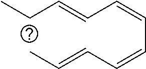 |
| 1-15 | NH2(CH2CH2OH)2 | 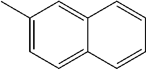 |
| 1-16 | NH(Et)3, H | 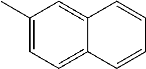 |

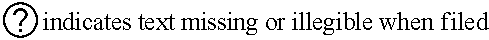

TABLE 1-2

| | M | Ar1 |
|---|---|---|
| 1-17 | Na | 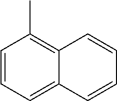 |
| 1-18 | Na, H | 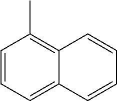 |
| 1-19 | K | 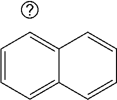 |
| 1-20 | K, H | 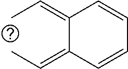 |
| 1-21 | NH(CH2CH2OH)3 | 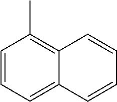 |
| 1-22 | NH(Me)3, H | 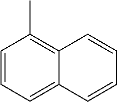 |
| 1-23 | NH2(CH2CH2OH)2 | 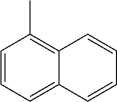 |
| 1-24 | NH(Et)3, H | 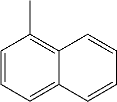 |

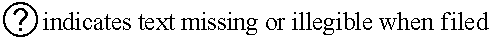

These combinations can be used even when composition ratio and molecular weight of the formulae (1) and (2) are changed. These combinations have the same effects.

Specific compositional combinations of M in the formula (1) and R₁ in the formula (3) when the copolymer including a salt of phosphonic acid group in the present invention has structural units having the formulae (1) and (3) are shown in Tables 2-1 and 2-4.

TABLE 2-1

| | M | R1 |
|---|---|---|
| 2-1 | Na | n-C5H11 |
| 2-2 | Na | C(Me)2CH2CH3 |
| 2-3 | Na | CH2C(Me)2CH3 |
| 2-4 | Na | CH(Me)CH2CH2CH3 |
| 2-5 | Na | CH2CH(Me)CH2CH3 |
| 2-6 | Na | CH2CH2CH(Me)CH3 |
| 2-7 | Na | n-C5H13 |
| 2-8 | Na | C(Me)2CH2CH2CH3 |
| 2-9 | Na | CH(Me)CH(Me)CH2CH3 |
| 2-10 | Na | CH2C(Me)2CH2CH3 |
| 2-11 | Na | n-C7H15 |
| 2-12 | Na | CH(Me)CH2C(Me)2CH3 |
| 2-13 | Na | n-C8H17 |
| 2-14 | Na | n-C9H19 |
| 2-15 | Na | n-C10H21 |
| 2-16 | Na | n-C11H23 |
| 2-17 | Na | n-C12H25 |
| 2-18 | Na | n-C13H27 |
| 2-19 | Na | n-C14H29 |
| 2-20 | Na | n-C15H31 |
| 2-21 | Na | n-C16H33 |
| 2-22 | Na | n-C17H35 |
| 2-23 | Na | n-C18H37 |
| 2-24 | Na | n-C20H41 |
| 2-25 | Na, H | n-C5H11 |
| 2-26 | Na, H | C(Me)2CH2CH3 |
| 2-27 | Na, H | CH2C(Me)2CH3 |
| 2-28 | Na, H | CH(Me)CH2CH2CH3 |
| 2-29 | Na, H | CH2CH(Me)CH2CH3 |
| 2-30 | Na, H | CH2CH2CH(Me)CH3 |
| 2-31 | Na, H | n-C5H13 |
| 2-32 | Na, H | C(Me)2CH2CH2CH3 |
| 2-33 | Na, H | CH(Me)CH(Me)CH2CH3 |
| 2-34 | Na, H | CH2C(Me)2CH2CH3 |
| 2-35 | Na, H | n-C7H15 |
| 2-36 | Na, H | CH(Me)CH2C(Me)2CH3 |
| 2-37 | Na, H | n-C8H17 |
| 2-38 | Na, H | n-C9H19 |
| 2-39 | Na, H | n-C10H21 |
| 2-40 | Na, H | n-C11H23 |
| 2-41 | Na, H | n-C12H25 |
| 2-42 | Na, H | n-C13H27 |
| 2-43 | Na, H | n-C14H29 |
| 2-44 | Na, H | n-C15H31 |
| 2-45 | Na, H | n-C16H33 |
| 2-46 | Na, H | n-C17H35 |
| 2-47 | Na, H | n-C18H37 |
| 2-48 | Na, H | n-C20H41 |

TABLE 2-2

| | M | R1 |
|---|---|---|
| 2-49 | K | n-C5H11 |
| 2-50 | K | C(Me)2CH2CH3 |
| 2-51 | K | CH2C(Me)2CH3 |
| 2-52 | K | CH(Me)CH2CH2CH3 |
| 2-53 | K | CH2CH(Me)CH2CH3 |
| 2-54 | K | CH2CH2CH(Me)CH3 |
| 2-55 | K | n-C5H13 |
| 2-56 | K | C(Me)2CH2CH2CH3 |
| 2-57 | K | CH(Me)CH(Me)CH2CH3 |
| 2-58 | K | CH2C(Me)2CH2CH3 |
| 2-59 | K | n-C7H15 |
| 2-60 | K | CH(Me)CH2C(Me)2CH3 |
| 2-61 | K | n-C8H17 |
| 2-62 | K | n-C9H19 |
| 2-63 | K | n-C10H21 |
| 2-64 | K | n-C11H23 |
| 2-65 | K | n-C12H25 |
| 2-66 | K | n-C13H27 |
| 2-67 | K | n-C14H29 |
| 2-68 | K | n-C15H31 |
| 2-69 | K | n-C16H33 |
| 2-70 | K | n-C17H35 |
| 2-71 | K | n-C18H37 |
| 2-72 | K | n-C20H41 |
| 2-73 | K, H | n-C5H11 |
| 2-74 | K, H | C(Me)2CH2CH3 |
| 2-75 | K, H | CH2C(Me)2CH3 |
| 2-76 | K, H | CH(Me)CH2CH2CH3 |
| 2-77 | K, H | CH2CH(Me)CH2CH3 |
| 2-78 | K, H | CH2CH2CH(Me)CH3 |
| 2-79 | K, H | n-C5H13 |
| 2-80 | K, H | C(Me)2CH2CH2CH3 |
| 2-81 | K, H | CH(Me)CH(Me)CH2CH3 |
| 2-82 | K, H | CH2C(Me)2CH2CH3 |
| 2-83 | K, H | n-C7H15 |
| 2-84 | K, H | CH(Me)CH2C(Me)2CH3 |
| 2-85 | K, H | n-C8H17 |
| 2-86 | K, H | n-C9H19 |
| 2-87 | K, H | n-C10H21 |
| 2-88 | K, H | n-C11H23 |
| 2-89 | K, H | n-C12H25 |
| 2-90 | K, H | n-C13H27 |
| 2-91 | K, H | n-C14H29 |
| 2-92 | K, H | n-C15H31 |
| 2-93 | K, H | n-C16H33 |
| 2-94 | K, H | n-C17H35 |
| 2-95 | K, H | n-C18H37 |
| 2-96 | K, H | n-C20H41 |

TABLE 2-3

| | M | R1 |
|---|---|---|
| 2-97 | NH(CH2CH2OH)3 | n-C5H11 |
| 2-98 | NH(CH2CH2OH)3 | C(Me)2CH2CH3 |
| 2-99 | NH(CH2CH2OH)3 | CH2C(Me)2CH3 |
| 2-100 | NH(CH2CH2OH)3 | CH(Me)CH2CH2CH3 |
| 2-101 | NH(CH2CH2OH)3 | CH2CH(Me)CH2CH3 |
| 2-102 | NH(CH2CH2OH)3 | CH2CH2CH(Me)CH3 |
| 2-103 | NH(CH2CH2OH)3 | n-C5H13 |
| 2-104 | NH(CH2CH2OH)3 | C(Me)2CH2CH2CH3 |
| 2-105 | NH(CH2CH2OH)3 | CH(Me)CH(Me)CH2CH3 |
| 2-106 | NH(CH2CH2OH)3 | CH2C(Me)2CH2CH3 |
| 2-107 | NH(CH2CH2OH)3 | n-C7H15 |
| 2-108 | NH(CH2CH2OH)3 | CH(Me)CH2C(Me)2CH3 |
| 2-109 | NH(CH2CH2OH)3 | n-C8H17 |
| 2-110 | NH(CH2CH2OH)3 | n-C9H19 |
| 2-111 | NH(CH2CH2OH)3 | n-C10H21 |
| 2-112 | NH(CH2CH2OH)3 | n-C11H23 |
| 2-113 | NH(CH2CH2OH)3 | n-C12H25 |
| 2-114 | NH(CH2CH2OH)3 | n-C13H27 |
| 2-115 | NH(CH2CH2OH)3 | n-C14H29 |
| 2-116 | NH(CH2CH2OH)3 | n-C15H31 |
| 2-117 | NH(CH2CH2OH)3 | n-C16H33 |
| 2-118 | NH(CH2CH2OH)3 | n-C17H35 |
| 2-119 | NH(CH2CH2OH)3 | n-C18H37 |
| 2-120 | NH(CH2CH2OH)3 | n-C20H41 |
| 2-121 | NH(Me)3, H | n-C5H11 |
| 2-122 | NH(Me)3, H | C(Me)2CH2CH3 |
| 2-123 | NH(Me)3, H | CH2C(Me)2CH3 |
| 2-124 | NH(Me)3, H | CH(Me)CH2CH2CH3 |
| 2-125 | NH(Me)3, H | CH2CH(Me)CH2CH3 |
| 2-126 | NH(Me)3, H | CH2CH2CH(Me)CH3 |
| 2-127 | NH(Me)3, H | n-C5H13 |
| 2-128 | NH(Me)3, H | C(Me)2CH2CH2CH3 |
| 2-129 | NH(Me)3, H | CH(Me)CH(Me)CH2CH3 |
| 2-130 | NH(Me)3, H | CH2C(Me)2CH2CH3 |
| 2-131 | NH(Me)3, H | n-C7H15 |
| 2-132 | NH(Me)3, H | CH(Me)CH2C(Me)2CH3 |
| 2-133 | NH(Me)3, H | n-C8H17 |
| 2-134 | NH(Me)3, H | n-C9H19 |
| 2-135 | NH(Me)3, H | n-C10H21 |
| 2-136 | NH(Me)3, H | n-C11H23 |
| 2-137 | NH(Me)3, H | n-C12H25 |
| 2-138 | NH(Me)3, H | n-C13H27 |
| 2-139 | NH(Me)3, H | n-C14H29 |
| 2-140 | NH(Me)3, H | n-C15H31 |
| 2-141 | NH(Me)3, H | n-C16H33 |
| 2-142 | NH(Me)3, H | n-C17H35 |
| 2-143 | NH(Me)3, H | n-C18H37 |
| 2-144 | NH(Me)3, H | n-C20H41 |

TABLE 2-4

| | M | R1 |
|---|---|---|
| 2-145 | NH2(CH2CH2OH)2 | n-C5H11 |
| 2-146 | NH2(CH2CH2OH)2 | C(Me)2CH2CH3 |
| 2-147 | NH2(CH2CH2OH)2 | CH2C(Me)2CH3 |
| 2-148 | NH2(CH2CH2OH)2 | CH(Me)CH2CH2CH3 |
| 2-149 | NH2(CH2CH2OH)2 | CH2CH(Me)CH2CH3 |
| 2-150 | NH2(CH2CH2OH)2 | CH2CH2CH(Me)CH3 |
| 2-151 | NH2(CH2CH2OH)2 | n-C5H13 |
| 2-152 | NH2(CH2CH2OH)2 | C(Me)2CH2CH2CH3 |
| 2-153 | NH2(CH2CH2OH)2 | CH(Me)CH(Me)CH2CH3 |
| 2-154 | NH2(CH2CH2OH)2 | CH2C(Me)2CH2CH3 |
| 2-155 | NH2(CH2CH2OH)2 | n-C7H15 |
| 2-156 | NH2(CH2CH2OH)2 | CH(Me)CH2C(Me)2CH3 |
| 2-157 | NH2(CH2CH2OH)2 | n-C8H17 |
| 2-158 | NH2(CH2CH2OH)2 | n-C9H19 |
| 2-159 | NH2(CH2CH2OH)2 | n-C10H21 |
| 2-160 | NH2(CH2CH2OH)2 | n-C11H23 |
| 2-161 | NH2(CH2CH2OH)2 | n-C12H25 |
| 2-162 | NH2(CH2CH2OH)2 | n-C13H27 |
| 2-163 | NH2(CH2CH2OH)2 | n-C14H29 |
| 2-164 | NH2(CH2CH2OH)2 | n-C15H31 |
| 2-165 | NH2(CH2CH2OH)2 | n-C16H33 |
| 2-166 | NH2(CH2CH2OH)2 | n-C17H35 |
| 2-167 | NH2(CH2CH2OH)2 | n-C18H37 |
| 2-168 | NH2(CH2CH2OH)2 | n-C20H41 |
| 2-169 | NH(E [symbol] )3, H | n-C5H11 |
| 2-170 | NH(E [symbol] )3, H | C(Me)2CH2CH3 |
| 2-171 | NH(E [symbol] )3, H | CH2C(Me)2CH3 |
| 2-172 | NH(E [symbol] )3, H | CH(Me)CH2CH2CH3 |
| 2-173 | NH(E [symbol] )3, H | CH2CH(Me)CH2CH3 |
| 2-174 | NH(E [symbol] )3, H | CH2CH2CH(Me)CH3 |
| 2-175 | NH(E [symbol] )3, H | n-C5H13 |
| 2-176 | NH(E [symbol] )3, H | C(Me)2CH2CH2CH3 |
| 2-177 | NH(E [symbol] )3, H | CH(Me)CH(Me)CH2CH3 |
| 2-178 | NH(E [symbol] )3, H | CH2C(Me)2CH2CH3 |
| 2-179 | NH(E [symbol] )3, H | n-C7H15 |
| 2-180 | NH(E [symbol] )3, H | CH(Me)CH2C(Me)2CH3 |
| 2-181 | NH(E [symbol] )3, H | n-C8H17 |
| 2-182 | NH(E [symbol] )3, H | n-C9H19 |
| 2-183 | NH(E [symbol] )3, H | n-C10H21 |
| 2-184 | NH(E [symbol] )3, H | n-C11H23 |
| 2-185 | NH(E [symbol] )3, H | n-C12H25 |
| 2-186 | NH(E [symbol] )3, H | n-C13H27 |
| 2-187 | NH(E [symbol] )3, H | n-C14H29 |
| 2-188 | NH(E [symbol] )3, H | n-C15H31 |
| 2-189 | NH(E [symbol] )3, H | n-C16H33 |
| 2-190 | NH(E [symbol] )3, H | n-C17H35 |
| 2-191 | NH(E [symbol] )3, H | n-C18H37 |
| 2-192 | NH(E [symbol] )3, H | n-C20H41 |

[symbol]

indicates data missing or illegible when filed

These combinations can be used even when composition ratio and molecular weight of the formulae (1) and (3) are changed. These combinations have the same effects.

Specific compositional combinations of M in the formula (1), Ar₁ in the formula (2) and R₁ in the formula (3) when the copolymer including a salt of phosphonic acid group in the present invention has structural units having the formulae (1), (2) and (3) are shown in Tables 3-1 to 3-4, 4-1 to 4-4 and 5-1 to 5-5.

TABLE 3-1

| | M | Ar1 | R1 |
|---|---|---|---|
| 3-1 | Na | 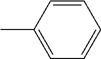 | n-C5H11 |
| 3-2 | Na | 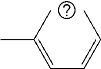 | CH2C(Me)2CH3 |
| 3-3 | Na | 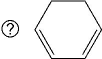 | CH2CH(Me)CH2CH3 |
| 3-4 | Na | 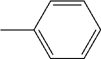 | n-C7H15 |
| 3-5 | Na | 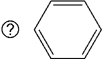 | CH(Me)CH2C(Me)2CH3 |
| 3-6 | Na | 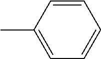 | n-C8H17 |
| 3-7 | Na | 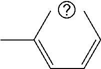 | n-C10H21 |
| 3-8 | Na | 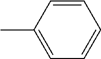 | n-C12H25 |
| 3-9 | Na | 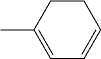 | n-C18H37 |
| 3-10 | Na | 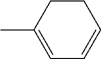 | n-C20H41 |
| 3-11 | Na, H | 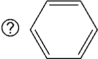 | n-C5H11 |
| 3-12 | Na, H | 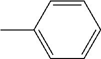 | CH2C(Me)2CH3 |
| 3-13 | Na, H | 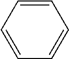 | CH2CH(Me)CH2CH3 |
| 3-14 | Na, H | 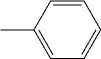 | n-C7H15 |
| 3-15 | Na, H | 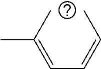 | CH(Me)CH2C(Me)2CH3 |
| 3-16 | Na, H | 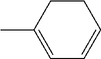 | n-C8H17 |

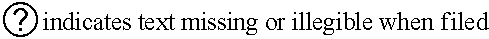

TABLE 3-2

| | M | Ar1 | R1 |
|---|---|---|---|
| 3-17 | Na, H | 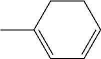 | n-C10H21 |
| 3-18 | Na, H | 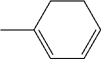 | n-C12H25 |
| 3-19 | Na, H | 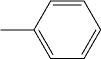 | n-C18H37 |
| 3-20 | Na, H | 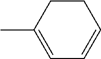 | n-C20H41 |
| 3-21 | K | 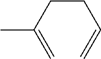 | n-C5H11 |
| 3-22 | K | 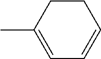 | CH2C(Me)2CH3 |
| 3-23 | K | 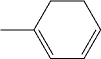 | CH2CH(Me)CH2CH3 |
| 3-24 | K | 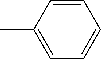 | n-C7H15 |
| 3-25 | K | 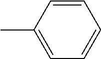 | CH(Me)CH2C(Me)2CH3 |
| 3-26 | K | 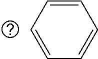 | n-C8H17 |
| 3-27 | K | 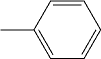 | n-C10H21 |
| 3-28 | K | 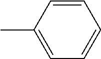 | n-C12H25 |
| 3-29 | K | 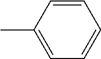 | n-C18H37 |
| 3-30 | K | 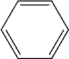 | n-C20H41 |
| 3-31 | K, H | 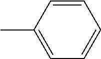 | n-C5H11 |
| 3-32 | K, H | 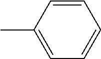 | CH2C(Me)2CH3 |

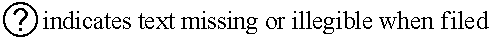

TABLE 3-3

| | M | Ar1 | R1 |
|---|---|---|---|
| 3-33 | K, H | 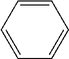 | CH2CH(Me)CH2CH3 |
| 3-34 | K, H | 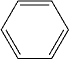 | n-C7H15 |
| 3-35 | K, H | 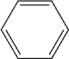 | CH(Me)CH2C(Me)2CH3 |
| 3-36 | K, H | 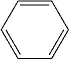 | n-C8H17 |
| 3-37 | K, H | 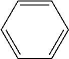 | n-C10H21 |
| 3-38 | K, H | 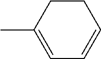 | n-C12H25 |
| 3-39 | K, H | 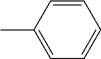 | n-C18H37 |
| 3-40 | K, H | 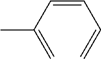 | n-C20H41 |
| 3-41 | NH2(CH2CH2OH)2 | 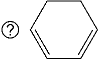 | n-C5H11 |
| 3-42 | NH2(CH2CH2OH)2 | 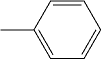 | CH2C(Me)CH3 |
| 3-43 | NH2(CH2CH2OH)2 | 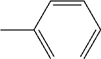 | CH2CH(Me)CH2CH3 |
| 3-44 | NH2(CH2CH2OH)2 | 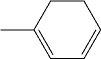 | n-C7H15 |
| 3-45 | NH2(CH2CH2OH)2 | 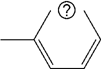 | CH(Me)CH2C(Me)2CH3 |
| 3-46 | NH2(CH2CH2OH)2 | 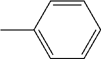 | n-C8H17 |
| 3-47 | NH2(CH2CH2OH)2 | 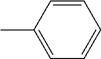 | n-C10H21 |
| 3-48 | NH2(CH2CH2OH)2 | 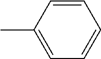 | n-C12H25 |

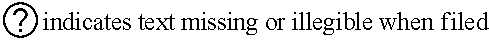

TABLE 3-4

| | M | Ar1 | R1 |
|---|---|---|---|
| 3-49 | NH2(CH2CH2OH)2 | 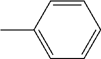 | n-C18H37 |
| 3-50 | NH2(CH2CH2OH)2 | 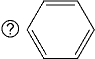 | n-C20H41 |
| 3-51 | NH(Et)3, H | 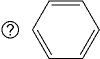 | n-C5H11 |
| 3-52 | NH(Et)3, H | 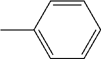 | CH2C(Me)2CH3 |
| 3-53 | NH(Et)3, H | 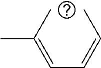 | CH2CH(Me)CH2CH3 |
| 3-54 | NH(Et)3, H | 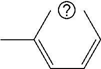 | n-C7H15 |
| 3-55 | NH(Et)3, H | 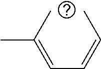 | CH(Me)CH2C(Me)2CH3 |
| 3-56 | NH(Et)3, H | 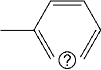 | n-C8H17 |
| 3-57 | NH(Et)3, H | 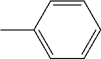 | n-C10H21 |
| 3-58 | NH(Et)3, H | 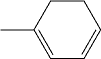 | n-C12H25 |
| 3-59 | NH(Et)3, H | 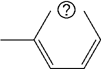 | n-C18H37 |
| 3-60 | NH(Et)3, H | 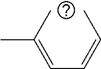 | n-C20H41 |

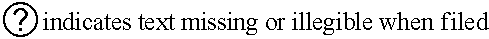

TABLE 4-1

| | M | Ar1 | R1 |
|---|---|---|---|
| 4-1 | Na | 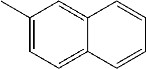 | n-C5H11 |
| 4-2 | Na | 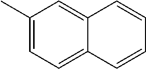 | CH2CH(Me)CH2CH3 |
| 4-3 | Na | 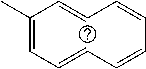 | n-C8H17 |
| 4-4 | Na | 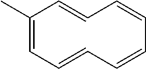 | n-C10H21 |
| 4-5 | Na | 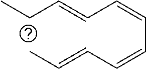 | n-C12H25 |
| 4-6 | Na | 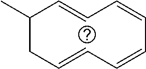 | n-C18H37 |
| 4-7 | Na | 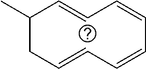 | n-C20H41 |
| 4-8 | Na, H | 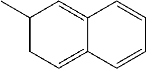 | n-C5H11 |
| 4-9 | Na, H | 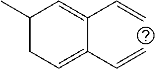 | CH2CH(Me)CH2CH3 |
| 4-10 | Na, H | 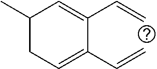 | n-C8H17 |
| 4-11 | Na, H | 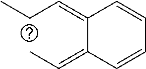 | n-C10H21 |
| 4-12 | Na, H | 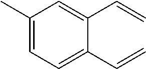 | n-C12H25 |
| 4-13 | Na, H | 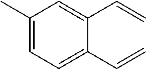 | n-C18H37 |

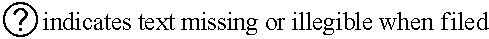

TABLE 4-2

| | M | Ar1 | R1 |
|---|---|---|---|
| 4-14 | Na, H | 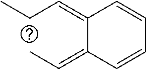 | n-C20H41 |
| 4-15 | K | 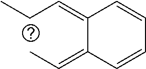 | n-C5H11 |
| 4-16 | K | 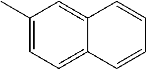 | CH2CH(Me)CH2CH3 |
| 4-17 | K | 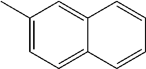 | n-C8H17 |
| 4-18 | K | 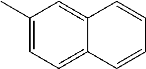 | n-C10H21 |
| 4-19 | K | 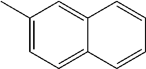 | n-C12H25 |
| 4-20 | K | 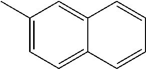 | n-C18H37 |
| 4-21 | K | 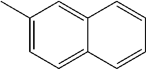 | n-C20H41 |
| 4-22 | K, H | 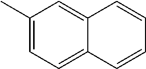 | n-C5H11 |
| 4-23 | K, H | 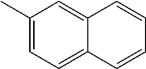 | CH2CH(Me)CH2CH3 |
| 4-24 | K, H | 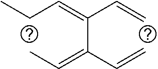 | n-C8H17 |
| 4-25 | K, H | 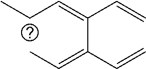 | n-C10H21 |
| 4-26 | K, H | 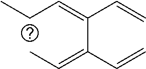 | n-C12H25 |

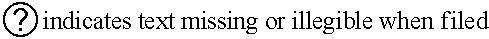

TABLE 4-3

| | M | Ar1 | R1 |
|---|---|---|---|
| 4-27 | K, H | 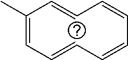 | n-C18H37 |
| 4-28 | K, H | 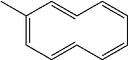 | n-C20H41 |
| 4-29 | NH2(CH2CH2OH)2 | 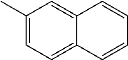 | n-C5H11 |
| 4-30 | NH2(CH2CH2OH)2 | 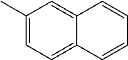 | CH2CH(Me)CH2CH3 |
| 4-31 | NH2(CH2CH2OH)2 | 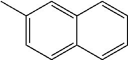 | n-C8H17 |
| 4-32 | NH2(CH2CH2OH)2 | 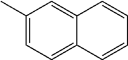 | n-C10H21 |
| 4-33 | NH2(CH2CH2OH)2 | 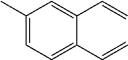 | n-C12H25 |
| 4-34 | NH2(CH2CH2OH)2 | 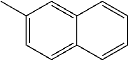 | n-C18H37 |
| 4-35 | NH2(CH2CH2OH)2 | 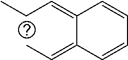 | n-C20H41 |
| 4-36 | NH(Me)3, H | 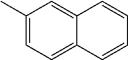 | n-C5H11 |
| 4-37 | NH(Me)3, H | 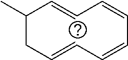 | CH2CH(Me)CH2CH3 |
| 4-38 | NH(Me)3, H | 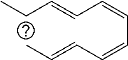 | n-C8H17 |
| 4-39 | NH(Me)3, H | 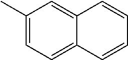 | n-C10H21 |

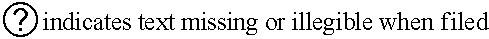

TABLE 4-4

| | M | Ar1 | R1 |
|---|---|---|---|
| 4-40 | NH(Me)3, H | 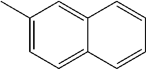 | n-C12H25 |
| 4-41 | NH(Me)3, H | 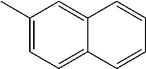 | n-C18H37 |
| 4-42 | NH(Me)3, H | 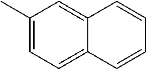 | n-C20H41 |

TABLE 5-1

| | M | Ar1 | R1 |
|---|---|---|---|
| 5-1 | Na | 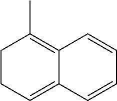 | n-C5H11 |
| 5-2 | Na | 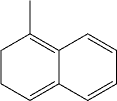 | CH2CH(Me)CH2CH3 |
| 5-3 | Na | 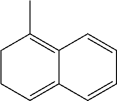 | n-C8H17 |
| 5-4 | Na | 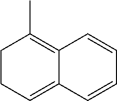 | n-C10H21 |
| 5-5 | Na | 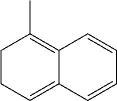 | n-C12H25 |
| 5-6 | Na | 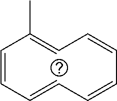 | n-C18H37 |
| 5-7 | Na | 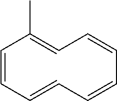 | n-C20H41 |
| 5-8 | Na, H | 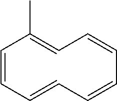 | n-C5H11 |
| 5-9 | Na, H | 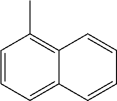 | CH2CH(Me)CH2CH3 |
| 5-10 | Na, H | 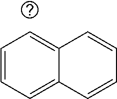 | n-C8H17 |

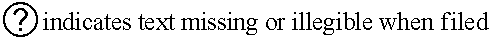

TABLE 5-2

| | M | Ar1 | R1 |
|---|---|---|---|
| 5-11 | Na, H | 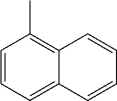 | n-C10H21 |
| 5-12 | Na, H | 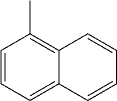 | n-C12H25 |
| 5-13 | Na, H | 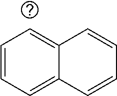 | n-C18H37 |
| 5-14 | Na, H | 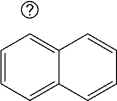 | n-C20H41 |
| 5-15 | K | 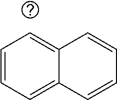 | n-C5H11 |
| 5-16 | K | 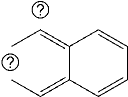 | CH2CH(Me)CH2CH3 |
| 5-17 | K | 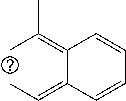 | n-C8H17 |
| 5-18 | K | 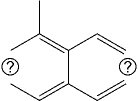 | n-C10H21 |
| 5-19 | K | 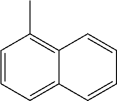 | n-C12H25 |
| 5-20 | K | 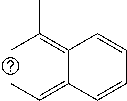 | n-C18H37 |

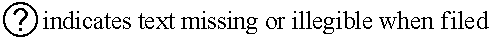

TABLE 5-3

| | M | Ar1 | R1 |
|---|---|---|---|
| 5-21 | K | 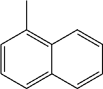 | n-C20H41 |
| 5-22 | K, H | 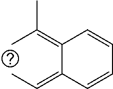 | n-C5H11 |
| 5-23 | K, H | 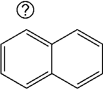 | CH2CH(Me)CH2CH3 |
| 5-24 | K, H | 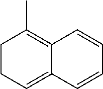 | n-C8H17 |
| 5-25 | K, H | 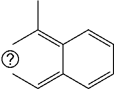 | n-C10H21 |
| 5-26 | K, H | 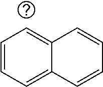 | n-C12H25 |
| 5-27 | K, H | 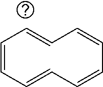 | n-C18H37 |
| 5-28 | K, H | 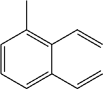 | n-C20H41 |
| 5-29 | NH2(CH2CH2OH)2, H | 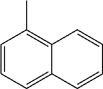 | n-C5H11 |
| 5-30 | NH2(CH2CH2OH)2, H | 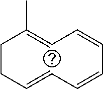 | CH2CH(Me)CH2CH3 |

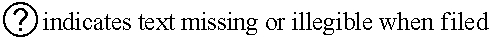

TABLE 5-4

| | M | Ar1 | R1 |
|---|---|---|---|
| 5-31 | NH2(CH2CH2OH)2, H | 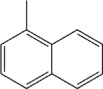 | n-C8H17 |
| 5-32 | NH2(CH2CH2OH)2, H | 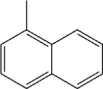 | n-C10H21 |
| 5-33 | NH2(CH2CH2OH)2, H | 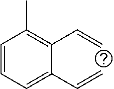 | n-C12H25 |
| 5-34 | NH2(CH2CH2OH)2, H | 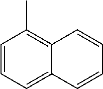 | n-C18H37 |
| 5-35 | NH2(CH2CH2OH)2, H | 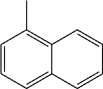 | n-C20H41 |
| 5-36 | NH(Me)CH2CH2OH | 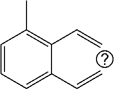 | n-C5H11 |
| 5-37 | NH(Me)CH2CH2OH | 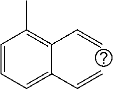 | CH2CH(Me)CH2CH3 |
| 5-38 | NH(Me)CH2CH2OH | 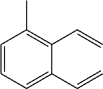 | n-C8H17 |
| 5-39 | NH(Me)CH2CH2OH | 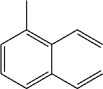 | n-C10H21 |
| 5-40 | NH(Me)CH2CH2OH | 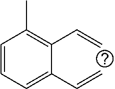 | n-C12H25 |

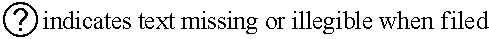

TABLE 5-5

| | M | Ar1 | R1 |
|---|---|---|---|
| 5-41 | NH(Me)CH2CH2OH | 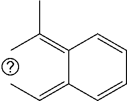 | n-C18H37 |
| 5-42 | NH(Me)CH2CH2OH | 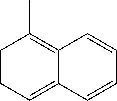 | n-C20H41 |

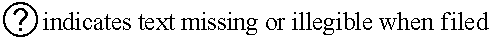

These combinations can be used even when composition ratio and molecular weight of the formulae (1), (2) and (3) are changed. These combinations have the same effects.

An ink for inkjet recording preferably includes the copolymer including a salt of phosphonic acid group in an amount of from 0.5 to 20% by weight.

Pigments for use in the present invention are not particularly limited, and carbon black is typically used as a black pigment.

Carbon black and color pigments are used as pigments.

Carbon black for use in the present invention is not particularly limited, and methods of preparing carbon black are not particularly limited, e.g., furnace methods and channel methods are used.

Marketed products can be used as carbon black. Specific examples thereof include No. 2300, No. 900, MCF-88, No. 3, No. 40, No. 45, No. 52, MA7, MA8, MA100 and No. 2200n from Mitsubishi Chemical Corp.; Raven 700, 5750. 5250, 5000, 3500 and 1255 from Colombian Chemicals Company; Regal 400R, 330R, 660R, Mogul L, Monarch 700, 800, 880, 900, 1000, 1100, 1300, Monarch 1400 from Cabot Corp.; Color Black FW1, FW2, FW2V, FW18, FW200, S150, S160, S170 from Degussa AG; Printex 35, U, V, 140U, 140V from Degussa AG; Special Black 6, 5, 4A, 4 from Degussa AG; etc.

The carbon black preferably has an average primary particle diameter of from 15 to 40 nm.

The carbon black preferably has specific surface area of from 50 to 300 m²/g.

Color pigments for use in the present invention are not particularly limited, and include yellow pigments, magenta pigments, cyan pigments, etc.

Specific examples of the yellow pigments include C.I. Pigment Yellow 1 (Fast Yellow G), 2, 3, 12 (disazo yellow AAA), 13 14, 16, 17, 20, 23, 24, 34, 35, 37, 42 (yellow iron oxide), 53, 55, 73, 74, 75, 81, 83 (disazo yellow HR), 86, 93, 95, 97, 98, 100, 101, 104, 108, 109, 110, 114, 117, 120, 125, 128, 129, 137, 138, 139, 147, 148, 150, 151, 153, 154, 155, 166, 168, 180, 185, etc.

Specific examples of the magenta pigments include C.I. Pigment Red 1, 2, 3, 5, 7, 9, 12, 17, 22 (Brilliant Fast Scarlet), 23, 31, 38, 48:1 (Parmanent Red 2B (Ba)), 48:2 (Parmanent Red 2B (Ca)), 48:3 (Parmanent Red 2B (Sr)), 48:4 (Parmanent Red 2B (Mn)), 49:1. 52:2, 53:1, 57:1, (Brilliant Carmine 6B), 60:1, 63:1, 63:2, 64:1, 81 (Rhodamine 6G Lake), 83, 88, 92, 97, 101 (red iron oxide), 104, 105, 106, 108 (Cadmium Red), 112, 114, 122 (dimethyl quinacridon), 123, 146, 149, 166, 168, 170, 172, 175, 176, 178, 179, 180, 184, 185, 190, 192, 193, 202, 209, 215, 216, 217, 219, 220, 223, 226, 227, 228, 238, 240, 254, 255, 272, etc.

Specific examples of the cyan pigments include C.I. Pigment Blue 1, 2, 3, 15 (Copper Phthalocyanine Blue R), 15:1, 15:2, 15:3 (Phthalocyanine Blue G), 15:4, 15:6 (Phthalocyanine Blue E), 16, 17:1, 22, 56, 60, 63, 64, Bat Blue 4, Bat Blue 60, etc.

Specific examples of additive color pigments include C.I. Pigment Red 177, 194, 224, C.I. Pigment Orange 16, 36, 43, 51, 55, 59, 61, 71, C.I. Pigment Violet 3, 19, 23, 29, 30, 37, 40, 50, C.I. Pigment Green 7, 36, etc.

The pigment preferably has a volume-average particle diameter of from 10 to 150 nm, more preferably from 20 to 100 nm, and furthermore preferably from 30 to 80 nm. When not less than 10 nm, light resistance and preservation stability of the resultant ink do not deteriorate. When not greater than 150 nm, color saturation of the resultant images do not deteriorate, the resultant ink does not increase in viscosity or agglutinate, and printer nozzles are not clogged.

The volume-average particle diameter is measured by, e.g., Microtrac UPA-150 from NIKKISO CO., LTD. A sample to be measured is diluted by pure water so as to have a pigment density of 0.01% by weight. The volume-average particle diameter means a 50% average particle diameter (D50) measured at particle refraction index of 1.51, a particle density of 1.4 g/cm³ and 23° C. using pure water parameter as a solvent parameter.

An ink for inkjet recording preferably includes the pigment in an amount of from 0.1 to 20% by weight, and more preferably from 1 to 20% by weight.

In the present invention, surfactant-treated carbon black particles or color pigment particles, on the surface of which a surfactant is adsorbed can be used.

The surfactant-treated carbon black particles are not particularly limited if the carbon black and a surfactant present on the surface thereof are included.

The surfactant-treated color pigment particles are not particularly limited if the color pigment and a surfactant present on the surface thereof are included.

Hereinafter, the surfactant-treated carbon black particles and the surfactant-treated color pigment particles are referred to as “surfactant-treated pigment particles”.

The surfactant-treated pigment particles are obtained by treating the pigments with the following surfactants. Specifically, the pigments are dispersed in water using the surfactants.

The pigments include the carbon black and color pigments.

In the present invention, a surfactant may be added to the ink.

The surfactants are not particularly limited, and include, e.g., nonionic surfactants, anionic surfactants, ampholytic surfactants, etc.

Specific examples of the nonionic surfactants include, but are not limited to, polyoxyethylenealkylethers such as polyoxyethylenelaurylether, polyoxyethylenemyristylether, polyoxyethylenecetylether, polyoxyethylenestearylether and polyoxyethyleneoleylether; polyoxyethylenealkylphenylethers such as polyoxyethyleneoctylphenylether and polyoxyethylenenonylphenylether; polyoxyethylene-α-naphthylether; polyoxyethylene-β-naphthylether; polyoxyethylenemonostyrylphenylether; polyoxyethylenedistyrylphenylether; polyoxyethylenealkylnaphthylether; polyoxyethylenemonostyrylnaphthylether; polyoxyethylenedistyrylnaphthylether; etc.

Further, surfactants of polyoxyethylene polyoxypropylene block copolymers formed by replacing a part of polyoxyethylene of these surfactants with polyoxypropylene, and surfactants formed by condensing a compound having an aromatic ring such as polyoxyethylenealkylphenylether with formaldehyde can also be used.

The nonionic surfactants preferably have an HLB of from 12.0 to 19.5. and more preferably from 13.0 to 19.0. When not less than 12.0, the surfactants do not have affinity with dispersion media and dispersion stability does not deteriorate. When not greater than 19.5, the surfactants are difficult to adsorb to the pigment and dispersion stability does not deteriorate.

Specific examples of the anionic surfactants include, but are not limited to, polyoxyethylenealkylether sulfate, polyoxyethylenealkylphenylether sulfate, polyoxyethylenemonostyrylphenylether sulfate, polyoxyethylenedistyrylphenylether sulfate, polyoxyethylenealkylether phosphate, polyoxyethylenealkylphenylether phosphate, polyoxyethylenemonostyrylphenylether phosphate, polyoxyethylenedistyrylphenylether phosphate, polyoxyethylenealkylether carboxylate, polyoxyethylenealkylphenylether carboxylate, polyoxyethylenemonostyrylphenylether carboxylate, polyoxyethylenedistyrylphenylether carboxylate, naphthalene sulfonate formaldehyde condensate, melamine sulfonate formaldehyde condensate, dialkyl sulfosuccinate, alkyl sulfosuccinate disalt, polyoxyethylenealkyl sulfosuccinate disalt, alkyl sulfoacetate, α-olefin sulfonate, alkylbenzenesulfonate, alkylnaphthalene sulfonate, alkyl sulfonate, N-acylamino acid salt, acyl peptide, soap, etc.

Metals used for these salts are not particularly limited, and include potassium, sodium, magnesium, calcium, etc.

Methods of preparing the surfactant-treated pigment particles are not particularly limited, and include a method of dispersing a mixture in which the pigment, the surfactant and water are mixed.

The mixture preferably includes the surfactant in an amount of from 10 to 50% by weight based on total weight of the pigment. When not less than 10% by weight, preservation stability of the ink does not deteriorate and dispersion does not take so much time. When not greater than 50% by weight, the ink does not have so high viscosity as to deteriorate discharge stability.

As the water, ion-exchanged water, ultrafiltrated water, Mill-Q water, pure water such as distilled water or ultrapure water can be used.

The content of the water used in the ink for inkjet recording is not particularly limited.

The black and color inks use water as a medium and preferably include a water-soluble solvent for the purpose of preventing the ink from being dried and improving dispersion stability of the pigment.

The water-soluble solvents are not particularly limited, and polyol having an equilibrium water content not less than 40% by weight in an environment of 23° C. and 80% Rh. The polyols are not particularly limited, and a water-soluble solvent A having a boiling point greater than 250° C. at normal pressure and a water-soluble solvent B having a boiling point not less than 140° C. and less than 250° C. at normal pressure are preferably used together.

Specific examples of the water-soluble solvent A include 1,2,3-butanetriol, 1,2,4-butanetriol (bp 190 to 191° C./24 hPa), glycerin (bp 290° C.), diglycerin (bp 270° C./20 hPa), triethylene glycol (bp 285° C.), tetraethylene glycol (bp 324 to 330° C.), etc.

Specific examples of the water-soluble solvent B include diethylene glycol (bp 245° C.), 1,3-butanediol (bp 203 to 204° C.), etc.

The water-soluble solvents A and B are both hygroscopic materials having an equilibrium water content not less than 40% by weight in an environment of 23° C. and 80% Rh. However, the water-soluble solvent B is more comparatively evaporable than the water-soluble solvent A.

When the water-soluble solvents A and B are used in combination, a weight ratio (B/A) of the water-soluble solvent B to the water-soluble solvent A is preferably from 10/90 to 90/10 although depending not a little on an amount of a water-soluble solvent C mentioned later and other additives such as a penetrant.

Potassium chloride saturated aqueous solution is placed in a desiccator in which 23+1° C. and 80+3% Rh are maintained and a petri dish on which each 1 g of the water-soluble solvents is placed is stored in the desiccator to determine the equilibrium water content from a saturated amount of water.

Saturated amount of water (%)=(amount of water absorbed in an organic solvent/organic solvent)×100

The black ink and the color ink may include a water-soluble solvent C together with the water-soluble solvents A and B when necessary.

Specific examples of the water-soluble solvent C include polyol, polyol alkyl ethers, polyol aryl ether, nitrogen-containing heterocyclic compounds, amides, amines, sulfur-containing compounds, propylene carbonate, ethylene carbonate, other water-soluble solvents, etc.

Specific examples of the polyol include dipropylene glycol (bp 232° C.), 1,5-pentanediol (bp 242° C.), 3-methyl-1,3-butanediol (bp 203° C.), propylene glycol (bp 187° C.), 2-methyl-2,4-pentanediol (bp 197° C.), ethylene glycol (bp 196 to 198° C.), tripropylene glycol (bp 267° C.), hexylene glycol (bp 197° C.), polyethylene glycol (viscosity liquid to solid), polypropylene glycol (bp 187° C.), 1,6-hexanediol (bp 253 to 260° C.), 1,2,6-hexanetriol (bp 178° C.), trimethylolethane (solid, mp 199 to 201° C.), trimethylolpropane (solid, mp 61° C.), etc.

Specific examples of the polyol alkyl ethers include ethyleneglycolmonoethylether (bp 135° C.), ethyleneglycolmonobutylether (bp 171° C.), ethyleneglycolmonomethylether (bp 194° C.), diethyleneglycolmonobutylether (bp 231° C.), ethyleneglycolmono-2-ethylhexylether (bp 229° C.), propyleneglycolmonoethylether (bp 132° C.), etc.

Specific examples of the nitrogen-containing heterocyclic compounds include 2-pyrrolidon, N-methyl-2-pyrrolidon, N-hydroxyethyl-2-pyrrolidon, 1,3-dimethylimidazolidinone, ε-caprolactam, γ-butyrolactone, etc.

The black ink and the color ink preferably includes the water-soluble solvent in an amount of from 10 to 50% by weight.

The ink including the surfactant lowers in surface tension and penetrates recording media such as papers quicker, and feathering and color bleed are lessened.

Fluorine surfactants and silicone surfactants are preferably used, and combination thereof is more preferably used because image density, discharge stability and discharge recovery improve.

Specific examples of the fluorine surfactants include, but are not limited to, perfluoroalkylsulfonate, perfluoroalkylcarboxylate, perfluoroalkylphosphate ester, adducts of perfluoroalkylethyleneoxide, perfluoroalkylbetaine, perfluoroalkylamineoxide compounds, polyoxyethyleneperfluoroalkylether, etc.

As the fluorine surfactants, marketed products can be used. Specific examples of the marketed products include Surflon S-111, S-112, S-113, S121, S131, S132, S-141, S-144 and S-145 from Asahi Glass Co., Ltd.; Fluorad FC-93, FC-95, FC-98, FC-129, FC-135, FC-170C, FC-430, FC-431 and FC-4430 from Sumitomo 3M Corp.; MEGAFAC F-470, F-1405 and F474 from DIC Corp.; Zonyl FSN, FSN-100, FSO, FSO-100 and FS-300 from DuPont; Eftop EF-351, 352, 801 and 802 from Jemco; FT-250 and 251 from Neos Company Limited; PF-151N, PF-136A and PF-156A from OMNOVA Solutions Inc.; etc. Among these, Zonyl FSN, FSN-100, FSO, FSO-100 and FS-300 from DuPont are preferably used in terms of good printed quality and preservation stability.

The silicone surfactants are not particularly limited, and include polyether-modified silicone compounds, etc.

Specific examples of the polyether-modified silicone compounds include side chain (pendant) types in which a polyether group is introduced to a side chain of polysiloxane, one terminal types in which a polyether group is introduced to one terminal of polysiloxane, both terminal (ABA) types in which a polyether group is introduced to each of the terminals, side chain both and both terminal types in which a polyether group is introduced to each of the side chain and the terminals, ABn types in which a polyether-group-introduced polysiloxane (A) and an unintroduced polysiloxane (B) are repeatedly bonded, branched types in which polyether groups are introduced to branched terminals.

As the polyether-modified silicone compounds, the side chain (pendant) types in which a polyether group is introduced to a side chain of polysiloxane are preferably used. The side chain type polyether-modified silicone compounds are not particularly limited, and a silicone compound having the following formula (I) is preferably used in terms of not only decreasing surface tension of the ink but also preventing the ink from anchoring to nozzle plate of head.

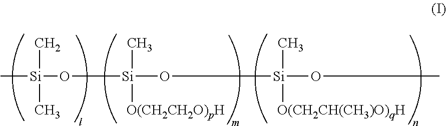

wherein l, m, n, p and q are integers, and l+m+n is less than 2,000 and p+q is less than 100.

As the silicone surfactants, marketed products can be used. Specific examples of the marketed products include KF-351A, KF-352A, KF-353 (Silicone surfactant having the formula (I)), KF-354L, KF-355A, KF-615A, KF-945, KF-618, KF-6011, KF-6015 and KF-6004 from Shin-Etsu Chemical Co., Ltd.; SF-3771, SF-8427, SF-8428, SH-3749, SH-8400, FZ-2101, FZ-2104, FZ-2118, FZ-2201, FZ-2101, FZ-2104, FZ-2118, FZ-2203, FZ-2207 and L-7604 from Dow Corning Toray Silicone Co., Ltd.; BYK-345, BYK-346 and BYK-348 from BYK-Chemie Japan; etc.

The black ink and the color ink preferably include the fluorine surfactant in an amount of from 0.1 to 3.0% by weight, and more preferably from 0.3 to 1.0% by weight in terms of better image density and discharge recovery.

The black ink and the color ink preferably include the silicone surfactant in an amount of from 0.05 to 3.0% by weight in terms of good discharge stability.

Specific examples of the other components include defoamers, pH control agents, anti-septic and anti-fungal agents, anti-corrosion agents, anti-oxidants, ultraviolet absorbers, etc.

Specific examples of the defoamers include silicone defoamers, polyether defoamers, fatty acid ester defoamers, etc.

The pH control agents are not particularly limited as long as they are capable of controlling pH to be not less than 7, and include diethanol amine, triethanol compounds, lithium carbonate, sodium carbonate, potassium carbonate, ammonium hydroxide, lithium hydroxide, sodium hydroxide, potassium hydroxide, etc.

Specific examples of the anti-septic and anti-fungal agents include, but are not limited, 1,2-benzisothiazolin-3-on, dehydrosodium acetate, sodium sorbinate, 2-pyridine thiol-1-oxide sodium, sodium benzoate, and pentachlorophenol sodium.

Specific examples of the anti-corrosion agents include, but are not limited to, acid sulfite, thiosodium sulfate, ammonium thiodiglycolate, diisopropyl ammonium nitrite, pentaerythritol quaternary nitride, and dicyclohexyl ammonium nitrite.

Specific examples of the anti-oxidants include, but are not limited to, phenol-based anti-oxidants (including hindered phenol-based anti-oxidants), amino-based anti-oxidants, sulfur-based anti-oxidants, and phosphorous-based anti-oxidants.

Specific examples of the ultraviolet absorbers include, but are not limited to, oxybenzone, phenyl salicylate, and paraaminobenzoate ester.

The black ink and the color ink preferably has a viscosity of from 5.0 to 12.0 mPa·s at 25° C. The viscosity is measured by, e.g., a viscometer RE80L from TOKI SANGYO CO., LTD.

Next, the ink container, the inkjet recorder, the method of preparing recorded matters and recorded matters of the present invention are explained.

Each ink constituting the ink set can be used in an ink cartridge and any other suitable member can be used in combination.

The ink container of the present invention contains the inkjet ink of the present invention and may include any other suitable members in combination.

There is no specific limit to the container. Any form, any structure, any size, and any material can be suitably selected. For example, an ink bag formed of aluminum laminate film, a resin film, etc. can be suitably used as a container.

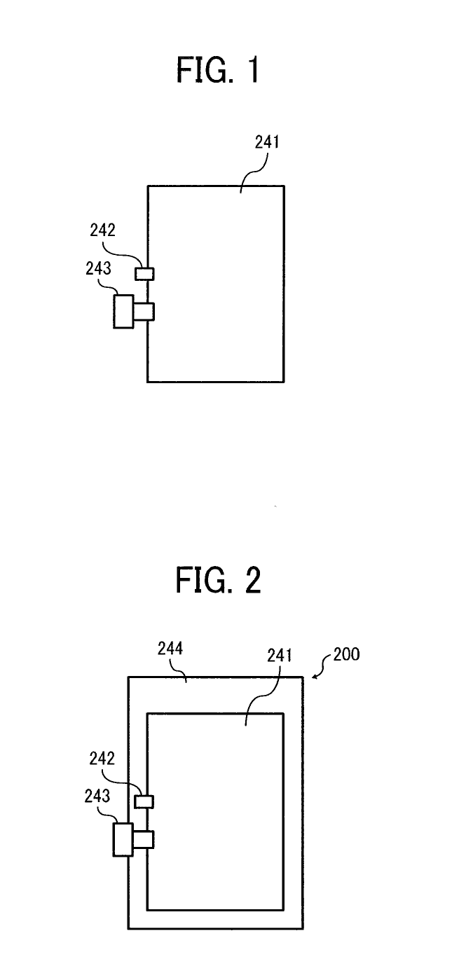

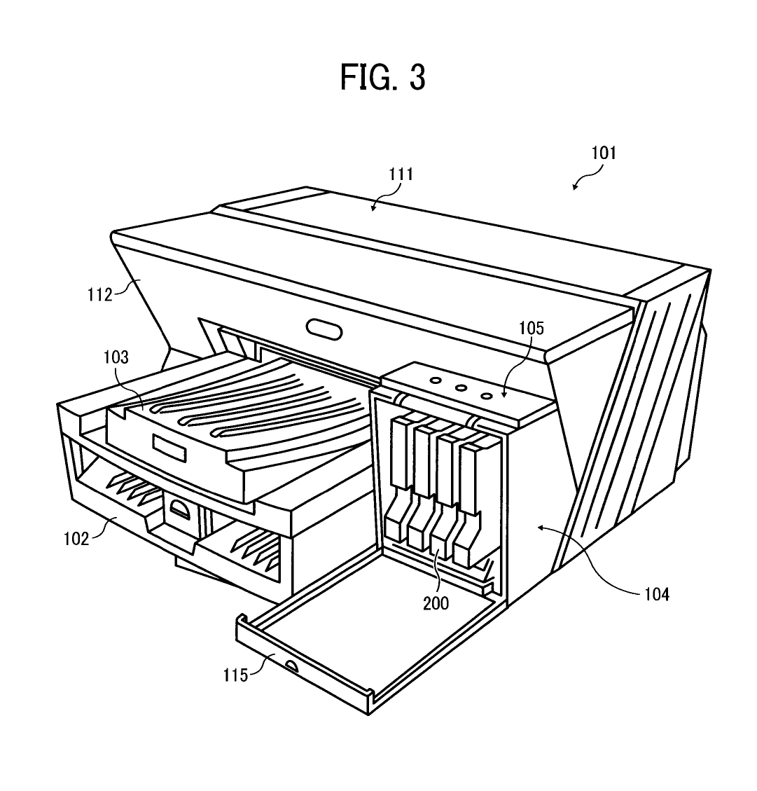

FIG. 1 is a schematic plain view illustrating an embodiment of the ink container 200 of the present invention. FIG. 2 is a schematic plain view illustrating the embodiment of the ink container 200 including a case (outer package) in FIG. 1.

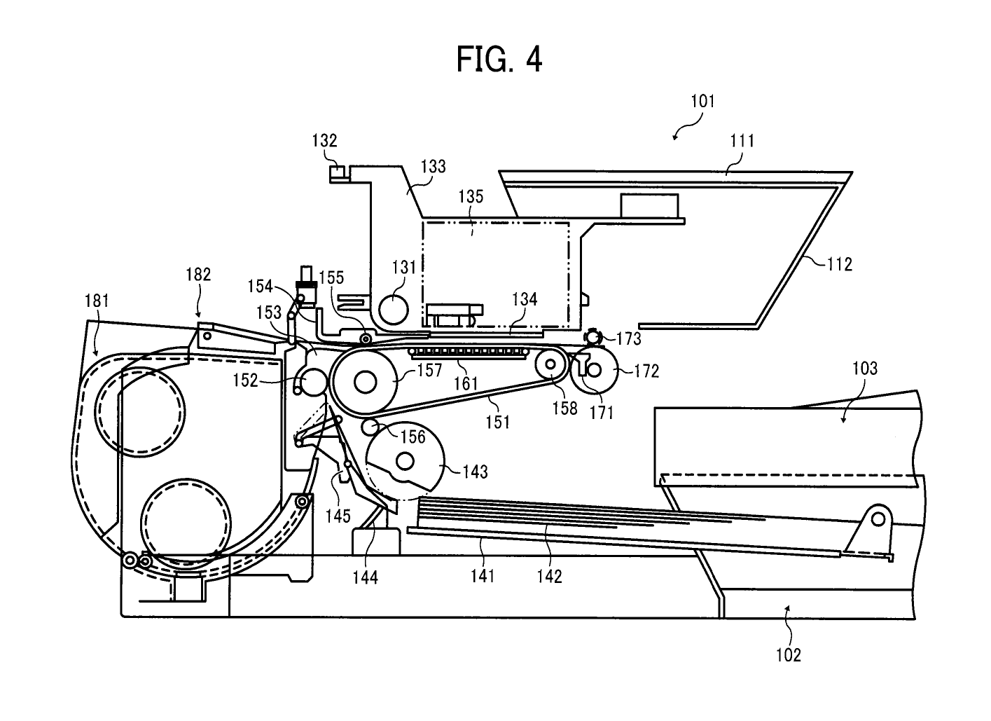

As illustrated in FIG. 1, an ink bag 241 is filled with the ink from an ink inlet 242. Subsequent to evacuation of air, the ink inlet 242 is closed by fusion. When in use, the ink is supplied by piercing the needle attached to the inkjet recorder into an ink outlet 243 made of rubber. The ink bag 241 is formed of a packaging material such as aluminum laminate film having no air permeability. The ink bag 241 is accommodated in a cartridge case 244 made of plastic as illustrated in FIG. 4 and detachably attachable to various inkjet recorders.

Inkjet recorders include inkjet printers, facsimile machines, photocopiers, multi-functional machines (serving as a printer, a facsimile machine, and a photocopier), etc.

Specific examples of recording media recorded by the inkjet recorder include, but are not limited to, plain papers, coated papers for printing, glossy paper, special papers, clothes, films and OHP sheets.

FIG. 3 is a perspective view illustrating an embodiment of the inkjet recorder of the present invention.

An inkjet recorder 101 illustrated in FIG. 1 has a sheet feeder tray 102 to feed recording media placed in the inkjet recorder 101, a discharging tray 103 installed in the inkjet recorder 101, which stores the recording media on which images are recorded (formed), and an ink cartridge installation unit 104. On the upper surface of the ink cartridge installation unit 104 is arranged an operating portion 105 including operation keyboard, a display, etc. The ink cartridge installation unit 104 has a front cover 115 that is openable and closable to detach and attach an ink cartridge 200. 111 represents the upper cover of the inkjet recorder 101 and 112 represents the front surface thereof.

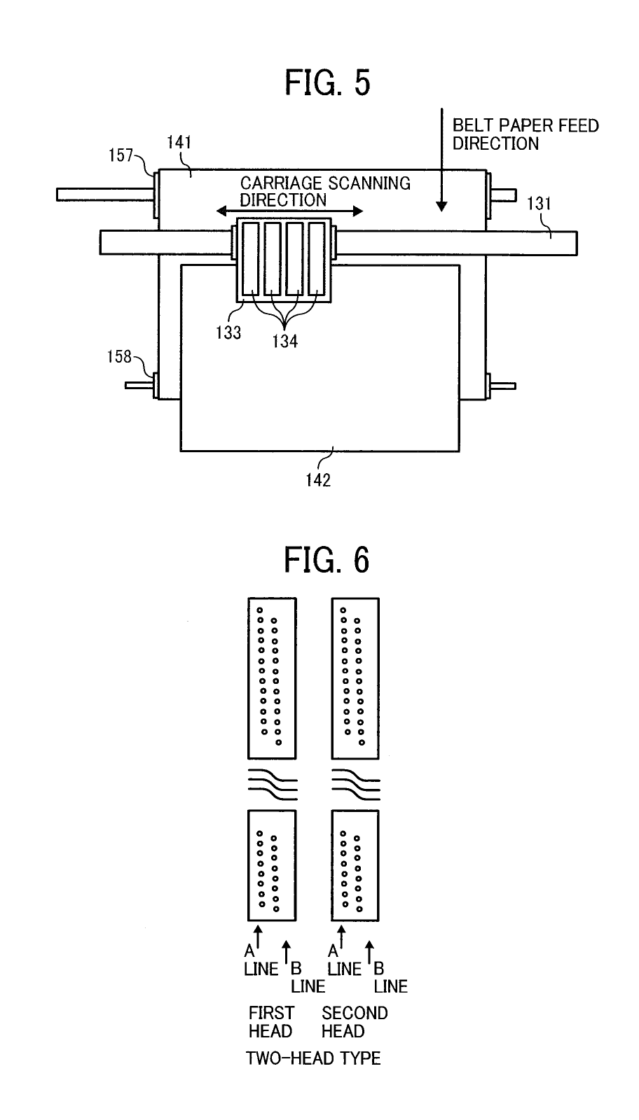

Inside the inkjet recorder 101, as illustrated in FIGS. 4 and 5, a guide rod 131 and a stay 132 serving as guiding members that laterally bridge side plates provided on the right side and left side hold a carriage 133 slidably movable in the main scanning direction. A main scanning motor moves the carriage 133 for scanning in an arrow direction in FIG. 5.

The carriage 133 has a recording head 134 having four inkjet recording heads that discharge ink droplets of each color of yellow (Y), cyan (C), magenta (M), and black (Bk) while multiple ink discharging mouths are arranged in the direction crossing the main scanning direction with the ink droplet discharging direction downward.

As the heads for inkjet recording that form the recording head 134, it is possible to use a device having an energy-generating device to discharge ink such as a piezoelectric actuator such as a piezoelectric element, a thermal actuator that utilizes the phase change caused by film boiling of liquid using an electric heat conversion element such as a heat element, a shape-memory alloy actuator that uses the metal phase change due to the temperature change, and an electrostatic actuator that uses an electrostatic force. The carriage 133 has a sub tank 135 for each color to supply each color ink to the recording head 134. The ink is supplied and replenished to the sub-tank 135 from the ink cartridge 200 mounted onto the ink cartridge inserting installation unit 104 via a tube for supplying ink.

A sheet feeding unit to feed a sheet 142 loaded on a sheet loader (pressure plate) 141 of the sheet feeder tray 103 includes a roller (sheet feeding roller 143) having a half-moon like form to separate and feed the sheet 142 one by one from the sheet loader 141 and a separation pad 144 that is made of a material having a large friction index and arranged facing the sheet feeding roller 143 while biased to the side of the sheet feeding roller 143.

A transfer unit to transfer the sheet 142 fed from the sheet feeding unit on the lower side of the recording head 134 includes a transfer belt 151 to electrostatically adsorb and transfer the sheet 142, a counter roller 152 to transfer the sheet 142 fed from the sheet feeding unit via a guide 145 while pinching the sheet 142 with the transfer belt 151, a transfer guide 153 to make the sheet 142 track on the transfer belt 151 by changing the transfer direction of the sheet 142 being sent substantially vertically upward by substantially 90°, a front head pressure roller 155 biased towards the transfer belt 151 by a pressure member 154, and a charging roller 156 to charge the surface of the transfer belt 151.

The transfer belt 151 is an endless form belt, stretched between a transfer roller 157 and a tension roller 158 and rotatable in the belt transfer direction. This transfer belt 151 include, for example, a top layer serving as a sheet adsorption surface made of a resin material such as a copolymer (ETFE) of tetrafluoroethylene and ethylene with no resistance control treatment while having a thickness about 40 μm, and a bottom layer (moderate resistance layer, earth layer) made of the same material as the top layer with resistance control treatment with carbon. On the rear side of the transfer belt 151, a guiding member 161 is arranged corresponding to the printing area by the recording head 134.

A discharging unit to discharge the sheet 142 on which images are recorded by the recording head 134 includes a separation claw 171 to separate the sheet 142 from the transfer belt 151, a discharging roller 172, and a discharging roller 173. A discharging tray 103 is arranged below the discharging roller 172.

A duplex printing sheet feeding unit 181 is detachably attached to the rear side of the inkjet recorder 101. The duplex printing sheet feeding unit 181 takes in and reverses the sheet 142 that is returned by the reverse rotation of the transfer belt 151 and feeds it again between the counter roller 152 and the transfer belt 151. A manual sheet feeding unit 182 is provided on the upper surface of the duplex printing sheet feeding unit 181.

In this inkjet recorder, the sheet 142 is separated and fed from the sheet feeding unit one by one substantially vertically upward, guided by the guide 145, and transferred while being pinched between the transfer belt 151 and the counter roller 152. Furthermore, the front end of the sheet 142 is guided by the transfer guide 153 and pressed against the transfer belt 151 by the front head pressure roller 155 to change the transfer direction by substantially 90°. Since the transfer belt 157 is charged by the charging roller 156 at this point in time, the sheet 142 is electrostatically adsorbed to the transfer belt 151 and transferred. By driving the recording head 134 according to the image signal while moving the carriage 133, the ink droplet is discharged to the sheet 142 not in motion to record an image for an amount corresponding to one line and thereafter the sheet 142 is transferred in a predetermined amount to conduct recording for the next line.

On receiving a signal indicating that the recording has completed or the rear end of the sheet 142 has reached the image recording area, the recording operation stops and the sheet 142 is discharged to the discharging tray 103. When the amount of ink for inkjet recording remaining in the sub-tank 135 is detected as “approaching to empty”, a predetermined amount of the ink is replenished to the sub tank 135 from the ink cartridge 200.

In this inkjet recorder, it is possible to dissemble the chassis of the ink cartridge 200 and replace the ink bags therein when the ink for inkjet is used up in the ink cartridge 200.

In addition, the ink cartridge 200 stably supplies the ink even when the ink cartridge 200 is placed upright (on its side) and installed by front loading. Therefore, even when the upside of the main part 101 is blocked, for example, it is accommodated in a rack or something is placed on the upper surface of the main part 101, the ink cartridge 200 is easily exchanged.

A serial type (shuttle type) in which the carriage scans is used in this description but this is true in a line-type inkjet recorder having a line type head.

The inkjet recording method using the ink for inkjet recording of the present invention preferably includes at least an ink flight process of applying stimulation to the ink thorough an ink flyer to fly the ink from a recording head to record an image on recording media.

Namely, the inkjet recording method using the ink for inkjet recording of the present invention includes at least an ink flight process and other processes selected when necessary such as a stimulation generation process and a control process.

The inkjet recorder of the present invention may be the following recorder.

The inkjet recorder of the present invention has an ink flight means flying the ink for inkjet recording of the present invention from a recording head to record an image on recoding media. Namely, the inkjet recorder of the present invention preferably includes at least a recording head and a maintenance and recovery device, and other means such as a stimulation generator and a controller when necessary.

Hereinafter, the inkjet recording method is explained through explanation of the inkjet recorder of the present invention.

The inkjet recorder applies a stimulation to each of the ink through an ink flight means to discharge the ink from a nozzle of the recording head to record an image. The stimulation is generated by, e.g., a stimulation generator. Specific examples of the stimulation include, but are not limited to, heat (temperature), pressure, oscillation and light. These can be used alone or in combination. Among these, heat and pressure are preferably used.

Specific examples of the stimulation generator include heater, pressurizer, piezo element, oscillator, ultrasonic oscillator, light, etc. For example, piezo actuator such as piezo element, thermal actuator using a phase variation due to film boiling of a liquid using electric heat conversion element such as heating resistant, shape-memory alloy actuator using metal phase variation due to variation of temperature, electrostatic actuator using electrostatic force are used.

The ink flight differs according to the stimulation. When the stimulation is heat, a heat energy according to a recording signal is applied from, e.g., a thermal head to the recording ink in a recording head. The heat energy has the recording ink generate bubbles. A pressure of the bubbles discharge the recording ink as a droplet from the nozzle of the recording head. When the stimulation is pressure, e.g., a voltage is applied to a piezo element bonded to a pressure room in an ink flow channel in the recording head. The piezo element bended and the pressure room decreases its capacity to discharge the recording ink as a droplet from the nozzle of the recording head.

The droplet of the ink preferably has a size of from 3 to 40 pl, a spray speed of from 5 to 20 m/s, a drive frequency not less than 1 kHz, and an image resolution not less than 300 dpi.

The recording head preferably includes many nozzles, and a head or a recording unit dripping and discharging the ink with energy. Further, the recording head preferably includes a liquid room, a fluid resistor, an oscillation plate and a nozzle member, and at least a part of the recording head is preferably formed of a material including silicone or nickel. The recording head preferably has a nozzle diameter not greater than 30 μm, and more preferably of from 1 to 20 μm.

The inkjet recorder of the present invention preferably has a sub-tank feeding ink on the recording head, which is filled with ink through a feed tube from an ink cartridge.

The maintenance and recovery device includes at least one suction cap connected with a suction generator, capping the recording head, and one moisturizing cap not connected with the suction generator, capping the recording head, and other means when necessary. The suction cap and the moisturizing cap decrease ink and time consumed for maintaining, and waste of ink more than when all the caps a re suction caps. The maintenance and recovery device is not particularly limited, and one disclosed in Japanese published unexamined application No. JP-2005-170035-A can be used.

The inkjet recorder of the present invention preferably has a reverser reversing recording surfaces of recording media to be duplex printable. The reverser includes a transfer belt having electrostatic force, a recording media holder with air suction, a combination of a transfer roller and a spur, etc. Further, the inkjet recorder of the present invention preferably has an endless transfer belt and a transferer transferring recording media while holding them by the charged transfer belt. In this case, an AC bias of from ±1.2 to ±2.6 kV is preferably applied to a charging roller to charge the transfer belt.

The controller is not particularly limited as long as it is capable of controlling operation of each of the means, and includes a sequencer, a computer, etc.

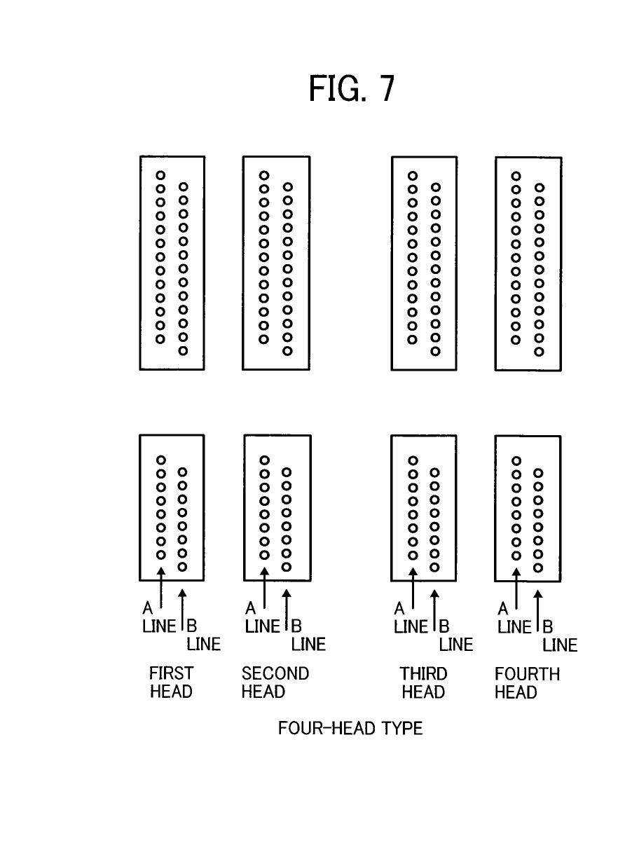

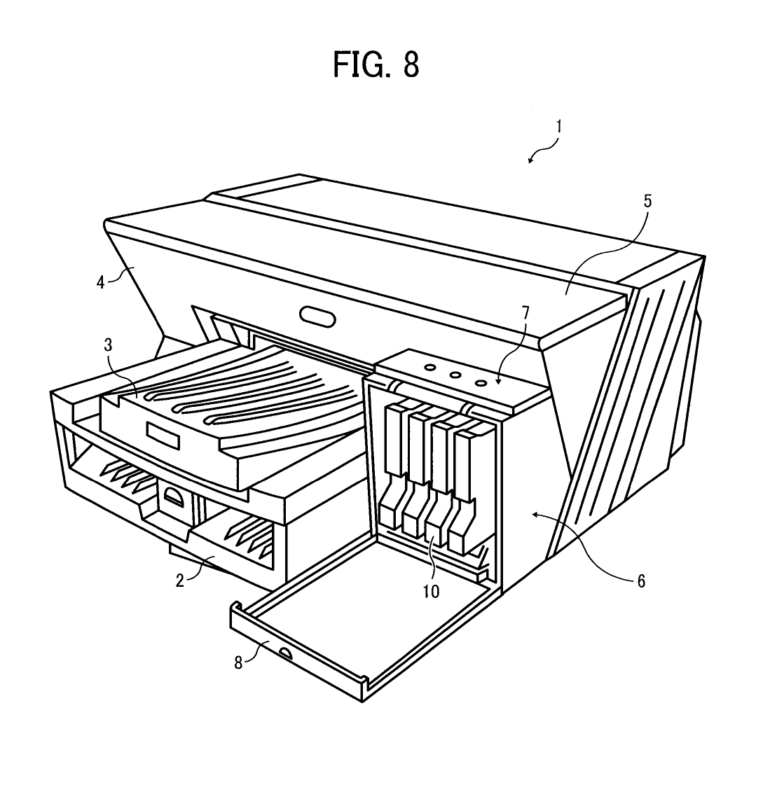

FIGS. 6 and 7 are schematic plain views illustrating embodiments of a recording head equipped in the inkjet recorder, seen from the nozzle surfaces. FIG. 6 is a two-head type formed of a first head and a second head. FIG. 7 is a four-head type formed of a first head, a second head, a third head and a fourth head.

In the two-head type, one of the first head and the second head is capped with a suction cap connected with a suction generator and the other is capped with a moisturizing cap not connected with the suction generator. In FIG. 6, the first head is capped with a suction cap and the second head is capped with a moisturizing cap.

In the four-head type in FIG. 7, at least one of the first to fourth heads is capped with a suction cap connected with a suction generator and the other are capped with moisturizing caps not connected with the suction generator. In FIG. 7, the first head is capped with a suction cap and the second, third and fourth heads are capped with moisturizing caps.

In the two-head type in FIG. 6, yellow (Y), cyan (C), magenta (M) and black (Bk) color inks need to be filled in four nozzle lines, respectively to record full-color images.

FIG. 8 is a perspective view illustrating an embodiment of the inkjet recorder having a maintenance and recovery device of the present invention.

The inkjet recorder in FIG. 8 includes an apparatus 1, a paper feed tray 2 filled with papers and a paper discharge tray 3 on which recorded papers (media) are stocked. Further, the inkjet recorder includes a cartridge loader 6 at a side of a front surface 4, projecting forward therefrom and lower than an upper surface 5. Operation keys and a controller 7 are located on the upper surface of the cartridge loader 6. The cartridge loader 6 is loaded with an exchangeable main tank (ink container or ink cartridge) 10 which is a liquid reserve tank, and has an openable and closable front cover 8.

The ink cartridge includes a container containing the ink for inkjet recording of the present invention and may include other members when necessary. The container is not particularly limited in shape, structure, size and material, and an ink bag formed of aluminum laminated film or a resin film is preferably used.

An ink is filled in the ink bag from an ink inlet and the ink inlet is sealed with heat after the ink bag is degasified. The ink is fed through a needle inserted into an ink exhaust formed of a rubber. The ink bag is formed of a wrapper made of an air-impermeable aluminum laminated film, etc. The ink bag is typically contained in a plastic cartridge case detachable from various inkjet recorders.

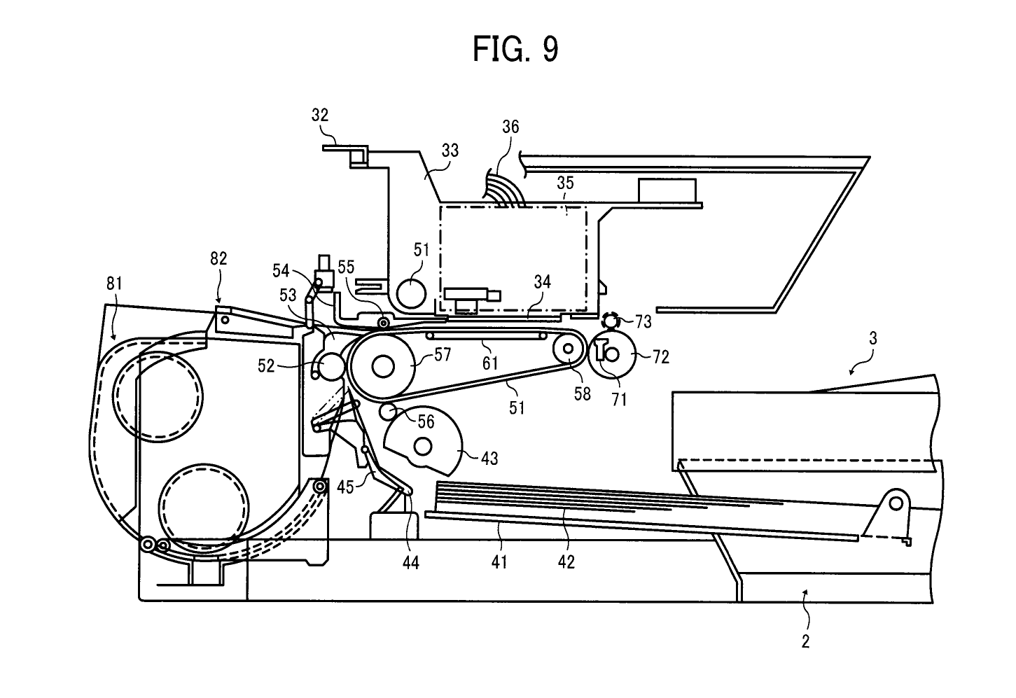

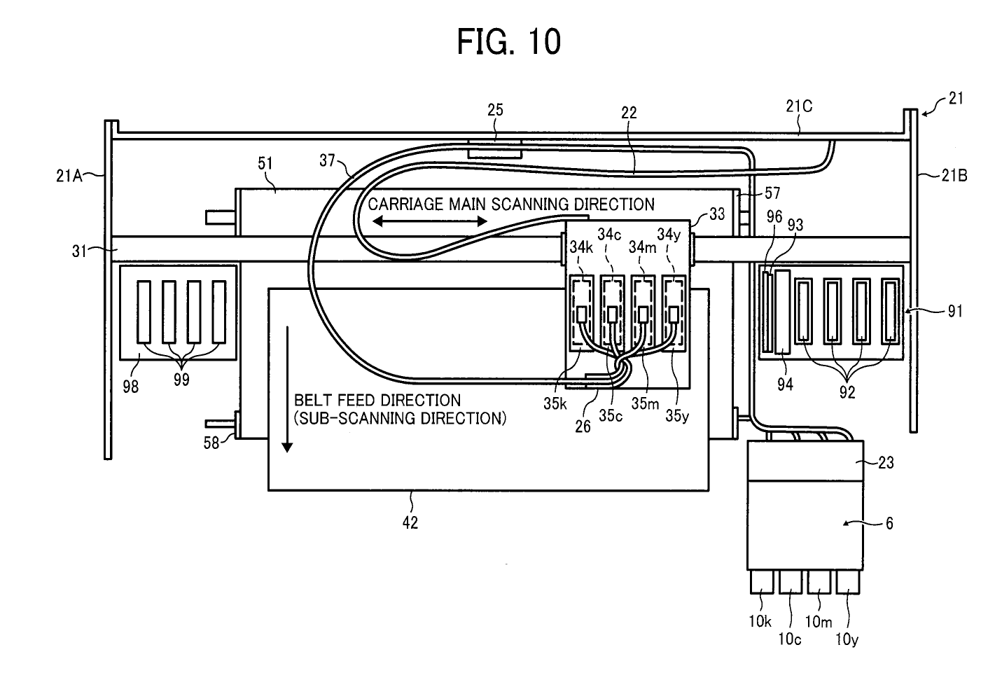

FIG. 9 is a schematic view illustrating an overall structure of the inkjet recorder in FIG. 8, and FIG. 10 is a schematic plain view illustrating a main part of the inkjet recorder therein.

A guide rod 31 as a guide member and a stay 32 horizontally suspended between side boards 21A and 21B forming a frame 21 slidably hold a carriage 33 in a main scanning direction, and a main scanning motor drives the carriage in the main scanning direction in FIG. 10.

The carriage 33 is loaded with plural recording heads 34 formed of inkjet heads which are droplet discharge heads discharging ink droplets, in which plural nozzles are located in a direction intersecting with the main scanning direction, directing the ink droplet discharge direction downward.

The recording heads 34 includes a recording head 34y discharging a yellow (Y) droplet, a recording head 34m discharging a magenta (M) droplet, a recording head 34c discharging a cyan (C) droplet, and a recording head 34k discharging a black (Bk) droplet. Further, one or plural recording heads having one or plural nozzle lines discharging one or plural color droplets can also be used.

The droplet discharge head forming the recording head 34 includes those equipped with a piezoelectric actuator such as a piezoelectric element, a thermal actuator that utilizes the phase change caused by film boiling of liquid using an electric heat conversion element such as a heat element, a shape-memory alloy actuator that uses the metal phase change due to the temperature change, and an electrostatic actuator that uses an electrostatic force as an energy generator to discharge droplets.

The carriage 33 is loaded with sub-tanks 35y, 35m, 35c and 35k for feeding each color ink to each recording head 34. The sub-tank 35 is filled with each color ink from each ink cartridge 10y, 10m, 10c and 10k through each ink feed tube 37.

The ink cartridge 10 is contained in the cartridge loader 6 as FIG. 10 shows. A feed pump unit 23 feeding ink in the ink cartridge 10 is located in the cartridge loader 6. The ink feed tube 37 from the cartridge loader 6 to the sub-tank 35 is fixedly held by a holder 25 on a back board 21C forming the frame 21 on the way of being laid.

In FIGS. 9 and 10, 22 is a flexible cable and 36 is an ink feed tube (sub-tank connector).

As a paper feeder feeding papers 42 loaded on a paper loader (bottom board) 41 of the paper feed tray 2, a semicircular (paper feed) roller 43 and a separation pad 44 formed of a material having a large friction coefficient separating and feeding one by one of the papers 42 from the paper loader 41 are equipped. The separation pad 44 is biased to the paper feed roller 43.

In addition, a transfer belt 51 electrostatically adsorbing a paper 42 and transferring the paper as a transferer transferring the paper 42 fed from the paper feeder below the recording head 34, a counter roller 52 sandwiching the paper 42 fed from the paper feeder through a guide 45 with the transfer belt 51 and transferring the paper, a transfer guide 53 changing the paper 42 fed almost vertically in direction at 90° to place the paper 42 on the transfer belt 51, a head pressure roller 55 biased to the transfer belt 51 by a pressure member 54 are equipped. Further, a charging roller 56 charging the surface of the transfer belt 51 is equipped.

The transfer belt 51 is an endless belt suspended with tension between a transfer roller 57 and a tension roller 58 and is rotated in a belt transfer direction in FIG. 10. A charging roller 56 contacts a surface layer of the transfer belt 51 and rotates in company with rotation of the transfer belt 51, and a pressure of 2.5N is applied to each of both ends of an axis thereof.

On the back of the transfer belt 51, a guide member 61 is located according to a printing area of the recording head 34. The guide member 61 projects more than a tangent line of the two rollers supporting the transfer belt 51 (transfer roller 57 and the tension roller 58) to the recording head 34. Thus, the transfer belt 51 is pressed up and guided by the upper surface of the guide member 61 to maintain high-precision flatness.

Further, to discharge the paper 42 recorded by the recording head 34, a separation claw 71 separating the paper 42 from the transfer belt 51, paper discharge rollers 72 and 73 are equipped, and a paper discharge tray 3 is equipped below the paper discharge roller 72. A distance from the paper discharge rollers 72 and 73 to the paper discharge tray 3 is long to some extent to stock as many papers as possible.

A both-side paper feed unit 81 is detachably installed on the back of the apparatus 1. The both-side paper feed unit 81 reverses the paper 42 retuned by reverse rotation of the transfer belt 51 and feeds the paper between a counter roller 52 and the transfer belt 51 again. A manual paper feeder 82 is located on the upper surface of the both-side paper feed unit 81.

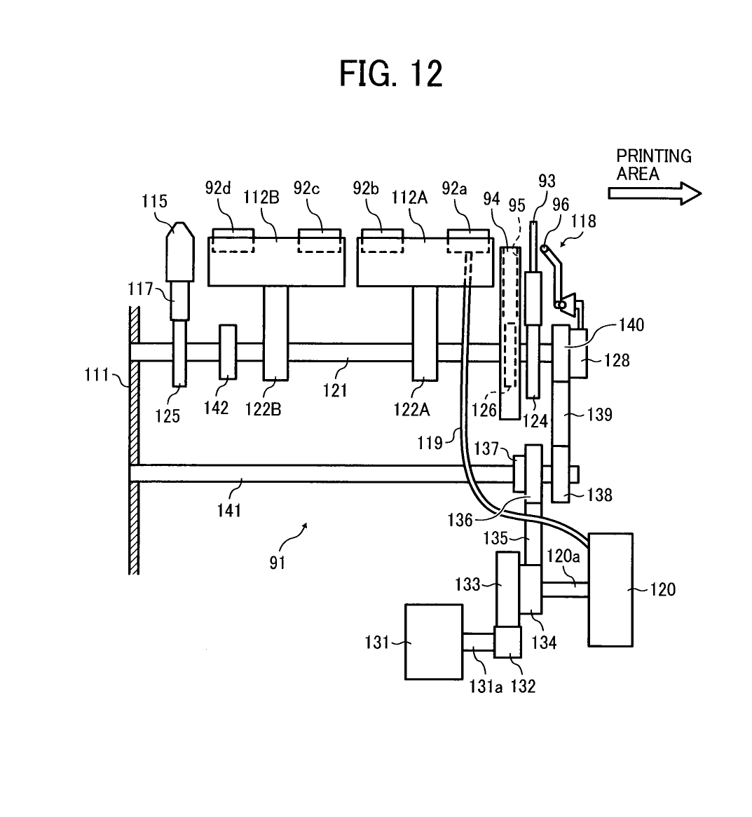

Further, as FIG. 10 shows, in a non-printing area at one side of the scanning direction of the carriage 33, a maintenance and recovery device (sub-system) 91 maintaining and recovering the nozzles of the recording head 34. The subsystem 91 includes cap members (caps) 92a to 92d capping the nozzle surfaces of the recording head 34, a wiper blade 93 which is a blade member wiping the nozzle surfaces, a blank discharge receiver 94 receiving droplets not for recording of blank discharge to discharge thickened ink, a wiper cleaner 95 (FIG. 12) removing ink adhering to the wiper blade 93, which is united with the blank discharge receiver 94, and a cleaner roller 96 pressing the wiper blade 93 to the wiper cleaner 95 when the wiper blade 93 is cleaned.

As FIG. 10 shows, in a non-printing area at the other side of the scanning direction of the carriage 33, a blank discharge receiver 98 receiving droplets not for recording of blank discharge to discharge thickened ink is located, and the discharge receiver 98 has an opening 99 along nozzle line direction of the recording head 34.

In the inkjet recorder, the papers 42 are separately fed one by one from the paper feed tray 2, and the paper 42 fed upward almost vertically is guided by the guide 45 to be fed while sandwiched between the counter roller 52 and the transfer belt 51. Further, the end of the paper 42 is guided by the transfer guide 53 and is pressed against the transfer belt 51 by the head pressure roller 55 to be fed in a direction at an almost 90° turn.

Then, a control circuit applies an alternating voltage repeating positive and negative outputs alternately to the charging roller 56 from a high-voltage electric source, and the transfer belt 51 is zonally and alternately charged positively and negatively in a sub-scanning direction. When the paper 42 is fed onto the positively and negatively charged transfer belt 51, the paper 42 is electrostatically adsorbed to the transfer belt 51, and the paper 42 is fed in a sub-scanning direction by rotation of the transfer belt 51. The recording head 34 is driven according to an image signal while the carriage 33 is moved to discharge ink to the paper 42 and record one line thereon. After the paper 42 is transferred for a predetermined distance, the following line is recorded. Receiving a record finish signal or a signal representing a tail end of the paper 42 reaches the recording area, recording operation is finished and the paper 42 is discharged on the paper feed tray 3.

When ready to print, the carriage 33 is moved to the subsystem 91, the recording head is capped with the cap member 92 to moisturize the nozzle to prevent defective discharge due to dried ink. The cap member 92 caps the recording head 34 to suction ink from the nozzle to perform recovery operation discharging thickened ink and bubbles. Before and while recording, blank discharge of the ink not recording is performed. This maintains stable dischargeability of the recording head 34.

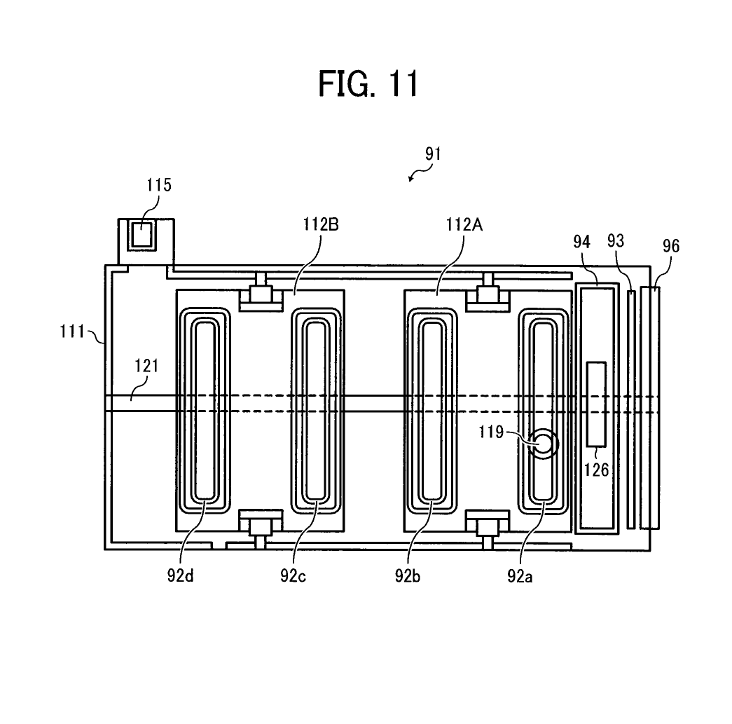

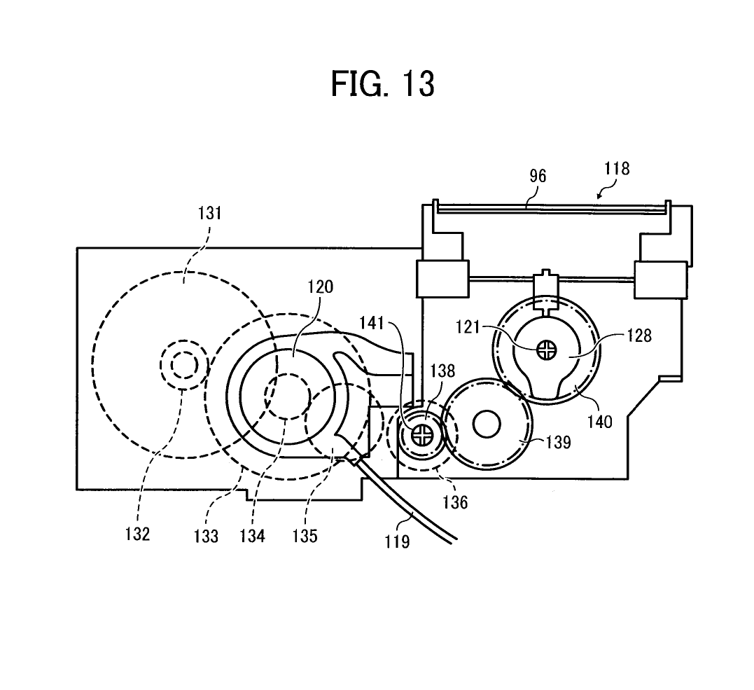

FIG. 11 is a schematic plain view illustrating a main part of a subsystem 91 including the maintenance and recovery device (subsystem 91) in the inkjet recorder of the present invention. FIG. 12 is a schematic view illustrating the subsystem in FIG. 11. FIG. 13 is a schematic view illustrating the right side of the subsystem in FIG. 11.

A frame 111 of the subsystem 91 holds two cap holders 112A and 112B holding the cap, a wiper blade 93 which is a wiping member including an elastic body as a cleaner, and a carriage lock 115, which are all vertically movable. A blank discharge receiver 94 is located between the wiper blade 93 and the cap holder 112A. To clean the wiper blade 93, a wiper cleaner 118 including a cleaner roller 96 pressing the wiper blade 93 to a wiper cleaner 95 cleaning the blank discharge receiver 94 from the outside is swingably held.

The cap holders 112A and 112B hold two caps 92a and 92b, and 92c and 92d capping the nozzle surface of two recording heads 34, respectively.

A tubing (suction) pump 120 is connected with the cap 92a held by the cap holder 112A through a flexible tube 119, and the tubing pump 120 is connected with each of the other caps 92b, 92c and 92d. Namely, only the cap 92a is a suction (recovery) and moisturizing cap and each of the other caps 92b, 92c and 92d is simply a moisturizing cap. Therefore, when recovery operation of the recording head 34 is performed, the recording head 34 is selectively moved to a position where it can be capped by the cap 92a.

Below the cap holders 112A and 112B, a cam shaft 121 is rotatably supported by the frame 111. The cam shaft 121 includes cap cams 122A and 122B elevating the cap holders 112A and 112B, a wiper cam 124 elevating the wiper blade 93, a carriage lock cam 125 elevating the carriage lock 115 through a carriage lock arm 117, a roller 126 droplets discharged in the blank discharge receiver 94 land on, and a cleaner cam 128 swinging the wiper cleaner 118.

The cap 92 is elevated by the cap cams 122A and 122B. The wiper blade 93 is elevated by the wiper cam 124. When the wiper blade 93 descends while the wiper cleaner 118 come out to be sandwiched between the cleaner roller 96 of the wiper cleaner 118 and the wiper cleaner 95 of the blank discharge receiver 94, ink adhering to the wiper blade 93 is scraped off in the blank discharge receiver 94.

The carriage lock 115 is biases upward (lock direction) by a compressed spring to be elevated through the carriage lock arm 117 driven by the carriage lock cam 125. In order to rotate the tubing pump 120 and the cam shaft 121, a pump gear 133 formed on a pump shaft of the tubing pump 120 is engaged with a motor gear 132 formed on a motor shaft 131a of a motor 131. Further, an intermediate gear 136 having a one-direction clutch is engaged with an intermediate gear 134 united with the pump gear 133 through an intermediate gear 135. A cam gear 140 fixed on the cam shaft 121 is engaged with an intermediate gear 138 having the same shaft as that of the intermediate gear 136. An intermediate shaft 141 which is a rotational shaft of the intermediate gear 136 having a clutch 137 and the intermediate gear 138 is rotatably held by the frame 111.

The subsystem 91 has a home position sensor cam 142 detecting a home position. The home position sensor operates a home position lever when the cap 92 comes to the lowest end and the sensor is open to detect a home position of the motor 131 (except for the pump 120. When the power is on, the cap 92 (cap holder 112) elevates regardless of its position and does not detection the position until starts moving. After the cap 92 detects the home position (while ascending), the cap 92 moves for a fixed distance to lowest end. Then, the carriage moves right and left and returns to a cap position after detecting the position, and the recording head 34 is capped.

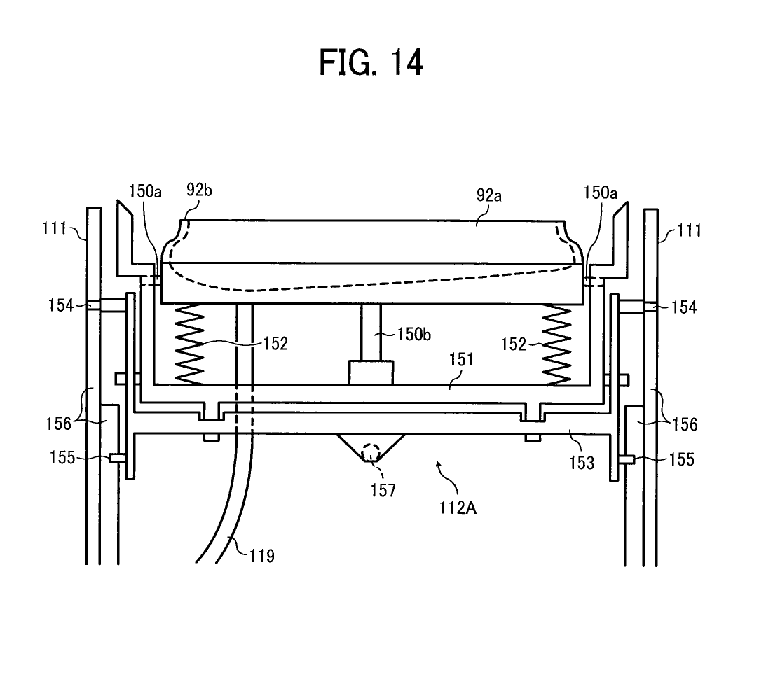

FIG. 14 is a schematic view illustrating a side of holding and elevating mechanism of the cap 92.

A cap holder 112A holding a cap has a holder 151 elevatably holding the caps 92a and 92b (92A), a spring 152 located between a bottom surface of the holder 151 and a bottom of the cap 92A, biasing the cap 92A upward, and a slider 153 slidably holding the holder 151 back and forth (line direction of the nozzles of the recording head 34).

The cap 92A is equipped with guide pins 150a at both ends elevatable through an unillustrated guide trough of the holder 151 and a guide shaft 150b at the bottom surface elevatably on the holder 151. A spring 152 located between the cap 92A and the cap holder 151 biases the caps 92a and 92b upward (a direction of pressing the caps 92a and 92b to the nozzle surfaces when capped).

The slider 153 slidably engages the guide pins 154 and 155 with a guide trough 156 formed on the frame 111 such that the slider 153, the holder 151 and the cap 92A are all elevatable.

A cam pin 157 located below the slider 153 is engaged with an unillustrated cam through to elevate the slider 153, the holder 151 and the cap 92A by rotation of the cap cam 122A rotating with the cam shaft 121 rotation of the motor 131 is transmitted to.

Further, the slider 153 and the holder 151 are inserted into the suction cap 92a, a tube 119 is wired thereon in its short direction from the lower part of the central position to the cap.

A cap holder 112B holding the caps 92c and 92d (cap 92B) and a method of elevating this are same as above. However, the tube 119 is not connected to the caps 92c and 92d. The motor 131 is driven to rotate the cam shaft 121, and the cam shaft 121 rotates to rotate the cams 122A and 122B fixed thereon such that the caps 92A and 92B elevate.

The inkjet recorder and the inkjet recording method of the present invention are used for various inkjet recordings such as inkjet recording printers, facsimiles, copiers and their combination machines.

The method of preparing recorded matters of the present invention includes a process of discharging an ink from an inkjet head to record on a recording medium, and the ink is the inkjet ink of the present invention.

The recorded matter of the present invention is recorded by the inkjet recording method of the present invention, and has an image recorded by the inkjet ink of the present invention on a recording medium.

The recorded matter of the present invention has high-quality images and good stability preferably usable for various applications.

The recording media are not particularly limited, as long as the inkjet recording ink of the present invention lands thereon to form an image thereon. Specific examples thereof includes plain papers, coated papers for printing, glossy papers, special papers, etc. They include calcium carbonate, talc, kaolin or aluminum sulfate, etc., and divalent or trivalent ions such as calcium, magnesium and aluminum elute when the inkjet recording ink of the present invention lands thereon. Namely, the ink of the present invention reacts with the metallic ions to agglutinate a pigment and produces images having high image density.

The plain papers are difficult to have high image density.

Most of loading materials and size fixers included in the plain papers are metallic salts having poor water solubility. Even when a water-soluble metallic salt is included, the content there of is low. Therefore, the plain papers do not improve in image density so much as papers including water-soluble multivalent metallic salts.

However, the inkjet recording ink of the present invention reacts with a pigment to produce images having high image density even when the multivalent metallic ions elute less. Specific examples of the marketed plain papers include quality paper My Paper from Ricoh Company, Ltd., Xerox 4024 from Fuji Xerox Co, Ltd., etc.

### EXAMPLES

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### Synthesis Example 1-1 of Copolymer Including a Salt of Phosphonic Acid Group

In a reaction container including a gas inlet tube, a thermometer and a reflux condenser, in an argon atmosphere, 400 parts of methyl ethyl ketone, 25 parts of vinyl phosphate from Tokyo Chemical Industry Co., Ltd., 75 parts of styrene from Tokyo Chemical Industry Co., Ltd., and 5 parts of 1-dodecanthiol as a molecular weight adjuster from Tokyo Chemical Industry Co., Ltd. were placed to prepare a solution, and argon gas displacement was performed for 30 min while the solution was stirred to prepare a mixed solution. In an argon atmosphere, the mixed solution was heated to have a temperature of 60° C. while stirred, and a solution including a half of 6 parts of a polymerization initiator 2,2′-azobis(2,4-dimethylvaleronitrile) and methyl ethyl ketone was dripped therein with a dripping funnel. After dripped, the temperature of the mixed liquid was maintained at 60° C. for 12 hrs. Then, the remaining solution of the polymerization initiator was dripped and reacted at 75° C. for 2 hrs to prepare a copolymer solution.

The copolymer solution was placed in a large amount of n-hexane to precipitate the copolymer and a solvent was removed therefrom by decantation. Further, the precipitated product was dried to prepare a copolymer including a phosphonic acid group.

The copolymer was dissolved in ethanol to prepare a solution, and potassium hydroxide dissolved in methanol was added and mixed therein so as to be completely disacidified. After the mixture was stirred, a solvent was removed by an evaporator, and further dried in a vacuum to prepare a copolymer R1-1 having a neutralized phosphonic acid group.

An aqueous solution including the R1-1 in an amount of 10% by weight was prepared, and a viscosity thereof at 25° C. was measured by viscometer RE500L from TOKI SANGYO CO., LTD. The results are shown in Table 6.

### Synthesis Example 1-2 to 1-26 of Copolymer Including a Salt of Phosphonic Acid Group

The procedure for preparation of the copolymer including a salt of phosphonic acid group in Synthesis Example 1-1 was repeated except for using various alkylene monomers, changing a compositional ratio of the vinyl phosphonic acid to the alkylene monomer of from 15/85 to 65/35, changing the amount of the molecular weight adjuster from 0 to 6 parts by weight, changing the amount of the polymerization initiator from 3 to 10 parts by weight such that the resultant copolymers had compositional combinations in Table 6. Further, sodium hydroxide, potassium hydroxide, triethanol amine, trimethyl amine, diethanol amine and triethyl amine were used as the neutralizer such that neutralization rates were from 80 to 100% to prepare copolymers R1-2 to R1-26 each having a neutralized phosphonic acid group. The results are shown in Table 6.

TABLE 6

| | | | M+ proton | |
|---|---|---|---|---|
| | | Formula (1) | content rate in | |
| | Compositional | content rate | formula (1) | Viscosity |
| | Combination No. | (% by weight) | (% by mol) | (mPa · s) |
| R1-1 | 1-3 | 25 | — | 1.6 |
| R1-2 | 1-3 | 15 | — | 2.7 |
| R1-3 | 1-3 | 25 | — | 3.0 |
| R1-4 | 1-3 | 55 | — | 1.7 |
| R1-5 | 1-3 | 65 | — | 3.5 |
| R1-6 | 1-3 | 55 | — | 3.2 |
| R1-7 | 1-3 | 55 | — | 39 |
| R1-8 | 1-3 | 65 | — | 28 |
| R1-9 | 1-3 | 55 | — | 32 |
| R1-10 | 1-3 | 25 | — | 41 |
| R1-11 | 1-3 | 15 | — | 22 |
| R1-12 | 1-3 | 25 | — | 26 |
| R1-13 | 1-3 | 35 | — | 2.9 |
| R1-14 | 1-3 | 35 | — | 1.3 |
| R1-15 | 1-3 | 35 | — | 30 |
| R1-16 | 1-3 | 35 | — | 38 |
| R1-17 | 1-3 | 15 | — | 1.5 |
| R1-18 | 1-3 | 65 | — | 45 |
| R1-19 | 1-4 | 35 | 10 | 3.4 |
| R1-20 | 1-4 | 35 | 20 | 3.0 |
| R1-21 | 1-1 | 35 | — | 4.1 |
| R1-22 | 1-7 | 35 | — | 3.2 |
| R1-23 | 1-8 | 35 | 10 | 3.1 |
| R1-24 | 1-11 | 35 | — | 4.3 |
| R1-25 | 1-16 | 35 | 5 | 3.3 |
| R1-26 | 1-17 | 35 | — | 3.7 |

### Synthesis Example of Copolymer R-100 Including Phosphoric Acid Group

With reference to a synthesis example in Japanese published unexamined application No. JP-2011-122072-A, 30 parts of styrene, 20 parts of methylmethacrylate, 15 parts of butylmethacrylate, 10 parts of methacrylate, 20 parts of phosmer M (monomer including a phosphoric acid group from Uni-Chemical Co., Ltd.) and 5 parts of azobisisobutylonitrile were polymerized to prepare a copolymer R-100 including a phosphoric acid group.

Similarly to the copolymer R1-1 including a salt of a phosphonic acid group, the copolymer R-100 including a phosphoric acid group was neutralized with sodium hydroxide to be completely neutralized to prepare a copolymer R-100 including a salt of a phosphoric acid group. An aqueous solution including the R-100 in an amount of 10% by weight had a viscosity of 9.1 mPa·s at 25° C.

### Pigment Dispersion Preparation Examples 1-1 to 1-36

### Pigment Dispersion Preparation Example 1-1

### Black Pigment Dispersion 1-1

With reference to Example 1 in Japanese published unexamined application No. JP-2009-114286-A, a black pigment dispersion was prepared.

The following materials were premixed to prepare a mixed slurry (a). This was subjected to a circulation dispersion by a disc type media mill (DMR from Ashizawa Finetech Ltd.) with 0.05 mm zirconia beads at a filling rate of 55%, a peripheral speed of 10 m/s, a liquid temperature of 10° C. for 3 min. Then, the resultant dispersion was subjected to centrifugal separation by a centrifugal separator Model 7700 from KUBOTA Corporation to separate coarse particles to prepare a pigment dispersion 1-1 having a pigment concentration of 16% by weight.

| | |
|---|---|
| Carbon black (NIPEX160 from Degussa AG | 160 |
| having a BET specific surface area of 150 m²/g, | |
| an average primary particle diameter of 20 nm | |
| a pH of 4.0 and a DBP oil absorption of 620 g/100 g | |
| Copolymer R1-13 | 20 |
| including a salt of a phosphonic acid group | |
| Distilled water | 820 |

### Pigment Dispersion Preparation Example 1-2

### Black Pigment Dispersion 1-2

The procedure for preparation of the pigment dispersion 1-1 in Pigment Dispersion Preparation Example 1-1 was repeated except for changing parts of the copolymer R1-13 from 20 to 40 and parts of the distilled water from 820 to 800.

### Pigment Dispersion Preparation Example 1-3

### Black Pigment Dispersion 1-3

The procedure for preparation of the pigment dispersion 1-1 in Pigment Dispersion Preparation Example 1-1 was repeated except for changing parts of the copolymer R1-13 from 20 to 160 and parts of the distilled water from 820 to 680.

### Pigment Dispersion Preparation Example 1-4

### Cyan Pigment Dispersion 1-1

The procedure for preparation of the pigment dispersion 1-2 in Pigment Dispersion Preparation Example 1-2 was repeated except for changing the carbon black into Pigment Blue 15:3 (CHROMOFINE BLUE) from DAINICHISEIKA COLOR & CHEMICALS MFG CO., LTD.

### Pigment Dispersion Preparation Example 1-5

### Magenta Pigment Dispersion 1-1

The procedure for preparation of the pigment dispersion 1-2 in Pigment Dispersion Preparation Example 1-2 was repeated except for changing the carbon black into Pigment Red 122 (Toner Magenta EO02) from Clariant (Japan) K.K.

### Pigment Dispersion Preparation Example 1-6

### Yellow Pigment Dispersion 1-1

The procedure for preparation of the pigment dispersion 1-2 in Pigment Dispersion Preparation Example 1-2 was repeated except for changing the carbon black into Pigment Yellow (Fast Yellow 531) from DAINICHISEIKA COLOR & CHEMICALS MFG CO., LTD.

### Pigment Dispersion Preparation Example 1-7

### Black Pigment Dispersion 1-4

The procedure for preparation of the pigment dispersion 1-1 in Pigment Dispersion Preparation Example 1-1 was repeated except for changing the copolymer R1-13 into POE (m=40) β-naphthylether 10% aqueous solution, parts thereof from 20 to 400 and parts of the distilled water from 820 to 440.

### Pigment Dispersion Preparation Example 1-8

### Cyan Pigment Dispersion 1-2

The procedure for preparation of the pigment dispersion 1-7 in Pigment Dispersion Preparation Example 1-7 was repeated except for changing the carbon black into Pigment Blue 15:3 (CHROMOFINE BLUE) from DAINICHISEIKA COLOR & CHEMICALS MFG CO., LTD.

### Pigment Dispersion Preparation Example 1-9

### Magenta Pigment Dispersion 1-2

The procedure for preparation of the pigment dispersion 1-7 in Pigment Dispersion Preparation Example 1-7 was repeated except for changing the carbon black into Pigment Red 122 (Toner Magenta EO02) from Clariant (Japan) K.K.

### Pigment Dispersion Preparation Example 1-10

### Yellow Pigment Dispersion 1-2

The procedure for preparation of the pigment dispersion 1-7 in Pigment Dispersion Preparation Example 1-7 was repeated except for changing the carbon black into Pigment Yellow (Fast Yellow 531) from DAINICHISEIKA COLOR & CHEMICALS MFG CO., LTD.

### Pigment Dispersion Preparation Example 1-11

### Black Pigment Dispersion 1-5

The procedure for preparation of the pigment dispersion 1-2 in Pigment Dispersion Preparation Example 1-2 was repeated except for changing the copolymer R1-13 into R1-1.

### Pigment Dispersion Preparation Example 1-12

### Black Pigment Dispersion 1-6

The procedure for preparation of the pigment dispersion 1-2 in Pigment Dispersion Preparation Example 1-2 was repeated except for changing the copolymer R1-13 into R1-2.

### Pigment Dispersion Preparation Example 1-13

### Black Pigment Dispersion 1-7

The procedure for preparation of the pigment dispersion 1-2 in Pigment Dispersion Preparation Example 1-2 was repeated except for changing the copolymer R1-13 into R1-3.

### Pigment Dispersion Preparation Example 1-14

### Black Pigment Dispersion 1-8

The procedure for preparation of the pigment dispersion 1-2 in Pigment Dispersion Preparation Example 1-2 was repeated except for changing the copolymer R1-13 into R1-4.

### Pigment Dispersion Preparation Example 1-15

### Black Pigment Dispersion 1-9

The procedure for preparation of the pigment dispersion 1-2 in Pigment Dispersion Preparation Example 1-2 was repeated except for changing the copolymer R1-13 into R1-5.

### Pigment Dispersion Preparation Example 1-16

### Black Pigment Dispersion 1-10

The procedure for preparation of the pigment dispersion 1-2 in Pigment Dispersion Preparation Example 1-2 was repeated except for changing the copolymer R1-13 into R1-6.

### Pigment Dispersion Preparation Example 1-17

### Black Pigment Dispersion 1-11

The procedure for preparation of the pigment dispersion 1-2 in Pigment Dispersion Preparation Example 1-2 was repeated except for changing the copolymer R1-13 into R1-7.

### Pigment Dispersion Preparation Example 1-18

### Black Pigment Dispersion 1-12

The procedure for preparation of the pigment dispersion 1-2 in Pigment Dispersion Preparation Example 1-2 was repeated except for changing the copolymer R1-13 into R1-8.

### Pigment Dispersion Preparation Example 1-19

### Black Pigment Dispersion 1-13

The procedure for preparation of the pigment dispersion 1-2 in Pigment Dispersion Preparation Example 1-2 was repeated except for changing the copolymer R1-13 into R1-9.

### Pigment Dispersion Preparation Example 1-20

### Black Pigment Dispersion 1-14

The procedure for preparation of the pigment dispersion 1-2 in Pigment Dispersion Preparation Example 1-2 was repeated except for changing the copolymer R1-13 into R1-10.

### Pigment Dispersion Preparation Example 1-21

### Black Pigment Dispersion 1-15

The procedure for preparation of the pigment dispersion 1-2 in Pigment Dispersion Preparation Example 1-2 was repeated except for changing the copolymer R1-13 into R1-11.

### Pigment Dispersion Preparation Example 1-22

### Black Pigment Dispersion 1-16

The procedure for preparation of the pigment dispersion 1-2 in Pigment Dispersion Preparation Example 1-2 was repeated except for changing the copolymer R1-13 into R1-12.

### Pigment Dispersion Preparation Example 1-23

### Black Pigment Dispersion 1-17

The procedure for preparation of the pigment dispersion 1-2 in Pigment Dispersion Preparation Example 1-2 was repeated except for changing the copolymer R1-13 into R1-14.

### Pigment Dispersion Preparation Example 1-24

### Black Pigment Dispersion 1-18

The procedure for preparation of the pigment dispersion 1-2 in Pigment Dispersion Preparation Example 1-2 was repeated except for changing the copolymer R1-13 into R1-15.

### Pigment Dispersion Preparation Example 1-25

### Black Pigment Dispersion 1-19

The procedure for preparation of the pigment dispersion 1-2 in Pigment Dispersion Preparation Example 1-2 was repeated except for changing the copolymer R1-13 into R1-16.

### Pigment Dispersion Preparation Example 1-26

### Black Pigment Dispersion 1-20

The procedure for preparation of the pigment dispersion 1-2 in Pigment Dispersion Preparation Example 1-2 was repeated except for changing the copolymer R1-13 into R1-17.

### Pigment Dispersion Preparation Example 1-27

### Black Pigment Dispersion 1-21

The procedure for preparation of the pigment dispersion 1-2 in Pigment Dispersion Preparation Example 1-2 was repeated except for changing the copolymer R1-13 into R1-18.

### Pigment Dispersion Preparation Example 1-28

### Black Pigment Dispersion 1-22

The procedure for preparation of the pigment dispersion 1-2 in Pigment Dispersion Preparation Example 1-2 was repeated except for changing the copolymer R1-13 into R1-19.

### Pigment Dispersion Preparation Example 1-29

### Black Pigment Dispersion 1-23

The procedure for preparation of the pigment dispersion 1-2 in Pigment Dispersion Preparation Example 1-2 was repeated except for changing the copolymer R1-13 into R1-20.

### Pigment Dispersion Preparation Example 1-30

### Black Pigment Dispersion 1-24

The procedure for preparation of the pigment dispersion 1-2 in Pigment Dispersion Preparation Example 1-2 was repeated except for changing the copolymer R1-13 into R1-21.

### Pigment Dispersion Preparation Example 1-31

### Black Pigment Dispersion 1-25

The procedure for preparation of the pigment dispersion 1-2 in Pigment Dispersion Preparation Example 1-2 was repeated except for changing the copolymer R1-13 into R1-22.

### Pigment Dispersion Preparation Example 1-32

### Black Pigment Dispersion 1-26

The procedure for preparation of the pigment dispersion 1-2 in Pigment Dispersion Preparation Example 1-2 was repeated except for changing the copolymer R1-13 into R1-23.

### Pigment Dispersion Preparation Example 1-33

### Black Pigment Dispersion 1-27

The procedure for preparation of the pigment dispersion 1-2 in Pigment Dispersion Preparation Example 1-2 was repeated except for changing the copolymer R1-13 into R1-24.

### Pigment Dispersion Preparation Example 1-34

### Black Pigment Dispersion 1-28

The procedure for preparation of the pigment dispersion 1-2 in Pigment Dispersion Preparation Example 1-2 was repeated except for changing the copolymer R1-13 into R1-25.

### Pigment Dispersion Preparation Example 1-35

### Black Pigment Dispersion 1-29

The procedure for preparation of the pigment dispersion 1-2 in Pigment Dispersion Preparation Example 1-2 was repeated except for changing the copolymer R1-13 into R1-26.

### Pigment Dispersion Preparation Example 1-36

### Black Pigment Dispersion 1-30

The procedure for preparation of the pigment dispersion 1-2 in Pigment Dispersion Preparation Example 1-2 was repeated except for changing the copolymer R1-13 into R-100.

### Examples 1-1 to 1-34 and Comparative Examples 1-1 to 1-5

### Preparation of Ink for Inkjet Recording

Ink compositions of Examples 1-1 to 1-34 and Comparative Examples 1-1 to 1-5 are shown in Table 7. The numbers are % by weight.

The inks were prepared by the following method.

First, the materials shown in Tables 7-1 to 7-5 were mixed and stirred for 1 hr to be uniformly mixed. The resultant dispersion was subjected to pressure filtration by a polyvinylidenefluoride membrane filter having an average pore diameter of 5.0 μm to remove coarse particles and dusts. Thus, a recording ink was prepared.

TABLE 7-1

| | | Example 1- | | | | |
|---|---|---|---|---|---|---|
| | | 1 | 2 | 3 | 4 | 5 |
| Pigment | Pigment dispersion 1-1 | 50 | | | | |
| Dispersion | Pigment dispersion 1-2 | | 50 | 50 | 50 | |
| | Pigment dispersion 1-3 | | | | | 50 |
| | Pigment dispersion 1-4 | | | | | |
| | Pigment dispersion 1-5 | | | | | |
| | Pigment dispersion 1-6 | | | | | |
| | Pigment dispersion 1-7 | | | | | |
| | Pigment dispersion 1-8 | | | | | |
| | Pigment dispersion 1-9 | | | | | |
| | Pigment dispersion 1-10 | | | | | |
| | Pigment dispersion 1-11 | | | | | |
| | Pigment dispersion 1-12 | | | | | |
| | Pigment dispersion 1-13 | | | | | |
| | Pigment dispersion 1-14 | | | | | |
| | Pigment dispersion 1-15 | | | | | |
| | Pigment dispersion 1-16 | | | | | |
| | Pigment dispersion 1-17 | | | | | |
| | Pigment dispersion 1-18 | | | | | |
| | Pigment dispersion 1-19 | | | | | |
| | Pigment dispersion 1-20 | | | | | |
| | Pigment dispersion 1-21 | | | | | |
| | Pigment dispersion 1-22 | | | | | |
| | Pigment dispersion 1-23 | | | | | |
| | Pigment dispersion 1-24 | | | | | |
| | Pigment dispersion 1-25 | | | | | |
| | Pigment dispersion 1-26 | | | | | |
| | Pigment dispersion 1-27 | | | | | |
| | Pigment dispersion 1-28 | | | | | |
| | Pigment dispersion 1-29 | | | | | |
| | Pigment dispersion 1-30 | | | | | |
| | Pigment dispersion 1-31 | | | | | |
| | Pigment dispersion 1-32 | | | | | |
| | Pigment dispersion 1-33 | | | | | |
| | Pigment dispersion 1-34 | | | | | |
| | Pigment dispersion 1-35 | | | | | |
| | Pigment dispersion 1-36 | | | | | |
| Additive | R1-13 | | | | 20 | |
| Water- | Glycerin | 10 | 10 | | | 10 |
| soluble | 1,3-butanediol | 20 | 20 | 30 | | 20 |
| solvent | Trimethylol propane | | | | 5 | |
| | 2-pyrrolidone | | | | 5 | |
| Solvent | High-purity water | Balance | Balance | Balance | Balance | Balance |
| | Total | 100 | 100 | 100 | 100 | 100 |

TABLE 7-2

| | | Example 1- | | | | | | | | |
|---|---|---|---|---|---|---|---|---|---|---|
| | | 6 | 7 | 8 | 9 | 10 | 11 | 12 | 13 | 14 |
| Pigment | Pigment dispersion 1-1 | | | | | | | | | |
| Dispersion | Pigment dispersion 1-2 | | | | | | | | | |
| | Pigment dispersion 1-3 | | | | | | | | | |
| | Pigment dispersion 1-4 | 30 | | | | | | | | |
| | Pigment dispersion 1-5 | | 50 | | | | | | | |
| | Pigment dispersion 1-6 | | | 30 | | | | | | |
| | Pigment dispersion 1-7 | | | | 50 | | | | | |
| | Pigment dispersion 1-8 | | | | | | | | | |
| | Pigment dispersion 1-9 | | | | | | | | | |
| | Pigment dispersion 1-10 | | | | | | | | | |
| | Pigment dispersion 1-11 | | | | | 50 | | | | |
| | Pigment dispersion 1-12 | | | | | | 50 | | | |
| | Pigment dispersion 1-13 | | | | | | | 50 | | |
| | Pigment dispersion 1-14 | | | | | | | | 50 | |
| | Pigment dispersion 1-15 | | | | | | | | | 50 |
| | Pigment dispersion 1-16 | | | | | | | | | |
| | Pigment dispersion 1-17 | | | | | | | | | |
| | Pigment dispersion 1-18 | | | | | | | | | |
| | Pigment dispersion 1-19 | | | | | | | | | |
| | Pigment dispersion 1-20 | | | | | | | | | |
| | Pigment dispersion 1-21 | | | | | | | | | |
| | Pigment dispersion 1-22 | | | | | | | | | |
| | Pigment dispersion 1-23 | | | | | | | | | |
| | Pigment dispersion 1-24 | | | | | | | | | |
| | Pigment dispersion 1-25 | | | | | | | | | |
| | Pigment dispersion 1-26 | | | | | | | | | |
| | Pigment dispersion 1-27 | | | | | | | | | |
| | Pigment dispersion 1-28 | | | | | | | | | |
| | Pigment dispersion 1-29 | | | | | | | | | |
| | Pigment dispersion 1-30 | | | | | | | | | |
| | Pigment dispersion 1-31 | | | | | | | | | |
| | Pigment dispersion 1-32 | | | | | | | | | |
| | Pigment dispersion 1-33 | | | | | | | | | |
| | Pigment dispersion 1-34 | | | | | | | | | |
| | Pigment dispersion 1-35 | | | | | | | | | |
| | Pigment dispersion 1-36 | | | | | | | | | |
| Additive | R1-13 | | | | 4 | | | | | |
| Water- | Glycerin | 10 | 10 | 10 | 10 | 10 | 10 | 10 | 10 | 10 |
| soluble | 1,3-butanediol | 20 | 20 | 20 | 20 | 20 | 20 | 20 | 20 | 20 |
| solvent | Trimethylol propane | | | | | | | | | |
| | 2-pyrrolidone | | | | | | | | | |
| Solvent | High-purity water | Balance | Balance | Balance | Balance | Balance | Balance | Balance | Balance | Balance |
| | Total | 100 | 100 | 100 | 100 | 100 | 100 | 100 | 100 | 100 |

TABLE 7-3

| | | Example 1- | | | | | | | | |
|---|---|---|---|---|---|---|---|---|---|---|
| | | 15 | 16 | 17 | 18 | 19 | 20 | 21 | 22 | 23 |
| Pigment | Pigment dispersion 1-1 | | | | | | | | | |
| Dispersion | Pigment dispersion 1-2 | | | | | | | | | |
| | Pigment dispersion 1-3 | | | | | | | | | |
| | Pigment dispersion 1-4 | | | | | | | | | |
| | Pigment dispersion 1-5 | | | | | | | | | |
| | Pigment dispersion 1-6 | | | | | | | | | |
| | Pigment dispersion 1-7 | | | | | | | | | |
| | Pigment dispersion 1-8 | | | | | | | | | |
| | Pigment dispersion 1-9 | | | | | | | | | |
| | Pigment dispersion 1-10 | | | | | | | | | |
| | Pigment dispersion 1-11 | | | | | | | | | |
| | Pigment dispersion 1-12 | | | | | | | | | |
| | Pigment dispersion 1-13 | | | | | | | | | |
| | Pigment dispersion 1-14 | | | | | | | | | |
| | Pigment dispersion 1-15 | | | | | | | | | |
| | Pigment dispersion 1-16 | 50 | | | | | | | | |
| | Pigment dispersion 1-17 | | 50 | | | | | | | |
| | Pigment dispersion 1-18 | | | 50 | | | | | | |
| | Pigment dispersion 1-19 | | | | 50 | | | | | |
| | Pigment dispersion 1-20 | | | | | 50 | | | | |
| | Pigment dispersion 1-21 | | | | | | 50 | | | |
| | Pigment dispersion 1-22 | | | | | | | 50 | | |
| | Pigment dispersion 1-23 | | | | | | | | 50 | |
| | Pigment dispersion 1-24 | | | | | | | | | 50 |
| | Pigment dispersion 1-25 | | | | | | | | | |
| | Pigment dispersion 1-26 | | | | | | | | | |
| | Pigment dispersion 1-27 | | | | | | | | | |
| | Pigment dispersion 1-28 | | | | | | | | | |
| | Pigment dispersion 1-29 | | | | | | | | | |
| | Pigment dispersion 1-30 | | | | | | | | | |
| | Pigment dispersion 1-31 | | | | | | | | | |
| | Pigment dispersion 1-32 | | | | | | | | | |
| | Pigment dispersion 1-33 | | | | | | | | | |
| | Pigment dispersion 1-34 | | | | | | | | | |
| | Pigment dispersion 1-35 | | | | | | | | | |
| | Pigment dispersion 1-36 | | | | | | | | | |
| Additive | R1-13 | | | | | | | | | |
| Water- | Glycerin | 10 | 10 | 10 | 10 | 10 | 10 | 10 | 10 | 10 |
| soluble | 1,3-butanediol | 20 | 20 | 20 | 20 | 20 | 20 | 20 | 20 | 20 |
| solvent | Trimethylol propane | | | | | | | | | |
| | 2-pyrrolidone | | | | | | | | | |
| Solvent | High-purity water | Balance | Balance | Balance | Balance | Balance | Balance | Balance | Balance | Balance |
| | Total | 100 | 100 | 100 | 100 | 100 | 100 | 100 | 100 | 100 |

TABLE 7-4

| | | Example 1- | | | | | | | | |
|---|---|---|---|---|---|---|---|---|---|---|
| | | 24 | 25 | 26 | 27 | 28 | 29 | 30 | 31 | 32 |
| Pigment | Pigment dispersion 1-1 | | | | | | | | | |
| Dispersion | Pigment dispersion 1-2 | | | | | | | | | |
| | Pigment dispersion 1-3 | | | | | | | | | |
| | Pigment dispersion 1-4 | | | | | | | | | |
| | Pigment dispersion 1-5 | | | | | | | | | |
| | Pigment dispersion 1-6 | | | | | | | | | |
| | Pigment dispersion 1-7 | | | | | | | | | |
| | Pigment dispersion 1-8 | | | | | | | | | |
| | Pigment dispersion 1-9 | | | | | | | | | |
| | Pigment dispersion 1-10 | | | | | | | | | |
| | Pigment dispersion 1-11 | | | | | | | | | |
| | Pigment dispersion 1-12 | | | | | | | | | |
| | Pigment dispersion 1-13 | | | | | | | | | |
| | Pigment dispersion 1-14 | | | | | | | | | |
| | Pigment dispersion 1-15 | | | | | | | | | |
| | Pigment dispersion 1-16 | | | | | | | | | |
| | Pigment dispersion 1-17 | | | | | | | | | |
| | Pigment dispersion 1-18 | | | | | | | | | |
| | Pigment dispersion 1-19 | | | | | | | | | |
| | Pigment dispersion 1-20 | | | | | | | | | |
| | Pigment dispersion 1-21 | | | | | | | | | |
| | Pigment dispersion 1-22 | | | | | | | | | |
| | Pigment dispersion 1-23 | | | | | | | | | |
| | Pigment dispersion 1-24 | | | | | | | | | |
| | Pigment dispersion 1-25 | 50 | | | | | | | | |
| | Pigment dispersion 1-26 | | 50 | | | | | | | |
| | Pigment dispersion 1-27 | | | 50 | | | | | | |
| | Pigment dispersion 1-28 | | | | 50 | | | | | |
| | Pigment dispersion 1-29 | | | | | 50 | | | | |
| | Pigment dispersion 1-30 | | | | | | 50 | | | |
| | Pigment dispersion 1-31 | | | | | | | 50 | | |
| | Pigment dispersion 1-32 | | | | | | | | 50 | |
| | Pigment dispersion 1-33 | | | | | | | | | 50 |
| | Pigment dispersion 1-34 | | | | | | | | | |
| | Pigment dispersion 1-35 | | | | | | | | | |
| | Pigment dispersion 1-36 | | | | | | | | | |
| Additive | R1-13 | | | | | | | | | |
| Water- | Glycerin | 10 | 10 | 10 | 10 | 10 | 10 | 10 | 10 | 10 |
| soluble | 1,3-butanediol | 20 | 20 | 20 | 20 | 20 | 20 | 20 | 20 | 20 |
| solvent | Trimethylol propane | | | | | | | | | |
| | 2-pyrrolidone | | | | | | | | | |
| Solvent | High-purity water | Balance | Balance | Balance | Balance | Balance | Balance | Balance | Balance | Balance |
| | Total | 100 | 100 | 100 | 100 | 100 | 100 | 100 | 100 | 100 |

TABLE 7-5

| | | Example 1- | | Comparative Example 1- | | | | |
|---|---|---|---|---|---|---|---|---|
| | | 33 | 34 | 1 | 2 | 3 | 4 | 5 |
| Pigment | Pigment dispersion 1-1 | | | | | | | |
| Dispersion | Pigment dispersion 1-2 | | | | | | | |
| | Pigment dispersion 1-3 | | | | | | | |
| | Pigment dispersion 1-4 | | | | | | | |
| | Pigment dispersion 1-5 | | | | | | | |
| | Pigment dispersion 1-6 | | | | | | | |
| | Pigment dispersion 1-7 | | | | 50 | | | |
| | Pigment dispersion 1-8 | | | | | 30 | | |
| | Pigment dispersion 1-9 | | | | | | 50 | |
| | Pigment dispersion 1-10 | | | | | | | 30 |
| | Pigment dispersion 1-11 | | | | | | | |
| | Pigment dispersion 1-12 | | | | | | | |
| | Pigment dispersion 1-13 | | | | | | | |
| | Pigment dispersion 1-14 | | | | | | | |
| | Pigment dispersion 1-15 | | | | | | | |
| | Pigment dispersion 1-16 | | | | | | | |
| | Pigment dispersion 1-17 | | | | | | | |
| | Pigment dispersion 1-18 | | | | | | | |
| | Pigment dispersion 1-19 | | | | | | | |
| | Pigment dispersion 1-20 | | | | | | | |
| | Pigment dispersion 1-21 | | | | | | | |
| | Pigment dispersion 1-22 | | | | | | | |
| | Pigment dispersion 1-23 | | | | | | | |
| | Pigment dispersion 1-24 | | | | | | | |
| | Pigment dispersion 1-25 | | | | | | | |
| | Pigment dispersion 1-26 | | | | | | | |
| | Pigment dispersion 1-27 | | | | | | | |
| | Pigment dispersion 1-28 | | | | | | | |
| | Pigment dispersion 1-29 | | | | | | | |
| | Pigment dispersion 1-30 | | | | | | | |
| | Pigment dispersion 1-31 | | | | | | | |
| | Pigment dispersion 1-32 | | | | | | | |
| | Pigment dispersion 1-33 | | | | | | | |
| | Pigment dispersion 1-34 | 50 | | | | | | |
| | Pigment dispersion 1-35 | | 50 | | | | | |
| | Pigment dispersion 1-36 | | | 50 | | | | |
| Additive | R1-13 | | | | | | | |
| Water- | Glycerin | 10 | 10 | 10 | 10 | 10 | 10 | 10 |
| soluble | 1,3-butanediol | 20 | 20 | 20 | 20 | 20 | 20 | 20 |
| solvent | Trimethylol propane | | | | | | | |
| | 2-pyrrolidone | | | | | | | |
| Solvent | High-purity water | Balance | Balance | Balance | Balance | Balance | Balance | Balance |
| | Total | 100 | 100 | 100 | 100 | 100 | 100 | 100 |

### <Preservation Stability of Pigment Dispersions and Inks>

The viscosities of the pigment dispersions 1-1 to 1-36, and the inks of Examples 1-1 to 1-34 and Comparative Examples 1-1 to 1-5 were measured by, e.g., a viscometer RE80L from TOKI SANGYO CO., LTD. at 25° C., adjusting the rotational number at from 50 to 100 rpm according the viscosities. As an index of dispersion stability of the pigment dispersion and the pigment in the ink, the initial viscosities of the pigment dispersions and the inks were measured to evaluate under the following standard.

As for the preservability, after the initial viscosities thereof were measured, each of them were placed in a polyethylene container and sealed. The viscosity after stored at 70° C. for 1 week was measured to evaluate under the following standard, compared with the initial viscosity.

### [Pigment Dispersion Evaluation Standard]

### Initial Viscosity

Good: less than 7 mPa·s

Average: not less than 7 mPa·s and less than 20 mPa·s

Poor: not less than 20 mPa·s

Preservability (Change Rate of Viscosity after Stored)

Good: less than 5%

Average: not less than 5% less than 50%

Poor: not less than 50%

### [Ink Evaluation Standard]

### Initial Viscosity

Good: less than 9 mPa·s

Average: not less than 9 mPa·s and less than 20 mPa·s

Poor: not less than 20 mPa·s

Preservability (Change Rate of Viscosity after Stored)

Good: less than 5%

Average: not less than 5% less than 50%

Poor: not less than 50%

### <Printed Image Evaluation>

Printed images by the inks of Examples 1-1 to 1-34 and Comparative Examples 1-1 to 1-5 were evaluated.

A drive voltage of piezo element of an inkjet printer IPSiO GX3000 from Ricoh Company, Ltd. was changed to uniformly discharge the ink such that the same amount of the ink adheres to a recording material. The results are shown in Table 8.

### <<Image Density>>

After a chart on which general marks JIS X 0208 (1997) and 2223 having 64 points are described by Microsoft Word 2003 was printed on My Paper having a weight of 69.6 g/m², a sizing degree of 23.2 sec and an air permeability of 21.0 sec, the image density of the general marks JIS X 0208 (1997) and 2223 was evaluated using X-Rite938 from X-Rite, Inc. Then, the printing mode was “plain paper-fast” mode by a driver of the printer. The general marks JIS X 0208 (1997) and 2223 has the outer form of a square and the whole surface was filled with ink.

Image density was evaluated under the following standard.

### [Evaluation Standard]

Excellent: OD value Black not less than 1.30
Yellow not less than 0.80
Magenta not less than 1.00
Cyan not less than 1.10

Good: OD value Black not less than 1.20 less than 1.30
Yellow not less than 0.75 less than 0.80
Magenta not less than 0.90 less than 1.00
Cyan not less than 1.00 less than 1.10

Average: OD value Black not less than 1.10 less than 1.20
Yellow not less than 0.70 less than 0.75
Magenta not less than 0.80 less than 0.90
Cyan not less than 0.90 less than 1.00

Fair: OD value Black not less than 1.00 less than 1.10
Yellow not less than 0.65 less than 0.70
Magenta not less than 0.70 less than 0.80
Cyan not less than 0.80 less than 0.90

Poor: OD value Black less than 1.00
Yellow less than 0.65
Magenta less than 0.70
Cyan less than 0.80

TABLE 8

| | Pigment | Image | Pigment Dispersion | | Ink | |
|---|---|---|---|---|---|---|
| | Dispersion | Density | Viscosity | Preservation | Viscosity | Preservation |
| Example 1-1 | 1-1 | Excellent | Good | Good | Good | Average |
| Example 1-2 | 1-2 | Excellent | Good | Good | Good | Average |
| Example 1-3 | 1-2 | Excellent | Good | Good | Good | Average |
| Example 1-4 | 1-2 | Excellent | Good | Good | Good | Average |
| Example 1-5 | 1-3 | Excellent | Good | Good | Average | Good |
| Example 1-6 | 1-4 | Excellent | Good | Good | Good | Average |
| Example 1-7 | 1-5 | Excellent | Good | Good | Good | Average |
| Example 1-8 | 1-6 | Excellent | Good | Good | Good | Average |
| Example 1-9 | 1-7 | Excellent | Good | Average | Good | Average |
| Example 1-10 | 1-11 | Good | Good | Good | Average | Average |
| Example 1-11 | 1-12 | Average | Good | Good | Average | Average |
| Example 1-12 | 1-13 | Good | Good | Good | Average | Average |
| Example 1-13 | 1-14 | Good | Good | Good | Average | Average |
| Example 1-14 | 1-15 | Excellent | Average | Average | Average | Average |
| Example 1-15 | 1-16 | Excellent | Good | Good | Good | Average |
| Example 1-16 | 1-17 | Excellent | Average | Good | Average | Average |
| Example 1-17 | 1-18 | Excellent | Average | Average | Average | Average |
| Example 1-18 | 1-19 | Excellent | Good | Good | Good | Average |
| Example 1-19 | 1-20 | Good | Good | Average | Average | Average |
| Example 1-20 | 1-21 | Average | Good | Good | Average | Average |
| Example 1-21 | 1-22 | Good | Good | Good | Average | Average |
| Example 1-22 | 1-23 | Good | Good | Good | Average | Average |
| Example 1-23 | 1-24 | Excellent | Good | Good | Good | Average |
| Example 1-24 | 1-25 | Excellent | Average | Good | Average | Average |
| Example 1-25 | 1-26 | Average | Good | Average | Average | Average |
| Example 1-26 | 1-27 | Good | Average | Average | Average | Average |
| Example 1-27 | 1-28 | Excellent | Good | Good | Good | Average |
| Example 1-28 | 1-29 | Excellent | Good | Good | Good | Average |
| Example 1-29 | 1-30 | Excellent | Good | Good | Good | Average |
| Example 1-30 | 1-31 | Excellent | Good | Good | Good | Average |
| Example 1-31 | 1-32 | Excellent | Good | Good | Good | Average |
| Example 1-32 | 1-33 | Excellent | Good | Good | Good | Good |
| Example 1-33 | 1-34 | Excellent | Good | Good | Good | Good |
| Example 1-34 | 1-35 | Excellent | Good | Good | Good | Good |
| Comparative | 1-36 | Average | Average | Poor | Average | Poor |
| Example 1-1 | | | | | | |
| Comparative | 1-7 | Fair | Average | Poor | Average | Average |
| Example 1-2 | | | | | | |
| Comparative | 1-8 | Fair | Average | Average | Average | Average |
| Example 1-3 | | | | | | |
| Comparative | 1-9 | Fair | Average | Poor | Average | Poor |
| Example 1-4 | | | | | | |
| Comparative | 1-10 | Fair | Average | Average | Average | Average |
| Example 1-5 | | | | | | |

### Synthesis Example 2-1 of Copolymer Including a Salt of Phosphonic Acid Group

In a reaction container including a gas inlet tube, a thermometer and a reflux condenser, in an argon atmosphere, 300 parts of methyl ethyl ketone, 50 parts of vinyl phosphate from Tokyo Chemical Industry Co., Ltd., 50 parts of 1-heptene from Tokyo Chemical Industry Co., Ltd., and 3 parts of 1-dodecanthiol as a molecular weight adjuster from Tokyo Chemical Industry Co., Ltd. were placed to prepare a solution, and argon gas displacement was performed for 30 min while the solution was stirred to prepare a mixed solution. In an argon atmosphere, the mixed solution was heated to have a temperature of 60° C. while stirred, and a solution including a half of 6 parts of a polymerization initiator 2,2′-azobis(2,4-dimethylvaleronitrile) and methyl ethyl ketone was dripped therein with a dripping funnel. After dripped, the temperature of the mixed liquid was maintained at 60° C. for 4 hrs. Then, the remaining solution of the polymerization initiator was dripped and reacted at 60° C. for 10 hrs to prepare a copolymer solution. The copolymer solution was placed in a large amount of n-hexane to precipitate the copolymer and a solvent was removed therefrom by decantation. Further, the precipitated product was dried to prepare a copolymer including a phosphonic acid group.

The copolymer was dissolved in ethanol to prepare a solution, and potassium hydroxide dissolved in methanol was added and mixed therein so as to be completely disacidified. After the mixture was stirred, a solvent was removed by an evaporator, and further dried in a vacuum to prepare a copolymer R2-1 having a neutralized phosphonic acid group.

A viscosity of an aqueous solution including the R2-1 in an amount of 10% by weight at 25° C. is shown in Table 9.

### Synthesis Example 2-2 to 2-62 of Copolymer Including a Salt of Phosphonic Acid Group

The procedure for preparation of the copolymer including a salt of phosphonic acid group in Synthesis Example 2-1 was repeated except for replacing 1-heptene with an alkylene monomer, changing a compositional ratio of the vinyl phosphonic acid to the alkylene monomer of from 15/85 to 65/35, changing the amount of the molecular weight adjuster from 0 to 6 parts by weight, changing the amount of the polymerization initiator from 3 to 10 parts by weight. Further, sodium hydroxide, potassium hydroxide, triethanol amine, trimethyl amine, diethanol amine and triethyl amine were used as the neutralizer such that neutralization rates were from 80 to 100% to prepare copolymers R2-2 to R2-62 each having a neutralized phosphonic acid group. The results are shown in Table 9.

TABLE 9

| | | | M+ proton | |
|---|---|---|---|---|
| | | Formula (1) | content rate | |
| | Compositional | content rate | in formula (1) | Viscosity |
| | Combination No. | (% by weight) | (% by mol) | (mPa · s) |
| R2-1 | 2-1 | 50 | — | 5.0 |
| R2-2 | 2-7 | 50 | — | 5.5 |
| R2-3 | 2-13 | 50 | — | 4.8 |
| R2-4 | 2-15 | 50 | — | 5.3 |
| R2-5 | 2-17 | 50 | — | 5.2 |
| R2-6 | 2-19 | 50 | — | 5.8 |
| R2-7 | 2-21 | 50 | — | 5.9 |
| R2-8 | 2-24 | 50 | — | 5.6 |
| R2-9 | 2-25 | 50 | 10 | 4.8 |
| R2-10 | 2-31 | 50 | 5 | 5.4 |
| R2-11 | 2-37 | 50 | 5 | 4.7 |
| R2-12 | 2-39 | 50 | 15 | 5.1 |
| R2-13 | 2-41 | 50 | 20 | 5.1 |
| R2-14 | 2-43 | 50 | 10 | 5.6 |
| R2-15 | 2-45 | 50 | 5 | 5.8 |
| R2-16 | 2-48 | 50 | 5 | 5.5 |
| R2-17 | 2-49 | 50 | — | 4.8 |
| R2-18 | 2-55 | 50 | — | 5.3 |
| R2-19 | 2-61 | 50 | — | 4.7 |
| R2-20 | 2-63 | 50 | — | 5.0 |
| R2-21 | 2-65 | 50 | — | 4.7 |
| R2-22 | 2-67 | 50 | — | 5.3 |
| R2-23 | 2-69 | 50 | — | 5.8 |
| R2-24 | 2-72 | 50 | — | 5.3 |
| R2-25 | 2-73 | 50 | 10 | 4.6 |
| R2-26 | 2-79 | 50 | 10 | 5.1 |
| R2-27 | 2-85 | 50 | 10 | 4.5 |
| R2-28 | 2-87 | 50 | 5 | 4.8 |
| R2-29 | 2-89 | 50 | 5 | 4.9 |
| R2-30 | 2-91 | 50 | 5 | 5.2 |
| R2-31 | 2-93 | 50 | 5 | 5.6 |
| R2-32 | 2-96 | 50 | 5 | 5.5 |
| R2-33 | 2-111 | 50 | — | 4.6 |
| R2-34 | 2-135 | 50 | 5 | 4.8 |
| R2-35 | 2-165 | 50 | — | 5.1 |
| R2-36 | 2-189 | 50 | 5 | 5.2 |
| R2-37 | 2-17 | 15 | — | 3.2 |
| R2-38 | 2-17 | 20 | — | 2.8 |
| R2-39 | 2-17 | 30 | — | 3.3 |
| R2-40 | 2-17 | 35 | — | 3.5 |
| R2-41 | 2-17 | 40 | — | 3.4 |
| R2-42 | 2-17 | 55 | — | 3.5 |
| R2-43 | 2-17 | 65 | — | 3.7 |
| R2-44 | 2-17 | 35 | — | 1.6 |
| R2-45 | 2-17 | 35 | — | 5.4 |
| R2-46 | 2-17 | 35 | — | 33 |
| R2-47 | 2-17 | 35 | — | 43 |
| R2-48 | 2-17 | 15 | — | 1.5 |
| R2-49 | 2-17 | 65 | — | 39 |
| R2-50 | 2-63 | 15 | — | 2.6 |
| R2-51 | 2-63 | 20 | — | 2.9 |
| R2-52 | 2-63 | 30 | — | 3.3 |
| R2-53 | 2-63 | 35 | — | 3.3 |
| R2-54 | 2-63 | 40 | — | 3.6 |
| R2-55 | 2-63 | 55 | — | 3.9 |
| R2-56 | 2-63 | 65 | — | 4.0 |
| R2-57 | 2-63 | 35 | — | 1.3 |
| R2-58 | 2-63 | 35 | — | 5.1 |
| R2-59 | 2-63 | 35 | — | 29 |
| R2-60 | 2-63 | 35 | — | 37 |
| R2-61 | 2-63 | 15 | — | 1.5 |
| R2-62 | 2-63 | 65 | — | 44 |

Examples of the copolymer including a salt of phosphonic acid group in Table 9 do not cover all compositional combinations in Tables 2-1 to 2-4, but the other compositional combinations not shown in Table 9 have the same effects.

### Synthesis Example of Copolymer R-100 Including Phosphoric Acid Group

With reference to a synthesis example in Japanese published unexamined application No. JP-2011-122072-A, 30 parts of styrene, 20 parts of methylmethacrylate, 15 parts of butylmethacrylate, 10 parts of methacrylate, 20 parts of phosmer M (monomer including a phosphoric acid group from Uni-Chemical Co., Ltd.) and 5 parts of azobisisobutylonitrile were polymerized to prepare a copolymer R-100 including a phosphoric acid group.

Similarly to the copolymer R1-1 including a salt of a phosphonic acid group, the copolymer R-100 including a phosphoric acid group was neutralized with sodium hydroxide to be completely neutralized to prepare a copolymer R-100 including a salt of a phosphoric acid group. An aqueous solution including the R-100 in an amount of 10% by weight had a viscosity of 9.1 mPa·s at 25° C.

### Pigment Dispersion Preparation Examples 2-1 to 2-73

Each of materials of pigment dispersions 2-1 to 2-73 in Tables 10-1 to 10-3 were premixed to prepare a mixed slurry. For examples, pigment dispersion 2-1 was a mixture of 4 parts of R2-1, 16 parts of carbon black and 80 parts of high-purity water. This was subjected to a circulation dispersion by a disc type media mill (DMR from Ashizawa Finetech Ltd.) with 0.05 mm zirconia beads at a filling rate of 55%, a peripheral speed of 10 m/s, a liquid temperature of 10° C. for 3 min. Then, the resultant dispersion was subjected to centrifugal separation by a centrifugal separator Model 7700 from KUBOTA Corporation to separate coarse particles to prepare a pigment dispersion 1-1 having a pigment concentration of 16% by weight.

The numbers in Tables 10-1 to 10-12 are parts by weight.

NIPEX160 is from Degussa AG, and has a BET specific surface area of 150 m²/g, an average primary particle diameter of 20 nm, a pH of 4.0 and a DBP oil absorption of 620 g/100 g.

RT-100 is POE (m=40) β-naphthylether.

TABLE 10-1

| | | Pigment Dispersion 2- | | | | |
|---|---|---|---|---|---|---|
| | | 1 | 2 | 3 | 4 | 5 |
| R2-1 | | 4 | | | | |
| R2-2 | | | 4 | | | |
| R2-3 | | | | 4 | | |
| R2-4 | | | | | 4 | |
| R2-5 | | | | | | 4 |
| R2-6 | | | | | | |
| R2-7 | | | | | | |
| R2-8 | | | | | | |
| R2-9 | | | | | | |
| R2-10 | | | | | | |
| R2-11 | | | | | | |
| R2-12 | | | | | | |
| R2-13 | | | | | | |
| R2-14 | | | | | | |
| R2-15 | | | | | | |
| R2-16 | | | | | | |
| R2-17 | | | | | | |
| R2-18 | | | | | | |
| R2-19 | | | | | | |
| R2-20 | | | | | | |
| R2-21 | | | | | | |
| R2-22 | | | | | | |
| R2-23 | | | | | | |
| R2-24 | | | | | | |
| R2-25 | | | | | | |
| Dispersant | RT-100 | | | | | |
| (Surfactant) | | | | | | |
| Carbon | NIPEX160 | 16 | 16 | 16 | 16 | 16 |
| black | | | | | | |
| Pigment | CHROMOFINE | | | | | |
| Blue 15:3 | BLUE A-220JC | | | | | |
| | (DAINICHISEIKA) | | | | | |
| Pigment | Toner Magenta | | | | | |
| Red 122 | EO02 (Clariant) | | | | | |
| Pigment | Fast Yellow 531 | | | | | |
| Yellow 74 | (DAINICHISEIKA) | | | | | |
| Solvent | High-purity water | Balance | Balance | Balance | Balance | Balance |

| | | | | | |
|---|---|---|---|---|---|
| Total | 100 | 100 | 100 | 100 | 100 |

TABLE 10-2

| | | Pigment Dispersion 2- | | | | | | | |
|---|---|---|---|---|---|---|---|---|---|
| | | 6 | 7 | 8 | 9 | 10 | 11 | 12 | 13 |
| R2-1 | | | | | | | | | |
| R2-2 | | | | | | | | | |
| R2-3 | | | | | | | | | |
| R2-4 | | | | | | | | | |
| R2-5 | | 4 | | | | | | | |
| R2-6 | | | 4 | | | | | | |
| R2-7 | | | | 4 | | | | | |
| R2-8 | | | | | 4 | | | | |
| R2-9 | | | | | | 4 | | | |
| R2-10 | | | | | | | 4 | | |
| R2-11 | | | | | | | | 4 | |
| R2-12 | | | | | | | | | 4 |
| R2-13 | | | | | | | | | |
| R2-14 | | | | | | | | | |
| R2-15 | | | | | | | | | |
| R2-16 | | | | | | | | | |
| R2-17 | | | | | | | | | |
| R2-18 | | | | | | | | | |
| R2-19 | | | | | | | | | |
| R2-20 | | | | | | | | | |
| R2-21 | | | | | | | | | |
| R2-22 | | | | | | | | | |
| R2-23 | | | | | | | | | |
| R2-24 | | | | | | | | | |
| R2-25 | | | | | | | | | |
| Dispersant | RT-100 | | | | | | | | |
| (Surfactant) | | | | | | | | | |
| Carbon | NIPEX160 | 16 | 16 | 16 | 16 | 16 | 16 | 16 | 16 |
| black | | | | | | | | | |
| Pigment | CHROMOFINE | | | | | | | | |
| Blue 15:3 | BLUE A-220JC | | | | | | | | |
| | (DAINICHISEIKA) | | | | | | | | |
| Pigment | Toner Magenta | | | | | | | | |
| Red 122 | EO02 (Clariant) | | | | | | | | |
| Pigment | Fast Yellow 531 | | | | | | | | |
| Yellow 74 | (DAINICHISEIKA) | | | | | | | | |
| Solvent | High-purity water | Balance | Balance | Balance | Balance | Balance | Balance | Balance | Balance |

| | | | | | | | | |
|---|---|---|---|---|---|---|---|---|
| Total | 100 | 100 | 100 | 100 | 100 | 100 | 100 | 100 |

TABLE 10-3

| | | Pigment Dispersion 2- | | | | | | | |
|---|---|---|---|---|---|---|---|---|---|
| | | 14 | 15 | 16 | 17 | 18 | 19 | 20 | 21 |
| R2-1 | | | | | | | | | |
| R2-2 | | | | | | | | | |
| R2-3 | | | | | | | | | |
| R2-4 | | | | | | | | | |
| R2-5 | | | | | | | | | |
| R2-6 | | | | | | | | | |
| R2-7 | | | | | | | | | |
| R2-8 | | | | | | | | | |
| R2-9 | | | | | | | | | |
| R2-10 | | | | | | | | | |
| R2-11 | | | | | | | | | |
| R2-12 | | | | | | | | | |
| R2-13 | | 4 | | | | | | | |
| R2-14 | | | 4 | | | | | | |
| R2-15 | | | | 4 | | | | | |
| R2-16 | | | | | 4 | | | | |
| R2-17 | | | | | | 4 | | | |
| R2-18 | | | | | | | 4 | | |
| R2-19 | | | | | | | | 4 | |
| R2-20 | | | | | | | | | 4 |
| R2-21 | | | | | | | | | |
| R2-22 | | | | | | | | | |
| R2-23 | | | | | | | | | |
| R2-24 | | | | | | | | | |
| R2-25 | | | | | | | | | |
| Dispersant | RT-100 | | | | | | | | |
| (Surfactant) | | | | | | | | | |
| Carbon | NIPEX160 | 16 | 16 | 16 | 16 | 16 | 16 | 16 | 16 |
| black | | | | | | | | | |
| Pigment | CHROMOFINE | | | | | | | | |
| Blue 15:3 | BLUE A-220JC | | | | | | | | |
| | (DAINICHISEIKA) | | | | | | | | |
| Pigment | Toner Magenta | | | | | | | | |
| Red 122 | EO02 (Clariant) | | | | | | | | |
| Pigment | Fast Yellow 531 | | | | | | | | |
| Yellow 74 | (DAINICHISEIKA) | | | | | | | | |
| Solvent | High-purity water | Balance | Balance | Balance | Balance | Balance | Balance | Balance | Balance |

| | | | | | | | | |
|---|---|---|---|---|---|---|---|---|
| Total | 100 | 100 | 100 | 100 | 100 | 100 | 100 | 100 |

TABLE 10-4

| | | Pigment Dispersion 2- | | | |
|---|---|---|---|---|---|
| | | 22 | 23 | 24 | 25 |
| R2-1 | | | | | |
| R2-2 | | | | | |
| R2-3 | | | | | |
| R2-4 | | | | | |
| R2-5 | | | | | |
| R2-6 | | | | | |
| R2-7 | | | | | |
| R2-8 | | | | | |
| R2-9 | | | | | |
| R2-10 | | | | | |
| R2-11 | | | | | |
| R2-12 | | | | | |
| R2-13 | | | | | |
| R2-14 | | | | | |
| R2-15 | | | | | |
| R2-16 | | | | | |
| R2-17 | | | | | |
| R2-18 | | | | | |
| R2-19 | | | | | |
| R2-20 | | | | | |
| R2-21 | | | | | |
| R2-22 | | 4 | | | |
| R2-23 | | | 4 | | |
| R2-24 | | | | 4 | |
| R2-25 | | | | | 4 |
| Dispersant | RT-100 | | | | |
| (Surfactant) | | | | | |
| Carbon | NIPEX160 | 16 | 16 | 16 | 16 |
| black | | | | | |
| Pigment | CHROMOFINE | | | | |
| Blue 15:3 | BLUE A-220JC | | | | |
| | (DAINICHISEIKA) | | | | |
| Pigment | Toner Magenta | | | | |
| Red 122 | EO02 (Clariant) | | | | |
| Pigment | Fast Yellow 531 | | | | |
| Yellow 74 | (DAINICHISEIKA) | | | | |
| Solvent | High-purity water | Balance | Balance | Balance | Balance |

| | | | | |
|---|---|---|---|---|
| Total | 100 | 100 | 100 | 100 |

TABLE 10-5

| | | Pigment Dispersion 2- | | | | |
|---|---|---|---|---|---|---|
| | | 26 | 27 | 28 | 29 | 30 |
| R2-26 | | 4 | | | | |
| R2-27 | | | 4 | | | |
| R2-28 | | | | 4 | | |
| R2-29 | | | | | 4 | |
| R2-30 | | | | | | 4 |
| R2-31 | | | | | | |
| R2-32 | | | | | | |
| R2-33 | | | | | | |
| R2-34 | | | | | | |
| R2-35 | | | | | | |
| R2-36 | | | | | | |
| R2-37 | | | | | | |
| R2-38 | | | | | | |
| R2-39 | | | | | | |
| R2-40 | | | | | | |
| R2-41 | | | | | | |
| R2-42 | | | | | | |
| R2-43 | | | | | | |
| R2-44 | | | | | | |
| R2-45 | | | | | | |
| R2-46 | | | | | | |
| R2-47 | | | | | | |
| R2-48 | | | | | | |
| R2-49 | | | | | | |
| R2-50 | | | | | | |
| Dispersant | RT-100 | | | | | |
| (Surfactant) | | | | | | |
| Carbon | NIPEX160 | 16 | 16 | 16 | 16 | 16 |
| black | | | | | | |
| Pigment | CHROMOFINE | | | | | |
| Blue 15:3 | BLUE A-220JC | | | | | |
| | (DAINICHISEIKA) | | | | | |
| Pigment | Toner Magenta | | | | | |
| Red 122 | EO02 (Clariant) | | | | | |
| Pigment | Fast Yellow 531 | | | | | |
| Yellow 74 | (DAINICHISEIKA) | | | | | |
| Solvent | High-purity water | Balance | Balance | Balance | Balance | Balance |

| | | | | | |
|---|---|---|---|---|---|
| Total | 100 | 100 | 100 | 100 | 100 |

TABLE 10-6

| | | Pigment Dispersion 2- | | | | | | | |
|---|---|---|---|---|---|---|---|---|---|
| | | 31 | 32 | 33 | 34 | 35 | 36 | 37 | 38 |
| R2-26 | | | | | | | | | |
| R2-27 | | | | | | | | | |
| R2-28 | | | | | | | | | |
| R2-29 | | | | | | | | | |
| R2-30 | | 4 | | | | | | | |
| R2-31 | | | 4 | | | | | | |
| R2-32 | | | | 4 | | | | | |
| R2-33 | | | | | 4 | | | | |
| R2-34 | | | | | | 4 | | | |
| R2-35 | | | | | | | 4 | | |
| R2-36 | | | | | | | | 4 | |
| R2-37 | | | | | | | | | 4 |
| R2-38 | | | | | | | | | |
| R2-39 | | | | | | | | | |
| R2-40 | | | | | | | | | |
| R2-41 | | | | | | | | | |
| R2-42 | | | | | | | | | |
| R2-43 | | | | | | | | | |
| R2-44 | | | | | | | | | |
| R2-45 | | | | | | | | | |
| R2-46 | | | | | | | | | |
| R2-47 | | | | | | | | | |
| R2-48 | | | | | | | | | |
| R2-49 | | | | | | | | | |
| R2-50 | | | | | | | | | |
| Dispersant | RT-100 | | | | | | | | |
| (Surfactant) | | | | | | | | | |
| Carbon | NIPEX160 | 16 | 16 | 16 | 16 | 16 | 16 | 16 | 16 |
| black | | | | | | | | | |
| Pigment | CHROMOFINE | | | | | | | | |
| Blue 15:3 | BLUE A-220JC | | | | | | | | |
| | (DAINICHISEIKA) | | | | | | | | |
| Pigment | Toner Magenta | | | | | | | | |
| Red 122 | EO02 (Clariant) | | | | | | | | |
| Pigment | Fast Yellow 531 | | | | | | | | |
| Yellow 74 | (DAINICHISEIKA) | | | | | | | | |
| Solvent | High-purity water | Balance | Balance | Balance | Balance | Balance | Balance | Balance | Balance |

| | | | | | | | | |
|---|---|---|---|---|---|---|---|---|
| Total | 100 | 100 | 100 | 100 | 100 | 100 | 100 | 100 |

TABLE 10-7

| | | Pigment Dispersion 2- | | | | | | | |
|---|---|---|---|---|---|---|---|---|---|
| | | 39 | 40 | 41 | 42 | 43 | 44 | 45 | 46 |
| R2-26 | | | | | | | | | |
| R2-27 | | | | | | | | | |
| R2-28 | | | | | | | | | |
| R2-29 | | | | | | | | | |
| R2-30 | | | | | | | | | |
| R2-31 | | | | | | | | | |
| R2-32 | | | | | | | | | |
| R2-33 | | | | | | | | | |
| R2-34 | | | | | | | | | |
| R2-35 | | | | | | | | | |
| R2-36 | | | | | | | | | |
| R2-37 | | | | | | | | | |
| R2-38 | | 4 | | | | | | | |
| R2-39 | | | 4 | | | | | | |
| R2-40 | | | | 4 | | | | | |
| R2-41 | | | | | 4 | | | | |
| R2-42 | | | | | | 4 | | | |
| R2-43 | | | | | | | 4 | | |
| R2-44 | | | | | | | | 4 | |
| R2-45 | | | | | | | | | 4 |
| R2-46 | | | | | | | | | |
| R2-47 | | | | | | | | | |
| R2-48 | | | | | | | | | |
| R2-49 | | | | | | | | | |
| R2-50 | | | | | | | | | |
| Dispersant | RT-100 | | | | | | | | |
| (Surfactant) | | | | | | | | | |
| Carbon | NIPEX160 | 16 | 16 | 16 | 16 | 16 | 16 | 16 | 16 |
| black | | | | | | | | | |
| Pigment | CHROMOFINE | | | | | | | | |
| Blue 15:3 | BLUE A-220JC | | | | | | | | |
| | (DAINICHISEIKA) | | | | | | | | |
| Pigment | Toner Magenta | | | | | | | | |
| Red 122 | EO02 (Clariant) | | | | | | | | |
| Pigment | Fast Yellow 531 | | | | | | | | |
| Yellow 74 | (DAINICHISEIKA) | | | | | | | | |
| Solvent | High-purity water | Balance | Balance | Balance | Balance | Balance | Balance | Balance | Balance |

| | | | | | | | | |
|---|---|---|---|---|---|---|---|---|
| Total | 100 | 100 | 100 | 100 | 100 | 100 | 100 | 100 |

TABLE 10-8

| | | Pigment Dispersion 2- | | | |
|---|---|---|---|---|---|
| | | 47 | 48 | 49 | 50 |
| R2-26 | | | | | |
| R2-27 | | | | | |
| R2-28 | | | | | |
| R2-29 | | | | | |
| R2-30 | | | | | |
| R2-31 | | | | | |
| R2-32 | | | | | |
| R2-33 | | | | | |
| R2-34 | | | | | |
| R2-35 | | | | | |
| R2-36 | | | | | |
| R2-37 | | | | | |
| R2-38 | | | | | |
| R2-39 | | | | | |
| R2-40 | | | | | |
| R2-41 | | | | | |
| R2-42 | | | | | |
| R2-43 | | | | | |
| R2-44 | | | | | |
| R2-45 | | | | | |
| R2-46 | | | | | |
| R2-47 | | 4 | | | |
| R2-48 | | | 4 | | |
| R2-49 | | | | 4 | |
| R2-50 | | | | | 4 |
| Dispersant | RT-100 | | | | |
| (Surfactant) | | | | | |
| Carbon | NIPEX160 | 16 | 16 | 16 | 16 |
| black | | | | | |
| Pigment | CHROMOFINE | | | | |
| Blue 15:3 | BLUE A-220JC | | | | |
| | (DAINICHISEIKA) | | | | |
| Pigment | Toner Magenta | | | | |
| Red 122 | EO02 (Clariant) | | | | |
| Pigment | Fast Yellow 531 | | | | |
| Yellow 74 | (DAINICHISEIKA) | | | | |
| Solvent | High-purity water | Balance | Balance | Balance | Balance |

| | | | | |
|---|---|---|---|---|
| Total | 100 | 100 | 100 | 100 |

TABLE 10-9

| | | Pigment Dispersion 2- | | | | |
|---|---|---|---|---|---|---|
| | | 51 | 52 | 53 | 54 | 55 |
| R2-5 | | | | | | |
| R2-20 | | | | | | |
| R2-51 | | 4 | | | | |
| R2-52 | | | 4 | | | |
| R2-53 | | | | 4 | | |
| R2-54 | | | | | 4 | |
| R2-55 | | | | | | 4 |
| R2-56 | | | | | | |
| R2-57 | | | | | | |
| R2-58 | | | | | | |
| R2-59 | | | | | | |
| R2-60 | | | | | | |
| R2-61 | | | | | | |
| R2-62 | | | | | | |
| R-100 | | | | | | |
| Dispersant | RT-100 | | | | | |
| (Surfactant) | | | | | | |
| Carbon | NIPEX160 | 16 | 16 | 16 | 16 | 16 |
| black | | | | | | |
| Pigment | CHROMOFINE | | | | | |
| Blue 15:3 | BLUE A-220JC | | | | | |
| | (DAINICHISEIKA) | | | | | |
| Pigment | Toner Magenta | | | | | |
| Red 122 | EO02 (Clariant) | | | | | |
| Pigment | Fast Yellow 531 | | | | | |
| Yellow 74 | (DAINICHISEIKA) | | | | | |
| Solvent | High-purity water | Balance | Balance | Balance | Balance | Balance |

| | | | | | |
|---|---|---|---|---|---|
| Total | 100 | 100 | 100 | 100 | 100 |

TABLE 10-10

| | | Pigment Dispersion 2- | | | | | | | |
|---|---|---|---|---|---|---|---|---|---|
| | | 56 | 57 | 58 | 59 | 60 | 61 | 62 | 63 |
| R2-5 | | | | | | | | | 4 |
| R2-20 | | | | | | | | | |
| R2-51 | | | | | | | | | |
| R2-52 | | | | | | | | | |
| R2-53 | | | | | | | | | |
| R2-54 | | | | | | | | | |
| R2-55 | | | | | | | | | |
| R2-56 | | 4 | | | | | | | |
| R2-57 | | | 4 | | | | | | |
| R2-58 | | | | 4 | | | | | |
| R2-59 | | | | | 4 | | | | |
| R2-60 | | | | | | 4 | | | |
| R2-61 | | | | | | | 4 | | |
| R2-62 | | | | | | | | 4 | |
| R-100 | | | | | | | | | |
| Dispersant | RT-100 | | | | | | | | |
| (Surfactant) | | | | | | | | | |
| Carbon | NIPEX160 | 16 | 16 | 16 | 16 | 16 | 16 | 16 | |
| black | | | | | | | | | |
| Pigment | CHROMOFINE | | | | | | | | 16 |
| Blue 15:3 | BLUE A-220JC | | | | | | | | |
| | (DAINICHISEIKA) | | | | | | | | |
| Pigment | Toner Magenta | | | | | | | | |
| Red 122 | EO02 (Clariant) | | | | | | | | |
| Pigment | Fast Yellow 531 | | | | | | | | |
| Yellow 74 | (DAINICHISEIKA) | | | | | | | | |
| Solvent | High-purity water | Balance | Balance | Balance | Balance | Balance | Balance | Balance | Balance |

| | | | | | | | | |
|---|---|---|---|---|---|---|---|---|
| Total | 100 | 100 | 100 | 100 | 100 | 100 | 100 | 100 |

TABLE 10-11

| | | Pigment Dispersion 2- | | | | | | | |
|---|---|---|---|---|---|---|---|---|---|
| | | 64 | 65 | 66 | 67 | 68 | 69 | 70 | 71 |
| R2-5 | | 4 | 4 | | | | | | |
| R2-20 | | | | 4 | 4 | 4 | | | |
| R2-51 | | | | | | | | | |
| R2-52 | | | | | | | | | |
| R2-53 | | | | | | | | | |
| R2-54 | | | | | | | | | |
| R2-55 | | | | | | | | | |
| R2-56 | | | | | | | | | |
| R2-57 | | | | | | | | | |
| R2-58 | | | | | | | | | |
| R2-59 | | | | | | | | | |
| R2-60 | | | | | | | | | |
| R2-61 | | | | | | | | | |
| R2-62 | | | | | | | | | |
| R-100 | | | | | | | 4 | | |
| Dispersant | RT-100 | | | | | | | 4 | 4 |
| (Surfactant) | | | | | | | | | |
| Carbon | NIPEX160 | 16 | 16 | 16 | 16 | 16 | 16 | 16 | |
| black | | | | | | | | | |
| Pigment | CHROMOFINE | | | | | | | | 16 |
| Blue 15:3 | BLUE A-220JC | | | | | | | | |
| | (DAINICHISEIKA) | | | | | | | | |
| Pigment | Toner Magenta | | | | | | | | |
| Red 122 | EO02 (Clariant) | | | | | | | | |
| Pigment | Fast Yellow 531 | | | | | | | | |
| Yellow 74 | (DAINICHISEIKA) | | | | | | | | |
| Solvent | High-purity water | Balance | Balance | Balance | Balance | Balance | Balance | Balance | Balance |

| | | | | | | | | |
|---|---|---|---|---|---|---|---|---|
| Total | 100 | 100 | 100 | 100 | 100 | 100 | 100 | 100 |

TABLE 10-12

Pigment
Dispersion 2-

| | | 72 | 73 |
|---|---|---|---|
| R2-5 | | | |
| R2-20 | | | |
| R2-51 | | | |
| R2-52 | | | |
| R2-53 | | | |
| R2-54 | | | |
| R2-55 | | | |
| R2-56 | | | |
| R2-57 | | | |
| R2-58 | | | |
| R2-59 | | | |
| R2-60 | | | |
| R2-61 | | | |
| R2-62 | | | |
| R-100 | | | |
| Dispersant | RT-100 | 4 | 4 |
| (Surfactant) | | | |
| Carbon | NIPEX160 | | |
| black | | | |
| Pigment | CHROMOFINE | | |
| Blue 15:3 | BLUE A-220JC | | |
| | (DAINICHISEIKA) | | |
| Pigment | Toner Magenta | 16 | |
| Red 122 | EO02 (Clariant) | | |
| Pigment | Fast Yellow 531 | | 16 |
| Yellow 74 | (DAINICHISEIKA) | | |
| Solvent | High-purity water | Balance | Balance |

| | | |
|---|---|---|
| Total | 100 | 100 |

### Examples 2-1 to 2-72 and Comparative Examples 2-1 to 2-5

Ink compositions of Examples 2-1 to 2-72 and Comparative Examples 2-1 to 2-5 are shown in Table 11-1 to 11-3. The numbers are % by weight.

The inks were prepared by the following method.

First, the materials shown in Tables 11-1 to 11-12 were mixed and stirred for 1 hr to be uniformly mixed. The resultant dispersion was subjected to pressure filtration by a polyvinylidenefluoride membrane filter having an average pore diameter of 5.0 μm to remove coarse particles and dusts. Thus, a recording ink was prepared.

TABLE 11-1

| | | Example 2- | | | | |
|---|---|---|---|---|---|---|
| | | 1 | 2 | 3 | 4 | 5 |
| Pigment | Pigment dispersion 2-1 | 50 | | | | |
| Dispersion | Pigment dispersion 2-2 | | 50 | | | |
| | Pigment dispersion 2-3 | | | 50 | | |
| | Pigment dispersion 2-4 | | | | 50 | |
| | Pigment dispersion 2-5 | | | | | 50 |
| | Pigment dispersion 2-6 | | | | | |
| | Pigment dispersion 2-7 | | | | | |
| | Pigment dispersion 2-8 | | | | | |
| | Pigment dispersion 2-9 | | | | | |
| | Pigment dispersion 2-10 | | | | | |
| | Pigment dispersion 2-11 | | | | | |
| | Pigment dispersion 2-12 | | | | | |
| | Pigment dispersion 2-13 | | | | | |
| | Pigment dispersion 2-14 | | | | | |
| | Pigment dispersion 2-15 | | | | | |
| | Pigment dispersion 2-16 | | | | | |
| | Pigment dispersion 2-17 | | | | | |
| | Pigment dispersion 2-18 | | | | | |
| | Pigment dispersion 2-19 | | | | | |
| | Pigment dispersion 2-20 | | | | | |
| | Pigment dispersion 2-21 | | | | | |
| | Pigment dispersion 2-22 | | | | | |
| | Pigment dispersion 2-23 | | | | | |
| Additive | R2-5 | | | | | |
| | R2-20 | | | | | |
| Water- | Glycerin | 10 | 10 | 10 | 10 | 10 |
| soluble | 1,3-butanediol | 20 | 20 | 20 | 20 | 20 |
| solvent | Trimethylol propane | | | | | |
| | 2-pyrrolidone | | | | | |
| Solvent | High-purity water | Balance | Balance | Balance | Balance | Balance |
| | Total | 100 | 100 | 100 | 100 | 100 |

TABLE 11-2

| | | Example 2- | | | | | | | | |
|---|---|---|---|---|---|---|---|---|---|---|
| | | 6 | 7 | 8 | 9 | 10 | 11 | 12 | 13 | 14 |
| Pigment | Pigment dispersion 2-1 | | | | | | | | | |
| Dispersion | Pigment dispersion 2-2 | | | | | | | | | |
| | Pigment dispersion 2-3 | | | | | | | | | |
| | Pigment dispersion 2-4 | | | | | | | | | |
| | Pigment dispersion 2-5 | 50 | 50 | | | | | | | |
| | Pigment dispersion 2-6 | | | 50 | | | | | | |
| | Pigment dispersion 2-7 | | | | 50 | | | | | |
| | Pigment dispersion 2-8 | | | | | 50 | | | | |
| | Pigment dispersion 2-9 | | | | | | 50 | | | |
| | Pigment dispersion 2-10 | | | | | | | 50 | | |
| | Pigment dispersion 2-11 | | | | | | | | 50 | |
| | Pigment dispersion 2-12 | | | | | | | | | 50 |
| | Pigment dispersion 2-13 | | | | | | | | | |
| | Pigment dispersion 2-14 | | | | | | | | | |
| | Pigment dispersion 2-15 | | | | | | | | | |
| | Pigment dispersion 2-16 | | | | | | | | | |
| | Pigment dispersion 2-17 | | | | | | | | | |
| | Pigment dispersion 2-18 | | | | | | | | | |
| | Pigment dispersion 2-19 | | | | | | | | | |
| | Pigment dispersion 2-20 | | | | | | | | | |
| | Pigment dispersion 2-21 | | | | | | | | | |
| | Pigment dispersion 2-22 | | | | | | | | | |
| | Pigment dispersion 2-23 | | | | | | | | | |
| Additive | R2-5 | | | | | | | | | |
| | R2-20 | | | | | | | | | |
| Water- | Glycerin | | 20 | 10 | 10 | 10 | 10 | 10 | 10 | 10 |
| soluble | 1,3-butanediol | 30 | | 20 | 20 | 20 | 20 | 20 | 20 | 20 |
| solvent | Trimethylol propane | | 5 | | | | | | | |
| | 2-pyrrolidone | | 5 | | | | | | | |
| Solvent | High-purity water | Balance | Balance | Balance | Balance | Balance | Balance | Balance | Balance | Balance |
| | Total | 100 | 100 | 100 | 100 | 100 | 100 | 100 | 100 | 100 |

TABLE 11-3

| | | Example 2- | | | | | | | | |
|---|---|---|---|---|---|---|---|---|---|---|
| | | 15 | 16 | 17 | 18 | 19 | 20 | 21 | 22 | 23 |
| Pigment | Pigment dispersion 2-1 | | | | | | | | | |
| Dispersion | Pigment dispersion 2-2 | | | | | | | | | |
| | Pigment dispersion 2-3 | | | | | | | | | |
| | Pigment dispersion 2-4 | | | | | | | | | |
| | Pigment dispersion 2-5 | | | | | | | | | |
| | Pigment dispersion 2-6 | | | | | | | | | |
| | Pigment dispersion 2-7 | | | | | | | | | |
| | Pigment dispersion 2-8 | | | | | | | | | |
| | Pigment dispersion 2-9 | | | | | | | | | |
| | Pigment dispersion 2-10 | | | | | | | | | |
| | Pigment dispersion 2-11 | | | | | | | | | |
| | Pigment dispersion 2-12 | | | | | | | | | |
| | Pigment dispersion 2-13 | 50 | | | | | | | | |
| | Pigment dispersion 2-14 | | 50 | | | | | | | |
| | Pigment dispersion 2-15 | | | 50 | | | | | | |
| | Pigment dispersion 2-16 | | | | 50 | | | | | |
| | Pigment dispersion 2-17 | | | | | 50 | | | | |
| | Pigment dispersion 2-18 | | | | | | 50 | | | |
| | Pigment dispersion 2-19 | | | | | | | 50 | | |
| | Pigment dispersion 2-20 | | | | | | | | 50 | |
| | Pigment dispersion 2-21 | | | | | | | | | 50 |
| | Pigment dispersion 2-22 | | | | | | | | | |
| | Pigment dispersion 2-23 | | | | | | | | | |
| Additive | R2-5 | | | | | | | | | |
| | R2-20 | | | | | | | | | |
| Water- | Glycerin | | 20 | 10 | 10 | 10 | 10 | 10 | 10 | 10 |
| soluble | 1,3-butanediol | 30 | | 20 | 20 | 20 | 20 | 20 | 20 | 20 |
| solvent | Trimethylol propane | | 5 | | | | | | | |
| | 2-pyrrolidone | | 5 | | | | | | | |
| Solvent | High-purity water | Balance | Balance | Balance | Balance | Balance | Balance | Balance | Balance | Balance |
| | Total | 100 | 100 | 100 | 100 | 100 | 100 | 100 | 100 | 100 |

TABLE 11-4

Example 2-

| | | 22 | 23 |
|---|---|---|---|
| Pigment | Pigment dispersion 2-1 | | |
| Dispersion | Pigment dispersion 2-2 | | |
| | Pigment dispersion 2-3 | | |
| | Pigment dispersion 2-4 | | |
| | Pigment dispersion 2-5 | | |
| | Pigment dispersion 2-6 | | |
| | Pigment dispersion 2-7 | | |
| | Pigment dispersion 2-8 | | |
| | Pigment dispersion 2-9 | | |
| | Pigment dispersion 2-10 | | |
| | Pigment dispersion 2-11 | | |
| | Pigment dispersion 2-12 | | |
| | Pigment dispersion 2-13 | | |
| | Pigment dispersion 2-14 | | |
| | Pigment dispersion 2-15 | | |
| | Pigment dispersion 2-16 | | |
| | Pigment dispersion 2-17 | | |
| | Pigment dispersion 2-18 | | |
| | Pigment dispersion 2-19 | | |
| | Pigment dispersion 2-20 | | |
| | Pigment dispersion 2-21 | | |
| | Pigment dispersion 2-22 | 50 | |
| | Pigment dispersion 2-23 | | 50 |
| Additive | R2-5 | | |
| | R2-20 | | |
| Water- | Glycerin | 10 | 10 |
| soluble | 1,3-butanediol | 20 | 20 |
| solvent | Trimethylol propane | | |
| | 2-pyrrolidone | | |
| Solvent | High-purity water | Balance | Balance |
| | Total | 100 | 100 |

TABLE 11-5

| | | Example 2- | | | | |
|---|---|---|---|---|---|---|
| | | 26 | 27 | 28 | 29 | 30 |
| Pigment | Pigment dispersion 2-24 | 50 | | | | |
| Dispersion | Pigment dispersion 2-25 | | 50 | | | |
| | Pigment dispersion 2-26 | | | 50 | | |
| | Pigment dispersion 2-27 | | | | 50 | |
| | Pigment dispersion 2-28 | | | | | 50 |
| | Pigment dispersion 2-29 | | | | | |
| | Pigment dispersion 2-30 | | | | | |
| | Pigment dispersion 2-31 | | | | | |
| | Pigment dispersion 2-32 | | | | | |
| | Pigment dispersion 2-33 | | | | | |
| | Pigment dispersion 2-34 | | | | | |
| | Pigment dispersion 2-35 | | | | | |
| | Pigment dispersion 2-36 | | | | | |
| | Pigment dispersion 2-37 | | | | | |
| | Pigment dispersion 2-38 | | | | | |
| | Pigment dispersion 2-39 | | | | | |
| | Pigment dispersion 2-40 | | | | | |
| | Pigment dispersion 2-41 | | | | | |
| | Pigment dispersion 2-42 | | | | | |
| | Pigment dispersion 2-43 | | | | | |
| | Pigment dispersion 2-44 | | | | | |
| | Pigment dispersion 2-45 | | | | | |
| | Pigment dispersion 2-46 | | | | | |
| | Pigment dispersion 2-47 | | | | | |
| | Pigment dispersion 2-48 | | | | | |
| Additive | R2-5 | | | | | |
| | R2-20 | | | | | |
| Water- | Glycerin | 10 | 10 | 10 | 10 | 10 |
| soluble | 1,3-butanediol | 20 | 20 | 20 | 20 | 20 |
| solvent | Trimethylol propane | | | | | |
| | 2-pyrrolidone | | | | | |
| Solvent | High-purity water | Balance | Balance | Balance | Balance | Balance |
| | Total | 100 | 100 | 100 | 100 | 100 |

TABLE 11-6

| | | Example 2- | | | | | | | | |
|---|---|---|---|---|---|---|---|---|---|---|
| | | 31 | 32 | 33 | 34 | 35 | 36 | 37 | 38 | 39 |
| Pigment | Pigment dispersion 2-24 | | | | | | | | | |
| Dispersion | Pigment dispersion 2-25 | | | | | | | | | |
| | Pigment dispersion 2-26 | | | | | | | | | |
| | Pigment dispersion 2-27 | | | | | | | | | |
| | Pigment dispersion 2-28 | | | | | | | | | |
| | Pigment dispersion 2-29 | 50 | | | | | | | | |
| | Pigment dispersion 2-30 | | 50 | | | | | | | |
| | Pigment dispersion 2-31 | | | 50 | | | | | | |
| | Pigment dispersion 2-32 | | | | 50 | | | | | |
| | Pigment dispersion 2-33 | | | | | 50 | | | | |
| | Pigment dispersion 2-34 | | | | | | 50 | | | |
| | Pigment dispersion 2-35 | | | | | | | 50 | | |
| | Pigment dispersion 2-36 | | | | | | | | 50 | |
| | Pigment dispersion 2-37 | | | | | | | | | 50 |
| | Pigment dispersion 2-38 | | | | | | | | | |
| | Pigment dispersion 2-39 | | | | | | | | | |
| | Pigment dispersion 2-40 | | | | | | | | | |
| | Pigment dispersion 2-41 | | | | | | | | | |
| | Pigment dispersion 2-42 | | | | | | | | | |
| | Pigment dispersion 2-43 | | | | | | | | | |
| | Pigment dispersion 2-44 | | | | | | | | | |
| | Pigment dispersion 2-45 | | | | | | | | | |
| | Pigment dispersion 2-46 | | | | | | | | | |
| | Pigment dispersion 2-47 | | | | | | | | | |
| | Pigment dispersion 2-48 | | | | | | | | | |
| Additive | R2-5 | | | | | | | | | |
| | R2-20 | | | | | | | | | |
| Water- | Glycerin | 10 | 10 | 10 | 10 | 10 | 10 | 10 | 10 | 10 |
| soluble | 1,3-butanediol | 20 | 20 | 20 | 20 | 20 | 20 | 20 | 20 | 20 |
| solvent | Trimethylol propane | | | | | | | | | |
| | 2-pyrrolidone | | | | | | | | | |
| Solvent | High-purity water | Balance | Balance | Balance | Balance | Balance | Balance | Balance | Balance | Balance |
| | Total | 100 | 100 | 100 | 100 | 100 | 100 | 100 | 100 | 100 |

TABLE 11-7

| | | Example 2- | | | | | | | | |
|---|---|---|---|---|---|---|---|---|---|---|
| | | 40 | 41 | 42 | 43 | 44 | 45 | 46 | 47 | 48 |
| Pigment | Pigment dispersion 2-24 | | | | | | | | | |
| Dispersion | Pigment dispersion 2-25 | | | | | | | | | |
| | Pigment dispersion 2-26 | | | | | | | | | |
| | Pigment dispersion 2-27 | | | | | | | | | |
| | Pigment dispersion 2-28 | | | | | | | | | |
| | Pigment dispersion 2-29 | | | | | | | | | |
| | Pigment dispersion 2-30 | | | | | | | | | |
| | Pigment dispersion 2-31 | | | | | | | | | |
| | Pigment dispersion 2-32 | | | | | | | | | |
| | Pigment dispersion 2-33 | | | | | | | | | |
| | Pigment dispersion 2-34 | | | | | | | | | |
| | Pigment dispersion 2-35 | | | | | | | | | |
| | Pigment dispersion 2-36 | | | | | | | | | |
| | Pigment dispersion 2-37 | | | | | | | | | |
| | Pigment dispersion 2-38 | 50 | | | | | | | | |
| | Pigment dispersion 2-39 | | 50 | | | | | | | |
| | Pigment dispersion 2-40 | | | 50 | | | | | | |
| | Pigment dispersion 2-41 | | | | 50 | | | | | |
| | Pigment dispersion 2-42 | | | | | 50 | | | | |
| | Pigment dispersion 2-43 | | | | | | 50 | | | |
| | Pigment dispersion 2-44 | | | | | | | 50 | | |
| | Pigment dispersion 2-45 | | | | | | | | 50 | |
| | Pigment dispersion 2-46 | | | | | | | | | 50 |
| | Pigment dispersion 2-47 | | | | | | | | | |
| | Pigment dispersion 2-48 | | | | | | | | | |
| Additive | R2-5 | | | | | | | | | |
| | R2-20 | | | | | | | | | |
| Water- | Glycerin | 10 | 10 | 10 | 10 | 10 | 10 | 10 | 10 | 10 |
| soluble | 1,3-butanediol | 20 | 20 | 20 | 20 | 20 | 20 | 20 | 20 | 20 |
| solvent | Trimethylol propane | | | | | | | | | |
| | 2-pyrrolidone | | | | | | | | | |
| Solvent | High-purity water | Balance | Balance | Balance | Balance | Balance | Balance | Balance | Balance | Balance |
| | Total | 100 | 100 | 100 | 100 | 100 | 100 | 100 | 100 | 100 |

TABLE 11-8

Example 2-

| | | 49 | 50 |
|---|---|---|---|
| Pigment | Pigment dispersion 2-24 | | |
| Dispersion | Pigment dispersion 2-25 | | |
| | Pigment dispersion 2-26 | | |
| | Pigment dispersion 2-27 | | |
| | Pigment dispersion 2-28 | | |
| | Pigment dispersion 2-29 | | |
| | Pigment dispersion 2-30 | | |
| | Pigment dispersion 2-31 | | |
| | Pigment dispersion 2-32 | | |
| | Pigment dispersion 2-33 | | |
| | Pigment dispersion 2-34 | | |
| | Pigment dispersion 2-35 | | |
| | Pigment dispersion 2-36 | | |
| | Pigment dispersion 2-37 | | |
| | Pigment dispersion 2-38 | | |
| | Pigment dispersion 2-39 | | |
| | Pigment dispersion 2-40 | | |
| | Pigment dispersion 2-41 | | |
| | Pigment dispersion 2-42 | | |
| | Pigment dispersion 2-43 | | |
| | Pigment dispersion 2-44 | | |
| | Pigment dispersion 2-45 | | |
| | Pigment dispersion 2-46 | | |
| | Pigment dispersion 2-47 | 50 | |
| | Pigment dispersion 2-48 | | 50 |
| Additive | R2-5 | | |
| | R2-20 | | |
| Water- | Glycerin | 10 | 10 |
| soluble | 1,3-butanediol | 20 | 20 |
| solvent | Trimethylol propane | | |
| | 2-pyrrolidone | | |
| Solvent | High-purity water | Balance | Balance |
| | Total | 100 | 100 |

TABLE 11-9

| | | Example 2- | | | | |
|---|---|---|---|---|---|---|
| | | 51 | 52 | 53 | 54 | 55 |
| Pigment | Pigment dispersion 2-49 | 50 | | | | |
| Dispersion | Pigment dispersion 2-50 | | 50 | | | |
| | Pigment dispersion 2-51 | | | 50 | | |
| | Pigment dispersion 2-52 | | | | 50 | |
| | Pigment dispersion 2-53 | | | | | 50 |
| | Pigment dispersion 2-54 | | | | | |
| | Pigment dispersion 2-55 | | | | | |
| | Pigment dispersion 2-56 | | | | | |
| | Pigment dispersion 2-57 | | | | | |
| | Pigment dispersion 2-58 | | | | | |
| | Pigment dispersion 2-59 | | | | | |
| | Pigment dispersion 2-60 | | | | | |
| | Pigment dispersion 2-61 | | | | | |
| | Pigment dispersion 2-62 | | | | | |
| | Pigment dispersion 2-63 | | | | | |
| | Pigment dispersion 2-64 | | | | | |
| | Pigment dispersion 2-65 | | | | | |
| | Pigment dispersion 2-66 | | | | | |
| | Pigment dispersion 2-67 | | | | | |
| | Pigment dispersion 2-68 | | | | | |
| | Pigment dispersion 2-69 | | | | | |
| | Pigment dispersion 2-70 | | | | | |
| | Pigment dispersion 2-71 | | | | | |
| | Pigment dispersion 2-72 | | | | | |
| | Pigment dispersion 2-73 | | | | | |
| Additive | R2-5 | | | | | |
| | R2-20 | | | | | |
| Water- | Glycerin | 10 | 10 | 10 | 10 | 10 |
| soluble | 1,3-butanediol | 20 | 20 | 20 | 20 | 20 |
| solvent | Trimethylol propane | | | | | |
| | 2-pyrrolidone | | | | | |
| Solvent | High-purity water | Balance | Balance | Balance | Balance | Balance |
| | Total | 100 | 100 | 100 | 100 | 100 |

TABLE 11-10

| | | Example 2- | | | | | | | | |
|---|---|---|---|---|---|---|---|---|---|---|
| | | 56 | 57 | 58 | 59 | 60 | 61 | 62 | 63 | 64 |
| Pigment | Pigment dispersion 2-49 | | | | | | | | | |
| Dispersion | Pigment dispersion 2-50 | | | | | | | | | |
| | Pigment dispersion 2-51 | | | | | | | | | |
| | Pigment dispersion 2-52 | | | | | | | | | |
| | Pigment dispersion 2-53 | | | | | | | | | |
| | Pigment dispersion 2-54 | 50 | | | | | | | | |
| | Pigment dispersion 2-55 | | 50 | | | | | | | |
| | Pigment dispersion 2-56 | | | 50 | | | | | | |
| | Pigment dispersion 2-57 | | | | 50 | | | | | |
| | Pigment dispersion 2-58 | | | | | 50 | | | | |
| | Pigment dispersion 2-59 | | | | | | 50 | | | |
| | Pigment dispersion 2-60 | | | | | | | 50 | | |
| | Pigment dispersion 2-61 | | | | | | | | 50 | |
| | Pigment dispersion 2-62 | | | | | | | | | 50 |
| | Pigment dispersion 2-63 | | | | | | | | | |
| | Pigment dispersion 2-64 | | | | | | | | | |
| | Pigment dispersion 2-65 | | | | | | | | | |
| | Pigment dispersion 2-66 | | | | | | | | | |
| | Pigment dispersion 2-67 | | | | | | | | | |
| | Pigment dispersion 2-68 | | | | | | | | | |
| | Pigment dispersion 2-69 | | | | | | | | | |
| | Pigment dispersion 2-70 | | | | | | | | | |
| | Pigment dispersion 2-71 | | | | | | | | | |
| | Pigment dispersion 2-72 | | | | | | | | | |
| | Pigment dispersion 2-73 | | | | | | | | | |
| Additive | R2-5 | | | | | | | | | |
| | R2-20 | | | | | | | | | |
| Water- | Glycerin | 10 | 10 | 10 | 10 | 10 | 10 | 10 | 10 | 10 |
| soluble | 1,3-butanediol | 20 | 20 | 20 | 20 | 20 | 20 | 20 | 20 | 20 |
| solvent | Trimethylol propane | | | | | | | | | |
| | 2-pyrrolidone | | | | | | | | | |
| Solvent | High-purity water | Balance | Balance | Balance | Balance | Balance | Balance | Balance | Balance | Balance |
| | Total | 100 | 100 | 100 | 100 | 100 | 100 | 100 | 100 | 100 |

TABLE 11-11

| | | Example 2- | | | | | | | |
|---|---|---|---|---|---|---|---|---|---|
| | | 65 | 66 | 67 | 68 | 69 | 70 | 71 | 72 |
| Pigment | Pigment dispersion 2-49 | | | | | | | | |
| Dispersion | Pigment dispersion 2-50 | | | | | | | | |
| | Pigment dispersion 2-51 | | | | | | | | |
| | Pigment dispersion 2-52 | | | | | | | | |
| | Pigment dispersion 2-53 | | | | | | | | |
| | Pigment dispersion 2-54 | | | | | | | | |
| | Pigment dispersion 2-55 | | | | | | | | |
| | Pigment dispersion 2-56 | | | | | | | | |
| | Pigment dispersion 2-57 | | | | | | | | |
| | Pigment dispersion 2-58 | | | | | | | | |
| | Pigment dispersion 2-59 | | | | | | | | |
| | Pigment dispersion 2-60 | | | | | | | | |
| | Pigment dispersion 2-61 | | | | | | | | |
| | Pigment dispersion 2-62 | | | | | | | | |
| | Pigment dispersion 2-63 | 30 | | | | | | | |
| | Pigment dispersion 2-64 | | 50 | | | | | | |
| | Pigment dispersion 2-65 | | | 30 | | | | | |
| | Pigment dispersion 2-66 | | | | 50 | | | | |
| | Pigment dispersion 2-67 | | | | | 50 | | | |
| | Pigment dispersion 2-68 | | | | | | 30 | | |
| | Pigment dispersion 2-69 | | | | | | | | |
| | Pigment dispersion 2-70 | | | | | | | 50 | 50 |
| | Pigment dispersion 2-71 | | | | | | | | |
| | Pigment dispersion 2-72 | | | | | | | | |
| | Pigment dispersion 2-73 | | | | | | | | |
| Additive | R2-5 | | | | | | | 5 | |
| | R2-20 | | | | | | | | 5 |
| Water- | Glycerin | 10 | 10 | 10 | 10 | 10 | 10 | 10 | 10 |
| soluble | 1,3-butanediol | 20 | 20 | 20 | 20 | 20 | 20 | 20 | 20 |
| solvent | Trimethylol propane | | | | | | | | |
| | 2-pyrrolidone | | | | | | | | |
| Solvent | High-purity water | Balance | Balance | Balance | Balance | Balance | Balance | Balance | Balance |
| | Total | 100 | 100 | 100 | 100 | 100 | 100 | 100 | 100 |

TABLE 11-12

| | | Comparative Example 2- | | | | |
|---|---|---|---|---|---|---|
| Pigment | Pigment dispersion 2-49 | | | | | |
| Dispersion | Pigment dispersion 2-50 | | | | | |
| | Pigment dispersion 2-51 | | | | | |
| | Pigment dispersion 2-52 | | | | | |
| | Pigment dispersion 2-53 | | | | | |
| | Pigment dispersion 2-54 | | | | | |
| | Pigment dispersion 2-55 | | | | | |
| | Pigment dispersion 2-56 | | | | | |
| | Pigment dispersion 2-57 | | | | | |
| | Pigment dispersion 2-58 | | | | | |
| | Pigment dispersion 2-59 | | | | | |
| | Pigment dispersion 2-60 | | | | | |
| | Pigment dispersion 2-61 | | | | | |
| | Pigment dispersion 2-62 | | | | | |
| | Pigment dispersion 2-63 | | | | | |
| | Pigment dispersion 2-64 | | | | | |
| | Pigment dispersion 2-65 | | | | | |
| | Pigment dispersion 2-66 | | | | | |
| | Pigment dispersion 2-67 | | | | | |
| | Pigment dispersion 2-68 | | | | | |
| | Pigment dispersion 2-69 | 50 | | | | |
| | Pigment dispersion 2-70 | | 50 | | | |
| | Pigment dispersion 2-71 | | | 30 | | |
| | Pigment dispersion 2-72 | | | | 50 | |
| | Pigment dispersion 2-73 | | | | | 30 |
| Additive | R2-5 | | | | | |
| | R2-20 | | | | | |
| Water- | Glycerin | 10 | 10 | 10 | 10 | 10 |
| soluble | 1,3-butanediol | 20 | 20 | 20 | 20 | 20 |
| solvent | Trimethylol propane | | | | | |
| | 2-pyrrolidone | | | | | |
| Solvent | High-purity water | Balance | Balance | Balance | Balance | Balance |
| | Total | 100 | 100 | 100 | 100 | 100 |

### <Preservation Stability of Pigment Dispersions and Inks>

The viscosities of the pigment dispersions 2-1 to 2-73, and the inks of Examples 2-1 to 2-72 and Comparative Examples 2-1 to 2-5 were measured by, e.g., a viscometer RE80L from TOKI SANGYO CO., LTD. at 25° C., adjusting the rotational number at from 50 to 100 rpm according the viscosities. As an index of dispersion stability of the pigment dispersion and the pigment in the ink, the initial viscosities of the pigment dispersions and the inks were measured to evaluate under the following standard.

As for the preservability, after the initial viscosities thereof were measured, each of them were placed in a polyethylene container and sealed. The viscosity after stored at 70° C. for 1 week was measured to evaluate under the following standard, compared with the initial viscosity.

### [Pigment Dispersion Evaluation Standard]

### Initial Viscosity

Good: less than 7 mPa·s

Average: not less than 7 mPa·s and less than 20 mPa·s

Poor: not less than 20 mPa·s

Preservability (Change Rate of Viscosity after Stored)

Good: less than 5%

Average: not less than 5% less than 50%

Poor: not less than 50%

### [Ink Evaluation Standard]

### Initial Viscosity

Good: less than 9 mPa·s

Average: not less than 9 mPa·s and less than 20 mPa·s

Poor: not less than 20 mPa·s

Preservability (Change Rate of Viscosity after Stored)

Good: less than 5%

Average: not less than 5% less than 50%

Poor: not less than 50%

### <Printed Image Evaluation>

Printed images by the inks of Examples 1-1 to 1-34 and Comparative Examples 1-1 to 1-5 were evaluated.

A drive voltage of piezo element of an inkjet printer IPSiO GX3000 from Ricoh Company, Ltd. was changed to uniformly discharge the ink such that the same amount of the ink adheres to a recording material. The results are shown in Table 12.

### <<Image Density>>

After a chart on which general marks JIS X 0208 (1997) and 2223 having 64 points are described by Microsoft Word 2003 was printed on My Paper having a weight of 69.6 g/m², a sizing degree of 23.2 sec and an air permeability of 21.0 sec, the image density of the general marks JIS X 0208 (1997) and 2223 was evaluated using X-Rite938 from X-Rite, Inc. Then, the printing mode was “plain paper-fast” mode by a driver of the printer. The general marks JIS X 0208 (1997) and 2223 has the outer form of a square and the whole surface was filled with ink.

Image density was evaluated under the following standard.

### [Evaluation Standard]

Excellent: OD value Black not less than 1.30
Yellow not less than 0.80
Magenta not less than 1.00
Cyan not less than 1.10

Good: OD value Black not less than 1.20 less than 1.30
Yellow not less than 0.75 less than 0.80
Magenta not less than 0.90 less than 1.00
Cyan not less than 1.00 less than 1.10

Average: OD value Black not less than 1.10 less than 1.20
Yellow not less than 0.70 less than 0.75
Magenta not less than 0.80 less than 0.90
Cyan not less than 0.90 less than 1.00

Fair: OD value Black not less than 1.00 less than 1.10
Yellow not less than 0.65 less than 0.70
Magenta not less than 0.70 less than 0.80
Cyan not less than 0.80 less than 0.90

Poor: OD value Black less than 1.00
Yellow less than 0.65
Magenta less than 0.70
Cyan less than 0.80

TABLE 12

| | | | Pigment Dispersion | | Ink | | |
|---|---|---|---|---|---|---|---|
| | Pigment | | Initial | Preservation | Initial | Preservation | Image |
| | Dispersion | Copolymer | viscosity | stability | viscosity | stability | Density |
| Example 2-1 | 2-1 | R2-1 | Good | Good | Good | Average | Excellent |
| Example 2-2 | 2-2 | R2-2 | Good | Good | Good | Average | Excellent |
| Example 2-3 | 2-3 | R2-3 | Good | Good | Good | Average | Excellent |
| Example 2-4 | 2-4 | R2-4 | Good | Good | Good | Good | Excellent |
| Example 2-5 | 2-5 | R2-5 | Good | Good | Good | Good | Excellent |
| Example 2-6 | 2-5 | R2-5 | Good | Good | Good | Good | Excellent |
| Example 2-7 | 2-5 | R2-5 | Good | Good | Good | Good | Excellent |
| Example 2-8 | 2-6 | R2-6 | Good | Good | Good | Good | Excellent |
| Example 2-9 | 2-7 | R2-7 | Good | Good | Good | Good | Excellent |
| Example 2-10 | 2-8 | R2-8 | Good | Good | Good | Good | Excellent |
| Example 2-11 | 2-9 | R2-9 | Good | Good | Good | Average | Excellent |
| Example 2-12 | 2-10 | R2-10 | Good | Good | Good | Average | Excellent |
| Example 2-13 | 2-11 | R2-11 | Good | Good | Good | Average | Excellent |
| Example 2-14 | 2-12 | R2-12 | Good | Good | Good | Good | Excellent |
| Example 2-15 | 2-13 | R2-13 | Good | Good | Good | Good | Excellent |
| Example 2-16 | 2-14 | R2-14 | Good | Good | Good | Good | Excellent |
| Example 2-17 | 2-15 | R2-15 | Good | Good | Good | Good | Excellent |
| Example 2-18 | 2-16 | R2-16 | Good | Good | Good | Average | Excellent |
| Example 2-19 | 2-17 | R2-17 | Good | Good | Good | Average | Excellent |
| Example 2-20 | 2-18 | R2-18 | Good | Good | Good | Average | Excellent |
| Example 2-21 | 2-19 | R2-19 | Good | Good | Good | Good | Excellent |
| Example 2-22 | 2-20 | R2-20 | Good | Good | Good | Good | Excellent |
| Example 2-23 | 2-21 | R2-21 | Good | Good | Good | Good | Excellent |
| Example 2-24 | 2-22 | R2-22 | Good | Good | Good | Good | Excellent |
| Example 2-25 | 2-23 | R2-23 | Good | Good | Good | Good | Excellent |
| Example 2-26 | 2-24 | R2-24 | Good | Good | Good | Average | Excellent |
| Example 2-27 | 2-25 | R2-25 | Good | Good | Good | Average | Excellent |
| Example 2-28 | 2-26 | R2-26 | Good | Good | Good | Average | Excellent |
| Example 2-29 | 2-27 | R2-27 | Good | Good | Good | Good | Excellent |
| Example 2-30 | 2-28 | R2-28 | Good | Good | Good | Good | Excellent |
| Example 2-31 | 2-29 | R2-29 | Good | Good | Good | Good | Excellent |
| Example 2-32 | 2-30 | R2-30 | Good | Good | Good | Good | Excellent |
| Example 2-33 | 2-31 | R2-31 | Good | Good | Good | Good | Excellent |
| Example 2-34 | 2-32 | R2-32 | Good | Good | Good | Good | Excellent |
| Example 2-35 | 2-33 | R2-33 | Good | Good | Good | Good | Excellent |
| Example 2-36 | 2-34 | R2-34 | Good | Good | Good | Good | Excellent |
| Example 2-37 | 2-35 | R2-35 | Good | Good | Good | Good | Excellent |
| Example 2-38 | 2-36 | R2-36 | Good | Good | Good | Good | Excellent |
| Example 2-39 | 2-37 | R2-37 | Good | Average | Good | Average | Average |
| Example 2-40 | 2-38 | R2-38 | Good | Average | Good | Average | Good |
| Example 2-41 | 2-39 | R2-39 | Good | Good | Good | Good | Excellent |
| Example 2-42 | 2-40 | R2-40 | Good | Good | Good | Good | Excellent |
| Example 2-43 | 2-41 | R2-41 | Good | Good | Good | Good | Excellent |
| Example 2-44 | 2-42 | R2-42 | Good | Good | Good | Good | Excellent |
| Example 2-45 | 2-43 | R2-43 | Good | Average | Good | Average | Average |
| Example 2-46 | 2-44 | R2-44 | Good | Average | Good | Average | Good |
| Example 2-47 | 2-45 | R2-45 | Good | Good | Good | Good | Excellent |
| Example 2-48 | 2-46 | R2-46 | Good | Good | Good | Good | Excellent |
| Example 2-49 | 2-47 | R2-47 | Average | Good | Average | Good | Excellent |
| Example 2-50 | 2-48 | R2-48 | Good | Average | Good | Fair | Average |
| Example 2-51 | 2-49 | R2-49 | Average | Average | Average | Average | Excellent |
| Example 2-52 | 2-50 | R2-50 | Good | Average | Good | Average | Average |
| Example 2-53 | 2-51 | R2-51 | Good | Average | Good | Average | Good |
| Example 2-54 | 2-52 | R2-52 | Good | Good | Good | Good | Excellent |
| Example 2-55 | 2-53 | R2-53 | Good | Good | Good | Good | Excellent |
| Example 2-56 | 2-54 | R2-54 | Good | Good | Good | Good | Excellent |
| Example 2-57 | 2-55 | R2-55 | Good | Good | Good | Good | Excellent |
| Example 2-58 | 2-56 | R2-56 | Good | Average | Good | Average | Average |
| Example 2-59 | 2-57 | R2-57 | Good | Average | Good | Average | Good |
| Example 2-60 | 2-58 | R2-58 | Good | Good | Good | Good | Excellent |
| Example 2-61 | 2-59 | R2-59 | Good | Good | Good | Good | Excellent |
| Example 2-62 | 2-60 | R2-60 | Average | Good | Average | Good | Excellent |
| Example 2-63 | 2-61 | R2-61 | Good | Average | Good | Fair | Average |
| Example 2-64 | 2-62 | R2-62 | Average | Average | Average | Average | Excellent |
| Example 2-65 | 2-63_Cy | R2-5 | Good | Good | Good | Good | Excellent |
| Example 2-66 | 2-64_Ma | R2-5 | Good | Good | Good | Good | Excellent |
| Example 2-67 | 2-65_Ye | R2-5 | Good | Good | Good | Good | Excellent |
| Example 2-68 | 2-66_Cy | R2-20 | Good | Good | Good | Good | Excellent |
| Example 2-69 | 2-67_Ma | R2-20 | Good | Good | Good | Good | Excellent |
| Example 2-70 | 2-68_Ye | R2-20 | Good | Good | Good | Good | Excellent |
| Example 2-71 | 2-70 | RT100 | Good | Average | Good | Average | Excellent |
| | | w/R2-5 | | | | | |
| Example 2-72 | 2-70 | RT100 | Good | Average | Good | Average | Excellent |
| | | w/R2-20 | | | | | |
| Comparative | 2-69 | R-100 | Average | Poor | Average | Poor | Average |
| Example 2-1 | | | | | | | |
| Comparative | 2-70 | RT100 | Average | Poor | Average | Average | Fair |
| Example 2-2 | | | | | | | |
| Comparative | 2-71_Cy | RT100 | Average | Average | Average | Average | Fair |
| Example 2-3 | | | | | | | |
| Comparative | 2-72_Ma | RT100 | Average | Poor | Average | Poor | Fair |
| Example 2-4 | | | | | | | |
| Comparative | 2-73_Ye | RT100 | Average | Average | Average | Average | Fair |
| Example 2-5 | | | | | | | |

### Synthesis Example 3-1 of Copolymer Including a Salt of Phosphonic Acid Group

In a reaction container including a gas inlet tube, a thermometer and a reflux condenser, in an argon atmosphere, 400 parts of methyl ethyl ketone, 35 parts of vinyl phosphate from Tokyo Chemical Industry Co., Ltd., 45 parts of styrene, 20 parts of 1-heptene from Tokyo Chemical Industry Co., Ltd., and 3 parts of 1-dodecanthiol as a molecular weight adjuster from Tokyo Chemical Industry Co., Ltd. were placed to prepare a solution, and argon gas displacement was performed for 30 min while the solution was stirred to prepare a mixed solution. In an argon atmosphere, the mixed solution was heated to have a temperature of 60° C. while stirred, and a solution including a half of 6 parts of a polymerization initiator 2,2′-azobis(2,4-dimethylvaleronitrile) and methyl ethyl ketone was dripped therein with a dripping funnel. After dripped, the temperature of the mixed liquid was maintained at 60° C. for 12 hrs. Then, the remaining solution of the polymerization initiator was dripped and reacted at 75° C. for 2 hrs to prepare a copolymer solution.

The copolymer solution was placed in a large amount of n-hexane to precipitate the copolymer and a solvent was removed therefrom by decantation. Further, the precipitated product was dried to prepare a copolymer including a phosphonic acid group.

The copolymer was dissolved in ethanol to prepare a solution, and potassium hydroxide dissolved in methanol was added and mixed therein so as to be completely disacidified. After the mixture was stirred, a solvent was removed by an evaporator, and further dried in a vacuum to prepare a copolymer R3-1 having a neutralized phosphonic acid group.

A viscosity of an aqueous solution including the R3-1 in an amount of 10% by weight at 25° C. is shown in Table 13.

### Synthesis Example 3-2 to 3-32 of Copolymer Including a Salt of Phosphonic Acid Group

The procedure for preparation of the copolymer including a salt of phosphonic acid group in Synthesis Example 3-1 was repeated except for using various monomers having the formulae (4) and (5), changing a compositional ratio of the vinyl phosphonic acid to the monomers having the formulae (4) and (5), changing the amount of the molecular weight adjuster from 0 to 6 parts by weight, changing the amount of the polymerization initiator from 3 to 10 parts by weight. Further, sodium hydroxide, potassium hydroxide, triethanol amine, trimethyl amine, diethanol amine and triethyl amine were used as the neutralizer such that neutralization rates were from 80 to 100% to prepare copolymers R3-2 to R2-32 each having a neutralized phosphonic acid group. The results are shown in Table 13

TABLE 13

| | | | | M+ proton | |
|---|---|---|---|---|---|
| | Compositional | Formula (1) | Formula (2) | content rate in | |
| | Combination | content rate (% | content rate | formula (1) (% by | Viscosity |
| | No. | by weight) | (% by weight) | mol) | (mPa · s) |
| R3-1 | 3-1 | 35 | 45 | — | 3.7 |
| R3-2 | 3-3 | 35 | 45 | — | 4.4 |
| R3-3 | 3-6 | 35 | 45 | — | 10 |
| R3-4 | 3-7 | 35 | 45 | — | 3.9 |
| R3-5 | 3-8 | 35 | 45 | — | 2.3 |
| R3-6 | 3-10 | 35 | 45 | — | 3.4 |
| R3-7 | 3-49 | 35 | 45 | — | 3.1 |
| R3-8 | 3-57 | 35 | 45 | 10 | 4.5 |
| R3-9 | 3-8 | 35 | 35 | — | 3.3 |
| R3-10 | 3-8 | 35 | 55 | — | 5.6 |
| R3-11 | 3-8 | 35 | 20 | — | 7.6 |
| R3-12 | 3-8 | 55 | 30 | — | 2.3 |
| R3-13 | 3-8 | 35 | 45 | — | 29 |
| R3-14 | 3-8 | 55 | 30 | — | 26 |
| R3-15 | 3-8 | 35 | 45 | — | 1.4 |
| R3-16 | 3-8 | 55 | 30 | — | 1.7 |
| R3-17 | 3-8 | 35 | 45 | — | 39 |
| R3-18 | 3-8 | 55 | 30 | — | 41 |
| R3-19 | 3-8 | 25 | 60 | — | 4.5 |
| R3-20 | 3-8 | 25 | 60 | — | 33 |
| R3-21 | 3-8 | 65 | 25 | — | 9.8 |
| R3-22 | 3-8 | 65 | 25 | — | 30 |
| R3-23 | 3-8 | 15 | 65 | — | 12 |
| R3-24 | 3-8 | 15 | 65 | — | 26 |
| R3-25 | 3-8 | 25 | 60 | — | 1.3 |
| R3-26 | 3-8 | 25 | 60 | — | 38 |
| R3-27 | 3-8 | 15 | 65 | — | 1.6 |
| R3-28 | 3-8 | 65 | 25 | — | 41 |
| R3-29 | 4-5 | 35 | 45 | — | 5.6 |
| R3-30 | 4-26 | 35 | 45 | 20 | 4.2 |
| R3-31 | 5-34 | 35 | 45 | 5 | 8.9 |
| R3-32 | 5-42 | 35 | 45 | — | 11 |

### Synthesis Example of Copolymer R-100 Including Phosphoric Acid Group

With reference to a synthesis example in Japanese published unexamined application No. JP-2011-122072-A, 30 parts of styrene, 20 parts of methylmethacrylate, 15 parts of butylmethacrylate, 10 parts of methacrylate, 20 parts of phosmer M (monomer including a phosphoric acid group from Uni-Chemical Co., Ltd.) and 5 parts of azobisisobutylonitrile were polymerized to prepare a copolymer R-100 including a phosphoric acid group.

Similarly to the copolymer R1-1 including a salt of a phosphonic acid group, the copolymer R-100 including a phosphoric acid group was neutralized with sodium hydroxide to be completely neutralized to prepare a copolymer R-100 including a salt of a phosphoric acid group. An aqueous solution including the R-100 in an amount of 10% by weight had a viscosity of 9.1 mPa·s at 25° C.

### Pigment Dispersion Preparation Example 3-1

### Black Pigment Dispersion 3-1

With reference to Example 1 in Japanese published unexamined application No. JP-2009-114286-A, a black pigment dispersion was prepared according to Table 14.

The materials in Table 14 were premixed to prepare a mixed slurry. This was subjected to a circulation dispersion by a disc type media mill (DMR from Ashizawa Finetech Ltd.) with 0.05 mm zirconia beads at a filling rate of 55%, a peripheral speed of 10 m/s, a liquid temperature of 10° C. for 3 min. Then, the resultant dispersion was subjected to centrifugal separation by a centrifugal separator Model 7700 from KUBOTA Corporation to separate coarse particles to prepare a pigment dispersion 3-1 having a pigment concentration of 16% by weight.

| | |
|---|---|
| Carbon black (NIPEX160 from Degussa AG | 160 |
| having a BET specific surface area of 150 m²/g, | |
| an average primary particle diameter of 20 nm | |
| a pH of 4.0 and a DBP oil absorption of 620 g/100 g | |
| Copolymer R3-4 | 20 |
| including a salt of a phosphonic acid group | |
| Distilled water | 820 |

### Pigment Dispersion Preparation Example 3-2

### Black Pigment Dispersion 3-2

The procedure for preparation of the pigment dispersion 3-1 in Pigment Dispersion Preparation Example 3-1 was repeated except for changing parts of the copolymer R3-4 from 20 to 40 and parts of the distilled water from 820 to 800.

### Pigment Dispersion Preparation Example 3-3

### Black Pigment Dispersion 3-3

The procedure for preparation of the pigment dispersion 3-1 in Pigment Dispersion Preparation Example 3-1 was repeated except for changing parts of the copolymer R3-4 from 20 to 160 and parts of the distilled water from 820 to 680.

### Pigment Dispersion Preparation Example 3-4

### Cyan Pigment Dispersion 3-1

The procedure for preparation of the pigment dispersion 3-2 in Pigment Dispersion Preparation Example 3-2 was repeated except for changing the carbon black into Pigment Blue 15:3 (CHROMOFINE BLUE) from DAINICHISEIKA COLOR & CHEMICALS MFG. CO., LTD.

### Pigment Dispersion Preparation Example 3-5

### Magenta Pigment Dispersion 3-1

The procedure for preparation of the pigment dispersion 3-2 in Pigment Dispersion Preparation Example 3-2 was repeated except for changing the carbon black into Pigment Red 122 (Toner Magenta EO02) from Clariant (Japan) K.K.

### Pigment Dispersion Preparation Example 3-6

### Yellow Pigment Dispersion 3-1

The procedure for preparation of the pigment dispersion 3-2 in Pigment Dispersion Preparation Example 3-2 was repeated except for changing the carbon black into Pigment Yellow 74 (Fast Yellow 531) from DAINICHISEIKA COLOR & CHEMICALS MFG CO., LTD.

### Pigment Dispersion Preparation Example 3-7

### Black Pigment Dispersion 3-4

The procedure for preparation of the pigment dispersion 3-1 in Pigment Dispersion Preparation Example 3-1 was repeated except for changing the copolymer R3-4 into POE (m=40) β-naphthylether (RT-100) 10% aqueous solution, parts thereof from 20 to 400 and parts of the distilled water from 820 to 440.

### Pigment Dispersion Preparation Example 3-8

### Cyan Pigment Dispersion 3-2

The procedure for preparation of the pigment dispersion 3-7 in Pigment Dispersion Preparation Example 3-7 was repeated except for changing the carbon black into Pigment Blue 15:3 (CHROMOFINE BLUE) from DAINICHISEIKA COLOR & CHEMICALS MFG. CO., LTD.

### Pigment Dispersion Preparation Example 3-9

### Magenta Pigment Dispersion 3-2

The procedure for preparation of the pigment dispersion 3-7 in Pigment Dispersion Preparation Example 3-7 was repeated except for changing the carbon black into Pigment Red 122 (Toner Magenta EO02) from Clariant (Japan) K.K.

### Pigment Dispersion Preparation Example 3-10

### Yellow Pigment Dispersion 3-2

The procedure for preparation of the pigment dispersion 3-7 in Pigment Dispersion Preparation Example 3-7 was repeated except for changing the carbon black into Pigment Yellow 74 (Fast Yellow 531) from DAINICHISEIKA COLOR & CHEMICALS MFG. CO., LTD.

### Pigment Dispersion Preparation Example 3-11

### Black Pigment Dispersion 3-5

The procedure for preparation of the pigment dispersion 3-2 in Pigment Dispersion Preparation Example 3-2 was repeated except for changing the copolymer R3-4 into R3-1.

### Pigment Dispersion Preparation Example 3-12

### Black Pigment Dispersion 3-6

The procedure for preparation of the pigment dispersion 3-2 in Pigment Dispersion Preparation Example 3-2 was repeated except for changing the copolymer R3-4 into R3-2.

### Pigment Dispersion Preparation Example 3-13

### Black Pigment Dispersion 3-7

The procedure for preparation of the pigment dispersion 3-2 in Pigment Dispersion Preparation Example 3-2 was repeated except for changing the copolymer R3-4 into R3-3.

### Pigment Dispersion Preparation Example 3-14

### Black Pigment Dispersion 3-8

The procedure for preparation of the pigment dispersion 3-2 in Pigment Dispersion Preparation Example 3-2 was repeated except for changing the copolymer R3-4 into R3-5.

### Pigment Dispersion Preparation Example 3-15

### Black Pigment Dispersion 1-9

The procedure for preparation of the pigment dispersion 3-2 in Pigment Dispersion Preparation Example 3-2 was repeated except for changing the copolymer R3-4 into R3-6.

### Pigment Dispersion Preparation Example 3-16

### Black Pigment Dispersion 3-10

The procedure for preparation of the pigment dispersion 3-2 in Pigment Dispersion Preparation Example 3-2 was repeated except for changing the copolymer R3-4 into R3-7.

### Pigment Dispersion Preparation Example 3-17

### Black Pigment Dispersion 3-11

The procedure for preparation of the pigment dispersion 3-2 in Pigment Dispersion Preparation Example 3-2 was repeated except for changing the copolymer R3-4 into R3-8.

### Pigment Dispersion Preparation Example 3-18

### Black Pigment Dispersion 3-12

The procedure for preparation of the pigment dispersion 3-2 in Pigment Dispersion Preparation Example 3-2 was repeated except for changing the copolymer R3-4 into R3-9.

### Pigment Dispersion Preparation Example 3-19

### Black Pigment Dispersion 3-13

The procedure for preparation of the pigment dispersion 3-2 in Pigment Dispersion Preparation Example 3-2 was repeated except for changing the copolymer R3-4 into R3-10.

### Pigment Dispersion Preparation Example 3-20

### Black Pigment Dispersion 3-14

The procedure for preparation of the pigment dispersion 3-2 in Pigment Dispersion Preparation Example 3-2 was repeated except for changing the copolymer R3-4 into R3-11.

### Pigment Dispersion Preparation Example 3-21

### Black Pigment Dispersion 3-15

The procedure for preparation of the pigment dispersion 3-2 in Pigment Dispersion Preparation Example 3-2 was repeated except for changing the copolymer R3-4 into R3-12.

### Pigment Dispersion Preparation Example 3-22

### Black Pigment Dispersion 3-16

The procedure for preparation of the pigment dispersion 3-2 in Pigment Dispersion Preparation Example 3-2 was repeated except for changing the copolymer R3-4 into R3-13.

### Pigment Dispersion Preparation Example 3-23

### Black Pigment Dispersion 3-17

The procedure for preparation of the pigment dispersion 3-2 in Pigment Dispersion Preparation Example 3-2 was repeated except for changing the copolymer R3-4 into R3-14.

### Pigment Dispersion Preparation Example 3-24

### Black Pigment Dispersion 3-18

The procedure for preparation of the pigment dispersion 3-2 in Pigment Dispersion Preparation Example 3-2 was repeated except for changing the copolymer R3-4 into R3-15.

### Pigment Dispersion Preparation Example 3-25

### Black Pigment Dispersion 3-19

The procedure for preparation of the pigment dispersion 3-2 in Pigment Dispersion Preparation Example 3-2 was repeated except for changing the copolymer R3-4 into R3-16.

### Pigment Dispersion Preparation Example 3-26

### Black Pigment Dispersion 3-20

The procedure for preparation of the pigment dispersion 3-2 in Pigment Dispersion Preparation Example 3-2 was repeated except for changing the copolymer R3-4 into R3-17.

### Pigment Dispersion Preparation Example 3-27

### Black Pigment Dispersion 3-21

The procedure for preparation of the pigment dispersion 3-2 in Pigment Dispersion Preparation Example 3-2 was repeated except for changing the copolymer R3-4 into R3-18.

### Pigment Dispersion Preparation Example 3-28

### Black Pigment Dispersion 3-22

The procedure for preparation of the pigment dispersion 3-2 in Pigment Dispersion Preparation Example 3-2 was repeated except for changing the copolymer R3-4 into R3-19.

### Pigment Dispersion Preparation Example 3-29

### Black Pigment Dispersion 3-23

The procedure for preparation of the pigment dispersion 3-2 in Pigment Dispersion Preparation Example 3-2 was repeated except for changing the copolymer R3-4 into R3-20.

### Pigment Dispersion Preparation Example 3-30

### Black Pigment Dispersion 3-24

The procedure for preparation of the pigment dispersion 3-2 in Pigment Dispersion Preparation Example 3-2 was repeated except for changing the copolymer R3-4 into R3-21.

### Pigment Dispersion Preparation Example 3-31

### Black Pigment Dispersion 3-25

The procedure for preparation of the pigment dispersion 3-2 in Pigment Dispersion Preparation Example 3-2 was repeated except for changing the copolymer R3-4 into R3-22.

### Pigment Dispersion Preparation Example 3-32

### Black Pigment Dispersion 3-26

The procedure for preparation of the pigment dispersion 3-2 in Pigment Dispersion Preparation Example 3-2 was repeated except for changing the copolymer R3-4 into R3-23.

### Pigment Dispersion Preparation Example 3-33

### Black Pigment Dispersion 3-27

The procedure for preparation of the pigment dispersion 3-2 in Pigment Dispersion Preparation Example 3-2 was repeated except for changing the copolymer R3-4 into R3-24.

### Pigment Dispersion Preparation Example 3-34

### Black Pigment Dispersion 3-28

The procedure for preparation of the pigment dispersion 3-2 in Pigment Dispersion Preparation Example 3-2 was repeated except for changing the copolymer R3-4 into R3-25.

### Pigment Dispersion Preparation Example 3-35

### Black Pigment Dispersion 1-29

The procedure for preparation of the pigment dispersion 1-2 in Pigment Dispersion Preparation Example 1-2 was repeated except for changing the copolymer R1-13 into R1-26.

### Pigment Dispersion Preparation Example 3-36

### Black Pigment Dispersion 3-30

The procedure for preparation of the pigment dispersion 3-2 in Pigment Dispersion Preparation Example 3-2 was repeated except for changing the copolymer R3-4 into R3-27.

### Pigment Dispersion Preparation Example 3-37

### Black Pigment Dispersion 3-31

The procedure for preparation of the pigment dispersion 3-2 in Pigment Dispersion Preparation Example 3-2 was repeated except for changing the copolymer R3-4 into R3-28.

### Pigment Dispersion Preparation Example 3-38

### Black Pigment Dispersion 3-32

The procedure for preparation of the pigment dispersion 3-2 in Pigment Dispersion Preparation Example 3-2 was repeated except for changing the copolymer R3-4 into R3-29.

### Pigment Dispersion Preparation Example 3-39

### Black Pigment Dispersion 3-33

The procedure for preparation of the pigment dispersion 3-2 in Pigment Dispersion Preparation Example 3-2 was repeated except for changing the copolymer R3-4 into R3-30.

### Pigment Dispersion Preparation Example 3-40

### Black Pigment Dispersion 3-34

The procedure for preparation of the pigment dispersion 3-2 in Pigment Dispersion Preparation Example 3-2 was repeated except for changing the copolymer R3-4 into R3-31.

### Pigment Dispersion Preparation Example 3-41

### Black Pigment Dispersion 3-35

The procedure for preparation of the pigment dispersion 3-2 in Pigment Dispersion Preparation Example 3-2 was repeated except for changing the copolymer R3-4 into R3-32.

### Pigment Dispersion Preparation Example 3-42

### Black Pigment Dispersion 3-35

The procedure for preparation of the pigment dispersion 3-2 in Pigment Dispersion Preparation Example 3-2 was repeated except for changing the copolymer R3-4 into R-100.

TABLE 14-1

| | Pigment Dispersion 3- | | | | |
|---|---|---|---|---|---|
| | 1 | 2 | 3 | 4 | 5 |
| R3-1 | | | | | |
| R3-2 | | | | | |
| R3-3 | | | | | |
| R3-4 | 2 | 4 | 16 | 4 | 4 |
| R3-5 | | | | | |
| R3-6 | | | | | |
| R3-7 | | | | | |
| R3-8 | | | | | |
| R3-9 | | | | | |
| R3-10 | | | | | |
| R3-11 | | | | | |
| R3-12 | | | | | |
| R3-13 | | | | | |
| R3-14 | | | | | |
| R3-15 | | | | | |
| R3-16 | | | | | |
| R3-17 | | | | | |
| R3-18 | | | | | |
| R3-19 | | | | | |
| R3-20 | | | | | |
| R3-21 | | | | | |
| R3-22 | | | | | |
| R3-23 | | | | | |
| R3-24 | | | | | |
| R3-25 | | | | | |
| R3-26 | | | | | |
| R3-27 | | | | | |
| R3-28 | | | | | |
| R3-29 | | | | | |
| R3-30 | | | | | |
| R3-31 | | | | | |
| R3-32 | | | | | |
| R-100 | | | | | |
| RT-100(10% | | | | | |
| aqueous solution) | | | | | |
| Carbon Black | 16 | 16 | 16 | | |
| Pigment Blue 15:3 | | | | 16 | |
| Pigment Red 122 | | | | | 16 |
| Pigment Yellow 74 | | | | | |
| High-Purity Water | Balance | Balance | Balance | Balance | Balance |
| Total | 100 | 100 | 100 | 100 | 100 |

TABLE 14-2

| | Pigment Dispersion 3- | | | | | | |
|---|---|---|---|---|---|---|---|
| | 6 | 7 | 8 | 9 | 10 | 11 | 12 |
| R3-1 | | | | | | | |
| R3-2 | | | | | | | |
| R3-3 | | | | | | | |
| R3-4 | 4 | | | | | | |
| R3-5 | | | | | | | |
| R3-6 | | | | | | | |
| R3-7 | | | | | | | |
| R3-8 | | | | | | | |
| R3-9 | | | | | | | |
| R3-10 | | | | | | | |
| R3-11 | | | | | | | |
| R3-12 | | | | | | | |
| R3-13 | | | | | | | |
| R3-14 | | | | | | | |
| R3-15 | | | | | | | |
| R3-16 | | | | | | | |
| R3-17 | | | | | | | |
| R3-18 | | | | | | | |
| R3-19 | | | | | | | |
| R3-20 | | | | | | | |
| R3-21 | | | | | | | |
| R3-22 | | | | | | | |
| R3-23 | | | | | | | |
| R3-24 | | | | | | | |
| R3-25 | | | | | | | |
| R3-26 | | | | | | | |
| R3-27 | | | | | | | |
| R3-28 | | | | | | | |
| R3-29 | | | | | | | |
| R3-30 | | | | | | | |
| R3-31 | | | | | | | |
| R3-32 | | | | | | | |
| R-100 | | | | | | | |
| RT-100 (10% | | 40 | 40 | 40 | 40 | | |
| aqueous solution) | | | | | | | |
| Carbon Black | | 16 | | | | 16 | 16 |
| Pigment Blue 15:3 | | | 16 | | | | |
| Pigment Red 122 | | | | 16 | | | |
| Pigment Yellow 74 | 16 | | | | 16 | | |
| High-Purity Water | Balance | Balance | Balance | Balance | Balance | Balance | Balance |
| Total | 100 | 100 | 100 | 100 | 100 | 100 | 100 |

TABLE 14-3

| | Pigment Dispersion 3- | | | | | | |
|---|---|---|---|---|---|---|---|
| | 13 | 14 | 15 | 16 | 17 | 18 | 19 |
| R3-1 | | | | | | | |
| R3-2 | | | | | | | |
| R3-3 | 4 | | | | | | |
| R3-4 | | | | | | | |
| R3-5 | | 4 | | | | | |
| R3-6 | | | 4 | | | | |
| R3-7 | | | | 4 | | | |
| R3-8 | | | | | 4 | | |
| R3-9 | | | | | | 4 | |
| R3-10 | | | | | | | 4 |
| R3-11 | | | | | | | |
| R3-12 | | | | | | | |
| R3-13 | | | | | | | |
| R3-14 | | | | | | | |
| R3-15 | | | | | | | |
| R3-16 | | | | | | | |
| R3-17 | | | | | | | |
| R3-18 | | | | | | | |
| R3-19 | | | | | | | |
| R3-20 | | | | | | | |
| R3-21 | | | | | | | |
| R3-22 | | | | | | | |
| R3-23 | | | | | | | |
| R3-24 | | | | | | | |
| R3-25 | | | | | | | |
| R3-26 | | | | | | | |
| R3-27 | | | | | | | |
| R3-28 | | | | | | | |
| R3-29 | | | | | | | |
| R3-30 | | | | | | | |
| R3-31 | | | | | | | |
| R3-32 | | | | | | | |
| R-100 | | | | | | | |
| RT-100 (10% | | | | | | | |
| aqueous solution) | | | | | | | |
| Carbon Black | 16 | 16 | 16 | 16 | 16 | 16 | 16 |
| Pigment Blue 15:3 | | | | | | | |
| Pigment Red 122 | | | | | | | |
| Pigment Yellow 74 | | | | | | | |
| High-Purity Water | Balance | Balance | Balance | Balance | Balance | Balance | Balance |
| Total | 100 | 100 | 100 | 100 | 100 | 100 | 100 |

TABLE 14-4

| | Pigment Dispersion 3- | | | | | | |
|---|---|---|---|---|---|---|---|
| | 20 | 21 | 22 | 23 | 24 | 25 | 26 |
| R3-1 | | | | | | | |
| R3-2 | | | | | | | |
| R3-3 | | | | | | | |
| R3-4 | | | | | | | |
| R3-5 | | | | | | | |
| R3-6 | | | | | | | |
| R3-7 | | | | | | | |
| R3-8 | | | | | | | |
| R3-9 | | | | | | | |
| R3-10 | | | | | | | |
| R3-11 | 4 | | | | | | |
| R3-12 | | 4 | | | | | |
| R3-13 | | | 4 | | | | |
| R3-14 | | | | 4 | | | |
| R3-15 | | | | | 4 | | |
| R3-16 | | | | | | 4 | |
| R3-17 | | | | | | | 4 |
| R3-18 | | | | | | | |
| R3-19 | | | | | | | |
| R3-20 | | | | | | | |
| R3-21 | | | | | | | |
| R3-22 | | | | | | | |
| R3-23 | | | | | | | |
| R3-24 | | | | | | | |
| R3-25 | | | | | | | |
| R3-26 | | | | | | | |
| R3-27 | | | | | | | |
| R3-28 | | | | | | | |
| R3-29 | | | | | | | |
| R3-30 | | | | | | | |
| R3-31 | | | | | | | |
| R3-32 | | | | | | | |
| R-100 | | | | | | | |
| RT-100 (10% | | | | | | | |
| aqueous solution) | | | | | | | |
| Carbon Black | 16 | 16 | 16 | 16 | 16 | 16 | 16 |
| Pigment Blue 15:3 | | | | | | | |
| Pigment Red 122 | | | | | | | |
| Pigment Yellow 74 | | | | | | | |
| High-Purity Water | Balance | Balance | Balance | Balance | Balance | Balance | Balance |
| Total | 100 | 100 | 100 | 100 | 100 | 100 | 100 |

TABLE 14-5

| | Pigment Dispersion 3- | | | | | | |
|---|---|---|---|---|---|---|---|
| | 27 | 28 | 29 | 30 | 31 | 32 | 33 |
| R3-1 | | | | | | | |
| R3-2 | | | | | | | |
| R3-3 | | | | | | | |
| R3-4 | | | | | | | |
| R3-5 | | | | | | | |
| R3-6 | | | | | | | |
| R3-7 | | | | | | | |
| R3-8 | | | | | | | |
| R3-9 | | | | | | | |
| R3-10 | | | | | | | |
| R3-11 | | | | | | | |
| R3-12 | | | | | | | |
| R3-13 | | | | | | | |
| R3-14 | | | | | | | |
| R3-15 | | | | | | | |
| R3-16 | | | | | | | |
| R3-17 | | | | | | | |
| R3-18 | 4 | | | | | | |
| R3-19 | | 4 | | | | | |
| R3-20 | | | 4 | | | | |
| R3-21 | | | | 4 | | | |
| R3-22 | | | | | 4 | | |
| R3-23 | | | | | | 4 | |
| R3-24 | | | | | | | 4 |
| R3-25 | | | | | | | |
| R3-26 | | | | | | | |
| R3-27 | | | | | | | |
| R3-28 | | | | | | | |
| R3-29 | | | | | | | |
| R3-30 | | | | | | | |
| R3-31 | | | | | | | |
| R3-32 | | | | | | | |
| R-100 | | | | | | | |
| RT-100 (10% | | | | | | | |
| aqueous solution) | | | | | | | |
| Carbon Black | 16 | 16 | 16 | 16 | 16 | 16 | 16 |
| Pigment Blue 15:3 | | | | | | | |
| Pigment Red 122 | | | | | | | |
| Pigment Yellow 74 | | | | | | | |
| High-Purity Water | Balance | Balance | Balance | Balance | Balance | Balance | Balance |
| Total | 100 | 100 | 100 | 100 | 100 | 100 | 100 |

TABLE 14-6

| | Pigment Dispersion 3- | | | | | | |
|---|---|---|---|---|---|---|---|
| | 34 | 35 | 36 | 37 | 38 | 39 | 40 |
| R3-1 | | | | | | | |
| R3-2 | | | | | | | |
| R3-3 | | | | | | | |
| R3-4 | | | | | | | |
| R3-5 | | | | | | | |
| R3-6 | | | | | | | |
| R3-7 | | | | | | | |
| R3-8 | | | | | | | |
| R3-9 | | | | | | | |
| R3-10 | | | | | | | |
| R3-11 | | | | | | | |
| R3-12 | | | | | | | |
| R3-13 | | | | | | | |
| R3-14 | | | | | | | |
| R3-15 | | | | | | | |
| R3-16 | | | | | | | |
| R3-17 | | | | | | | |
| R3-18 | | | | | | | |
| R3-19 | | | | | | | |
| R3-20 | | | | | | | |
| R3-21 | | | | | | | |
| R3-22 | | | | | | | |
| R3-23 | | | | | | | |
| R3-24 | | | | | | | |
| R3-25 | 4 | | | | | | |
| R3-26 | | 4 | | | | | |
| R3-27 | | | 4 | | | | |
| R3-28 | | | | 4 | | | |
| R3-29 | | | | | 4 | | |
| R3-30 | | | | | | 4 | |
| R3-31 | | | | | | | 4 |
| R3-32 | | | | | | | |
| R-100 | | | | | | | |
| RT-100 (10% | | | | | | | |
| aqueous solution) | | | | | | | |
| Carbon Black | 16 | 16 | 16 | 16 | 16 | 16 | 16 |
| Pigment Blue 15:3 | | | | | | | |
| Pigment Red 122 | | | | | | | |
| Pigment Yellow 74 | | | | | | | |
| High-Purity Water | Balance | Balance | Balance | Balance | Balance | Balance | Balance |
| Total | 100 | 100 | 100 | 100 | 100 | 100 | 100 |

TABLE 14-7

Pigment
Dispersion 3-

| | 41 | 42 |
|---|---|---|
| R3-1 | | |
| R3-2 | | |
| R3-3 | | |
| R3-4 | | |
| R3-5 | | |
| R3-6 | | |
| R3-7 | | |
| R3-8 | | |
| R3-9 | | |
| R3-10 | | |
| R3-11 | | |
| R3-12 | | |
| R3-13 | | |
| R3-14 | | |
| R3-15 | | |
| R3-16 | | |
| R3-17 | | |
| R3-18 | | |
| R3-19 | | |
| R3-20 | | |
| R3-21 | | |
| R3-22 | | |
| R3-23 | | |
| R3-24 | | |
| R3-25 | 4 | |
| R3-26 | | 4 |
| R3-27 | | |
| R3-28 | | |
| R3-29 | | |
| R3-30 | | |
| R3-31 | | |
| R3-32 | 4 | |
| R-100 | | 4 |
| RT-100(10% | | |
| aqueous solution) | | |
| Carbon Black | 16 | 16 |
| Pigment Blue 15:3 | | |
| Pigment Red 122 | | |
| Pigment Yellow 74 | | |
| High-Purity Water | Balance | Balance |
| Total | 100 | 100 |

### Examples 3-1 to 3-40 and Comparative Examples 3-1 to 3-5

Ink compositions of Examples 3-1 to 3-40 and Comparative Examples 3-1 to 3-5 are shown in Table 15-1 to 15-7. The numbers are % by weight.

TABLES 15-1

| | | | Example 3- | | |
|---|---|---|---|---|---|
| | | | 1 | 2 | 3 |
| Pigment | Pigment dispersion 3-1 | R3-4-16/2_Bk | 50 | | |
| Dispersion | Pigment dispersion 3-2 | R3-4-16/4_Bk | | 50 | 50 |
| | Pigment dispersion 3-3 | R3-4-16/16_Bk | | | |
| | Pigment dispersion 3-4 | R3-4-16/4_Cy | | | |
| | Pigment dispersion 3-5 | R3-4-16/4_Ma | | | |
| | Pigment dispersion 3-6 | R3-4-16/4_Ye | | | |
| | Pigment dispersion 3-7 | RT-100_Bk | | | |
| | Pigment dispersion 3-8 | RT-100_Cy | | | |
| | Pigment dispersion 3-9 | RT-100_Ma | | | |
| | Pigment dispersion 3-10 | RT-100_Ye | | | |
| | Pigment dispersion 3-11 | R3-1-16/4_Bk | | | |
| | Pigment dispersion 3-12 | R3-2-16/4_Bk | | | |
| | Pigment dispersion 3-13 | R3-3-16/4_Bk | | | |
| | Pigment dispersion 3-14 | R3-5-16/4_Bk | | | |
| | Pigment dispersion 3-15 | R3-6-16/4_Bk | | | |
| | Pigment dispersion 3-16 | R3-7-16/4_Bk | | | |
| | Pigment dispersion 3-17 | R3-8-16/4_Bk | | | |
| | Pigment dispersion 3-18 | R3-9-16/4_Bk | | | |
| | Pigment dispersion 3-19 | R3-10-16/4_Bk | | | |
| | Pigment dispersion 3-20 | R3-11-16/4_Bk | | | |
| | Pigment dispersion 3-21 | R3-12-16/4_Bk | | | |
| | Pigment dispersion 3-22 | R3-13-16/4_Bk | | | |
| | Pigment dispersion 3-23 | R3-14-16/4_Bk | | | |
| | Pigment dispersion 3-24 | R3-15-16/4_Bk | | | |
| | Pigment dispersion 3-25 | R3-16-16/4_Bk | | | |
| | Pigment dispersion 3-26 | R3-17-16/4_Bk | | | |
| | Pigment dispersion 3-27 | R3-18-16/4_Bk | | | |
| | Pigment dispersion 3-28 | R3-19-16/4_Bk | | | |
| | Pigment dispersion 3-29 | R3-20-16/4_Bk | | | |
| | Pigment dispersion 3-30 | R3-21-16/4_Bk | | | |
| | Pigment dispersion 3-31 | R3-22-16/4_Bk | | | |
| | Pigment dispersion 3-32 | R3-23-16/4_Bk | | | |
| | Pigment dispersion 3-33 | R3-24-16/4_Bk | | | |
| | Pigment dispersion 3-34 | R3-25-16/4_Bk | | | |
| | Pigment dispersion 3-35 | R3-26-16/4_Bk | | | |
| | Pigment dispersion 3-36 | R3-27-16/4_Bk | | | |
| | Pigment dispersion 3-37 | R3-28-16/4_Bk | | | |
| | Pigment dispersion 3-38 | R3-29-16/4_Bk | | | |
| | Pigment dispersion 3-39 | R3-30-16/4_Bk | | | |
| | Pigment dispersion 3-40 | R3-31-16/4_Bk | | | |
| | Pigment dispersion 3-41 | R3-32-16/4_Bk | | | |
| | Pigment dispersion 3-42 | R-100-16/4_Bk | | | |
| Additive | R3-4 | | | | |
| Water- | Glycerin | 10 | 10 | 10 | |
| soluble | 1,3-butanediol | 20 | 20 | 20 | 30 |
| solvent | Trimethylol propane | | | | |
| | 2-pyrrolidone | | | | |
| Solvent | High-purity water | Balance | Balance | Balance | Balance |
| | Total | 100 | 100 | 100 | 100 |

TABLE 15-2

| | | Example 3- | | | | | | | |
|---|---|---|---|---|---|---|---|---|---|
| | | 4 | 5 | 6 | 7 | 8 | 9 | 10 | 11 |
| Pigment | Pigment dispersion 3-1 | | | | | | | | |
| Dispersion | Pigment dispersion 3-2 | 50 | | | | | | | |
| | Pigment dispersion 3-3 | | 50 | | | | | | |
| | Pigment dispersion 3-4 | | | 30 | | | | | |
| | Pigment dispersion 3-5 | | | | 50 | | | | |
| | Pigment dispersion 3-6 | | | | | 30 | | | |
| | Pigment dispersion 3-7 | | | | | | 50 | | |
| | Pigment dispersion 3-8 | | | | | | | | |
| | Pigment dispersion 3-9 | | | | | | | | |
| | Pigment dispersion 3-10 | | | | | | | | |
| | Pigment dispersion 3-11 | | | | | | | 50 | |
| | Pigment dispersion 3-12 | | | | | | | | 50 |
| | Pigment dispersion 3-13 | | | | | | | | |
| | Pigment dispersion 3-14 | | | | | | | | |
| | Pigment dispersion 3-15 | | | | | | | | |
| | Pigment dispersion 3-16 | | | | | | | | |
| | Pigment dispersion 3-17 | | | | | | | | |
| | Pigment dispersion 3-18 | | | | | | | | |
| | Pigment dispersion 3-19 | | | | | | | | |
| | Pigment dispersion 3-20 | | | | | | | | |
| | Pigment dispersion 3-21 | | | | | | | | |
| | Pigment dispersion 3-22 | | | | | | | | |
| | Pigment dispersion 3-23 | | | | | | | | |
| | Pigment dispersion 3-24 | | | | | | | | |
| | Pigment dispersion 3-25 | | | | | | | | |
| | Pigment dispersion 3-26 | | | | | | | | |
| | Pigment dispersion 3-27 | | | | | | | | |
| | Pigment dispersion 3-28 | | | | | | | | |
| | Pigment dispersion 3-29 | | | | | | | | |
| | Pigment dispersion 3-30 | | | | | | | | |
| | Pigment dispersion 3-31 | | | | | | | | |
| | Pigment dispersion 3-32 | | | | | | | | |
| | Pigment dispersion 3-33 | | | | | | | | |
| | Pigment dispersion 3-34 | | | | | | | | |
| | Pigment dispersion 3-35 | | | | | | | | |
| | Pigment dispersion 3-36 | | | | | | | | |
| | Pigment dispersion 3-37 | | | | | | | | |
| | Pigment dispersion 3-38 | | | | | | | | |
| | Pigment dispersion 3-39 | | | | | | | | |
| | Pigment dispersion 3-40 | | | | | | | | |
| | Pigment dispersion 3-41 | | | | | | | | |
| | Pigment dispersion 3-42 | | | | | | | | |
| Additive | R3-4 | | | | | | 4 | | |
| Water- | Glycerin | 20 | 10 | 10 | 10 | 10 | 10 | 10 | 10 |
| soluble | 1,3-butanediol | | 20 | 20 | 20 | 20 | 20 | 20 | 20 |
| solvent | Trimethylol propane | 5 | | | | | | | |
| | 2-pyrrolidone | 5 | | | | | | | |
| Solvent | High-purity water | Balance | Balance | Balance | Balance | Balance | Balance | Balance | Balance |
| | Total | 100 | 100 | 100 | 100 | 100 | 100 | 100 | 100 |

TABLE 15-3

| | | Example 3- | | | | | | | |
|---|---|---|---|---|---|---|---|---|---|
| | | 12 | 13 | 14 | 15 | 16 | 17 | 18 | 19 |
| Pigment | Pigment dispersion 3-1 | | | | | | | | |
| Dispersion | Pigment dispersion 3-2 | | | | | | | | |
| | Pigment dispersion 3-3 | | | | | | | | |
| | Pigment dispersion 3-4 | | | | | | | | |
| | Pigment dispersion 3-5 | | | | | | | | |
| | Pigment dispersion 3-6 | | | | | | | | |
| | Pigment dispersion 3-7 | | | | | | | | |
| | Pigment dispersion 3-8 | | | | | | | | |
| | Pigment dispersion 3-9 | | | | | | | | |
| | Pigment dispersion 3-10 | | | | | | | | |
| | Pigment dispersion 3-11 | | | | | | | | |
| | Pigment dispersion 3-12 | | | | | | | | |
| | Pigment dispersion 3-13 | 50 | | | | | | | |
| | Pigment dispersion 3-14 | | 50 | | | | | | |
| | Pigment dispersion 3-15 | | | 50 | | | | | |
| | Pigment dispersion 3-16 | | | | 50 | | | | |
| | Pigment dispersion 3-17 | | | | | 50 | | | |
| | Pigment dispersion 3-18 | | | | | | 50 | | |
| | Pigment dispersion 3-19 | | | | | | | 50 | |
| | Pigment dispersion 3-20 | | | | | | | | 50 |
| | Pigment dispersion 3-21 | | | | | | | | |
| | Pigment dispersion 3-22 | | | | | | | | |
| | Pigment dispersion 3-23 | | | | | | | | |
| | Pigment dispersion 3-24 | | | | | | | | |
| | Pigment dispersion 3-25 | | | | | | | | |
| | Pigment dispersion 3-26 | | | | | | | | |
| | Pigment dispersion 3-27 | | | | | | | | |
| | Pigment dispersion 3-28 | | | | | | | | |
| | Pigment dispersion 3-29 | | | | | | | | |
| | Pigment dispersion 3-30 | | | | | | | | |
| | Pigment dispersion 3-31 | | | | | | | | |
| | Pigment dispersion 3-32 | | | | | | | | |
| | Pigment dispersion 3-33 | | | | | | | | |
| | Pigment dispersion 3-34 | | | | | | | | |
| | Pigment dispersion 3-35 | | | | | | | | |
| | Pigment dispersion 3-36 | | | | | | | | |
| | Pigment dispersion 3-37 | | | | | | | | |
| | Pigment dispersion 3-38 | | | | | | | | |
| | Pigment dispersion 3-39 | | | | | | | | |
| | Pigment dispersion 3-40 | | | | | | | | |
| | Pigment dispersion 3-41 | | | | | | | | |
| | Pigment dispersion 3-42 | | | | | | | | |
| Additive | R3-4 | | | | | | | | |
| Water- | Glycerin | 10 | 10 | 10 | 10 | 10 | 10 | 10 | 10 |
| soluble | 1,3-butanediol | 20 | 20 | 20 | 20 | 20 | 20 | 20 | 20 |
| solvent | Trimethylol propane | | | | | | | | |
| | 2-pyrrolidone | | | | | | | | |
| Solvent | High-purity water | Balance | Balance | Balance | Balance | Balance | Balance | Balance | Balance |
| | Total | 100 | 100 | 100 | 100 | 100 | 100 | 100 | 100 |

TABLE 15-4

| | | Example 3- | | | | | | | |
|---|---|---|---|---|---|---|---|---|---|
| | | 20 | 21 | 22 | 23 | 24 | 25 | 26 | 27 |
| Pigment | Pigment dispersion 3-1 | | | | | | | | |
| Dispersion | Pigment dispersion 3-2 | | | | | | | | |
| | Pigment dispersion 3-3 | | | | | | | | |
| | Pigment dispersion 3-4 | | | | | | | | |
| | Pigment dispersion 3-5 | | | | | | | | |
| | Pigment dispersion 3-6 | | | | | | | | |
| | Pigment dispersion 3-7 | | | | | | | | |
| | Pigment dispersion 3-8 | | | | | | | | |
| | Pigment dispersion 3-9 | | | | | | | | |
| | Pigment dispersion 3-10 | | | | | | | | |
| | Pigment dispersion 3-11 | | | | | | | | |
| | Pigment dispersion 3-12 | | | | | | | | |
| | Pigment dispersion 3-13 | | | | | | | | |
| | Pigment dispersion 3-14 | | | | | | | | |
| | Pigment dispersion 3-15 | | | | | | | | |
| | Pigment dispersion 3-16 | | | | | | | | |
| | Pigment dispersion 3-17 | | | | | | | | |
| | Pigment dispersion 3-18 | | | | | | | | |
| | Pigment dispersion 3-19 | | | | | | | | |
| | Pigment dispersion 3-20 | | | | | | | | |
| | Pigment dispersion 3-21 | 50 | | | | | | | |
| | Pigment dispersion 3-22 | | 50 | | | | | | |
| | Pigment dispersion 3-23 | | | 50 | | | | | |
| | Pigment dispersion 3-24 | | | | 50 | | | | |
| | Pigment dispersion 3-25 | | | | | 50 | | | |
| | Pigment dispersion 3-26 | | | | | | 50 | | |
| | Pigment dispersion 3-27 | | | | | | | 50 | |
| | Pigment dispersion 3-28 | | | | | | | | 50 |
| | Pigment dispersion 3-29 | | | | | | | | |
| | Pigment dispersion 3-30 | | | | | | | | |
| | Pigment dispersion 3-31 | | | | | | | | |
| | Pigment dispersion 3-32 | | | | | | | | |
| | Pigment dispersion 3-33 | | | | | | | | |
| | Pigment dispersion 3-34 | | | | | | | | |
| | Pigment dispersion 3-35 | | | | | | | | |
| | Pigment dispersion 3-36 | | | | | | | | |
| | Pigment dispersion 3-37 | | | | | | | | |
| | Pigment dispersion 3-38 | | | | | | | | |
| | Pigment dispersion 3-39 | | | | | | | | |
| | Pigment dispersion 3-40 | | | | | | | | |
| | Pigment dispersion 3-41 | | | | | | | | |
| | Pigment dispersion 3-42 | | | | | | | | |
| Additive | R3-4 | | | | | | | | |
| Water- | Glycerin | 10 | 10 | 10 | 10 | 10 | 10 | 10 | 10 |
| soluble | 1,3-butanediol | 20 | 20 | 20 | 20 | 20 | 20 | 20 | 20 |
| solvent | Trimethylol propane | | | | | | | | |
| | 2-pyrrolidone | | | | | | | | |
| Solvent | High-purity water | Balance | Balance | Balance | Balance | Balance | Balance | Balance | Balance |
| | Total | 100 | 100 | 100 | 100 | 100 | 100 | 100 | 100 |

TABLE 15-5

| | | Example 3- | | | | | | | |
|---|---|---|---|---|---|---|---|---|---|
| | | 28 | 29 | 30 | 31 | 32 | 33 | 34 | 35 |
| Pigment | Pigment dispersion 3-1 | | | | | | | | |
| Dispersion | Pigment dispersion 3-2 | | | | | | | | |
| | Pigment dispersion 3-3 | | | | | | | | |
| | Pigment dispersion 3-4 | | | | | | | | |
| | Pigment dispersion 3-5 | | | | | | | | |
| | Pigment dispersion 3-6 | | | | | | | | |
| | Pigment dispersion 3-7 | | | | | | | | |
| | Pigment dispersion 3-8 | | | | | | | | |
| | Pigment dispersion 3-9 | | | | | | | | |
| | Pigment dispersion 3-10 | | | | | | | | |
| | Pigment dispersion 3-11 | | | | | | | | |
| | Pigment dispersion 3-12 | | | | | | | | |
| | Pigment dispersion 3-13 | | | | | | | | |
| | Pigment dispersion 3-14 | | | | | | | | |
| | Pigment dispersion 3-15 | | | | | | | | |
| | Pigment dispersion 3-16 | | | | | | | | |
| | Pigment dispersion 3-17 | | | | | | | | |
| | Pigment dispersion 3-18 | | | | | | | | |
| | Pigment dispersion 3-19 | | | | | | | | |
| | Pigment dispersion 3-20 | | | | | | | | |
| | Pigment dispersion 3-21 | | | | | | | | |
| | Pigment dispersion 3-22 | | | | | | | | |
| | Pigment dispersion 3-23 | | | | | | | | |
| | Pigment dispersion 3-24 | | | | | | | | |
| | Pigment dispersion 3-25 | | | | | | | | |
| | Pigment dispersion 3-26 | | | | | | | | |
| | Pigment dispersion 3-27 | | | | | | | | |
| | Pigment dispersion 3-28 | | | | | | | | |
| | Pigment dispersion 3-29 | 50 | | | | | | | |
| | Pigment dispersion 3-30 | | 50 | | | | | | |
| | Pigment dispersion 3-31 | | | 50 | | | | | |
| | Pigment dispersion 3-32 | | | | 50 | | | | |
| | Pigment dispersion 3-33 | | | | | 50 | | | |
| | Pigment dispersion 3-34 | | | | | | 50 | | |
| | Pigment dispersion 3-35 | | | | | | | 50 | |
| | Pigment dispersion 3-36 | | | | | | | | 50 |
| | Pigment dispersion 3-37 | | | | | | | | |
| | Pigment dispersion 3-38 | | | | | | | | |
| | Pigment dispersion 3-39 | | | | | | | | |
| | Pigment dispersion 3-40 | | | | | | | | |
| | Pigment dispersion 3-41 | | | | | | | | |
| | Pigment dispersion 3-42 | | | | | | | | |
| Additive | R3-4 | | | | | | | | |
| Water- | Glycerin | 10 | 10 | 10 | 10 | 10 | 10 | 10 | 10 |
| soluble | 1,3-butanediol | 20 | 20 | 20 | 20 | 20 | 20 | 20 | 20 |
| solvent | Trimethylol propane | | | | | | | | |
| | 2-pyrrolidone | | | | | | | | |
| Solvent | High-purity water | Balance | Balance | Balance | Balance | Balance | Balance | Balance | Balance |
| | Total | 100 | 100 | 100 | 100 | 100 | 100 | 100 | 100 |

TABLE 15-6

| | | Example 3- | | | | |
|---|---|---|---|---|---|---|
| | | 36 | 37 | 38 | 39 | 40 |
| Pigment | Pigment dispersion 3-1 | | | | | |
| Dispersion | Pigment dispersion 3-2 | | | | | |
| | Pigment dispersion 3-3 | | | | | |
| | Pigment dispersion 3-4 | | | | | |
| | Pigment dispersion 3-5 | | | | | |
| | Pigment dispersion 3-6 | | | | | |
| | Pigment dispersion 3-7 | | | | | |
| | Pigment dispersion 3-8 | | | | | |
| | Pigment dispersion 3-9 | | | | | |
| | Pigment dispersion 3-10 | | | | | |
| | Pigment dispersion 3-11 | | | | | |
| | Pigment dispersion 3-12 | | | | | |
| | Pigment dispersion 3-13 | | | | | |
| | Pigment dispersion 3-14 | | | | | |
| | Pigment dispersion 3-15 | | | | | |
| | Pigment dispersion 3-16 | | | | | |
| | Pigment dispersion 3-17 | | | | | |
| | Pigment dispersion 3-18 | | | | | |
| | Pigment dispersion 3-19 | | | | | |
| | Pigment dispersion 3-20 | | | | | |
| | Pigment dispersion 3-21 | | | | | |
| | Pigment dispersion 3-22 | | | | | |
| | Pigment dispersion 3-23 | | | | | |
| | Pigment dispersion 3-24 | | | | | |
| | Pigment dispersion 3-25 | | | | | |
| | Pigment dispersion 3-26 | | | | | |
| | Pigment dispersion 3-27 | | | | | |
| | Pigment dispersion 3-28 | | | | | |
| | Pigment dispersion 3-29 | | | | | |
| | Pigment dispersion 3-30 | | | | | |
| | Pigment dispersion 3-31 | | | | | |
| | Pigment dispersion 3-32 | | | | | |
| | Pigment dispersion 3-33 | | | | | |
| | Pigment dispersion 3-34 | | | | | |
| | Pigment dispersion 3-35 | | | | | |
| | Pigment dispersion 3-36 | | | | | |
| | Pigment dispersion 3-37 | 50 | | | | |
| | Pigment dispersion 3-38 | | 50 | | | |
| | Pigment dispersion 3-39 | | | 50 | | |
| | Pigment dispersion 3-40 | | | | 50 | |
| | Pigment dispersion 3-41 | | | | | 50 |
| | Pigment dispersion 3-42 | | | | | |
| Additive | R3-4 | | | | | |
| Water- | Glycerin | 10 | 10 | 10 | 10 | 10 |
| soluble | 1,3-butanediol | 20 | 20 | 20 | 20 | 20 |
| solvent | Trimethylol propane | | | | | |
| | 2-pyrrolidone | | | | | |
| Solvent | High-purity water | Balance | Balance | Balance | Balance | Balance |
| | Total | 100 | 100 | 100 | 100 | 100 |

TABLE 15-7

| | | Comparative Example 3- | | | | |
|---|---|---|---|---|---|---|
| | | 1 | 2 | 3 | 4 | 5 |
| Pigment | Pigment dispersion 3-1 | | | | | |
| Dispersion | Pigment dispersion 3-2 | | | | | |
| | Pigment dispersion 3-3 | | | | | |
| | Pigment dispersion 3-4 | | | | | |
| | Pigment dispersion 3-5 | | | | | |
| | Pigment dispersion 3-6 | | | | | |
| | Pigment dispersion 3-7 | | 50 | | | |
| | Pigment dispersion 3-8 | | | 30 | | |
| | Pigment dispersion 3-9 | | | | 50 | |
| | Pigment dispersion 3-10 | | | | | 30 |
| | Pigment dispersion 3-11 | | | | | |
| | Pigment dispersion 3-12 | | | | | |
| | Pigment dispersion 3-13 | | | | | |
| | Pigment dispersion 3-14 | | | | | |
| | Pigment dispersion 3-15 | | | | | |
| | Pigment dispersion 3-16 | | | | | |
| | Pigment dispersion 3-17 | | | | | |
| | Pigment dispersion 3-18 | | | | | |
| | Pigment dispersion 3-19 | | | | | |
| | Pigment dispersion 3-20 | | | | | |
| | Pigment dispersion 3-21 | | | | | |
| | Pigment dispersion 3-22 | | | | | |
| | Pigment dispersion 3-23 | | | | | |
| | Pigment dispersion 3-24 | | | | | |
| | Pigment dispersion 3-25 | | | | | |
| | Pigment dispersion 3-26 | | | | | |
| | Pigment dispersion 3-27 | | | | | |
| | Pigment dispersion 3-28 | | | | | |
| | Pigment dispersion 3-29 | | | | | |
| | Pigment dispersion 3-30 | | | | | |
| | Pigment dispersion 3-31 | | | | | |
| | Pigment dispersion 3-32 | | | | | |
| | Pigment dispersion 3-33 | | | | | |
| | Pigment dispersion 3-34 | | | | | |
| | Pigment dispersion 3-35 | | | | | |
| | Pigment dispersion 3-36 | | | | | |
| | Pigment dispersion 3-37 | | | | | |
| | Pigment dispersion 3-38 | | | | | |
| | Pigment dispersion 3-39 | | | | | |
| | Pigment dispersion 3-40 | | | | | |
| | Pigment dispersion 3-41 | | | | | |
| | Pigment dispersion 3-42 | 50 | | | | |
| Additive | R3-4 | | | | | |
| Water- | Glycerin | 10 | 10 | 10 | 10 | 10 |
| soluble | 1,3-butanediol | 20 | 20 | 20 | 20 | 20 |
| solvent | Trimethylol propane | | | | | |
| | 2-pyrrolidone | | | | | |
| Solvent | High-purity water | Balance | Balance | Balance | Balance | Balance |
| | Total | 100 | 100 | 100 | 100 | 100 |

The inks were prepared by the following method.

First, the materials shown in Tables 15-1 to 15-7 were mixed and stirred for 1 hr to be uniformly mixed. The resultant dispersion was subjected to pressure filtration by a polyvinylidenefluoride membrane filter having an average pore diameter of 5.0 μm to remove coarse particles and dusts. Thus, a recording ink was prepared.

Next, the inkjet inks in Examples 3-1 to 3-40 and Comparative Examples 3-1 to 3-5 were evaluated. The results are shown in Table 16.

As an index of dispersion stability of each of the inks, the initial viscosity thereof s was measured by a viscometer RE80L from TOKI SANGYO CO., LTD. at 25° C., adjusting the rotational number at from 50 to 100 rpm according the viscosities to evaluate under the following standard.

### [Evaluation Standard]

Good: less than 8 mPa·s

Average: not less than 8 mPa·s and less than 20 mPa·s

Poor: not less than 20 mPa·s

### <Image Density>

Printed images by the inks of Examples 3-1 to 3-40 and Comparative Examples 3-1 to 3-5 were evaluated.

A drive voltage of piezo element of an inkjet printer IPSiO GX5000 from Ricoh Company, Ltd. was changed to uniformly discharge the ink such that the same amount of the ink adheres to a recording material.

After a chart on which general marks JIS X 0208 (1997) and 2223 of black and each color having 64 point are described by Microsoft Word 2003 was printed on My Paper having a weight of 69.6 g/m², a sizing degree of 23.2 sec and an air permeability of 21.0 sec, the image density of the general marks JIS X 0208 (1997) and 2223 was evaluated using X-Rite938 from X-Rite, Inc. Then, the printing mode was “plain paper-fast” mode by a driver of the printer. The general marks JIS X 0208 (1997) and 2223 has the outer form of a square and the whole surface was filled with ink.

Image density was evaluated under the following standard.

### [Evaluation Standard]

Excellent: OD value Black not less than 1.30
Yellow not less than 0.80
Magenta not less than 1.00
Cyan not less than 1.10

Good: OD value Black not less than 1.20 less than 1.30
Yellow not less than 0.75 less than 0.80
Magenta not less than 0.90 less than 1.00
Cyan not less than 1.00 less than 1.10

Average: OD value Black not less than 1.10 less than 1.20
Yellow not less than 0.70 less than 0.75
Magenta not less than 0.80 less than 0.90
Cyan not less than 0.90 less than 1.00

Fair: OD value Black not less than 1.00 less than 1.10
Yellow not less than 0.65 less than 0.70
Magenta not less than 0.70 less than 0.80
Cyan not less than 0.80 less than 0.90

Poor: OD value Black less than 1.00
Yellow less than 0.65
Magenta less than 0.70
Cyan less than 0.80

### <Ink Preservation Stability>

The viscosity after stored at 60° C. for 2 weeks was measured to evaluate under the following standard, compared with the initial viscosity.

### [Evaluation Standard]

Excellent: less than 5%

Good: not less than 5% less than 25%

Fair: not less than 25% less than 50%

Poor: not less than 50%

TABLE 16

| | | Evaluation | | |
|---|---|---|---|---|
| | | Image Density | Viscosity | Preservability |
| Example 3-1 | Pigment Dispersion 3-1 | Excellent | Good | Good |
| Example 3-2 | Pigment Dispersion 3-2 | Excellent | Good | Good |
| Example 3-3 | Pigment Dispersion 3-2 | Excellent | Good | Good |
| Example 3-4 | Pigment Dispersion 3-2 | Excellent | Good | Good |
| Example 3-5 | Pigment Dispersion 3-3 | Excellent | Good | Good |
| Example 3-6 | Pigment Dispersion 3-4 | Excellent | Good | Good |
| Example 3-7 | Pigment Dispersion 3-5 | Excellent | Good | Good |
| Example 3-8 | Pigment Dispersion 3-6 | Excellent | Good | Good |
| Example 3-9 | Pigment Dispersion 3-7 | Good | Average | Good |
| Example 3-10 | Pigment Dispersion 3-11 | Excellent | Average | Good |
| Example 3-11 | Pigment Dispersion 3-12 | Excellent | Average | Good |
| Example 3-12 | Pigment Dispersion 3-13 | Excellent | Average | Good |
| Example 3-13 | Pigment Dispersion 3-14 | Excellent | Good | Good |
| Example 3-14 | Pigment Dispersion 3-15 | Excellent | Good | Good |
| Example 3-15 | Pigment Dispersion 3-16 | Excellent | Good | Good |
| Example 3-16 | Pigment Dispersion 3-17 | Excellent | Good | Good |
| Example 3-17 | Pigment Dispersion 3-18 | Excellent | Good | Good |
| Example 3-18 | Pigment Dispersion 3-19 | Excellent | Good | Good |
| Example 3-19 | Pigment Dispersion 3-20 | Excellent | Good | Good |
| Example 3-20 | Pigment Dispersion 3-21 | Excellent | Good | Good |
| Example 3-21 | Pigment Dispersion 3-22 | Excellent | Good | Good |
| Example 3-22 | Pigment Dispersion 3-23 | Good | Good | Good |
| Example 3-23 | Pigment Dispersion 3-24 | Good | Good | Good |
| Example 3-24 | Pigment Dispersion 3-25 | Excellent | Average | Good |
| Example 3-25 | Pigment Dispersion 3-26 | Excellent | Average | Good |
| Example 3-26 | Pigment Dispersion 3-27 | Good | Good | Good |
| Example 3-27 | Pigment Dispersion 3-28 | Good | Good | Good |
| Example 3-28 | Pigment Dispersion 3-29 | Excellent | Average | Fair |
| Example 3-29 | Pigment Dispersion 3-30 | Excellent | Average | Fair |
| Example 3-30 | Pigment Dispersion 3-31 | Average | Good | Good |
| Example 3-31 | Pigment Dispersion 3-32 | Average | Good | Good |
| Example 3-32 | Pigment Dispersion 3-33 | Average | Good | Good |
| Example 3-33 | Pigment Dispersion 3-34 | Good | Average | Good |
| Example 3-34 | Pigment Dispersion 3-35 | Average | Good | Fair |
| Example 3-35 | Pigment Dispersion 3-36 | Good | Average | Fair |
| Example 3-36 | Pigment Dispersion 3-37 | Excellent | Good | Good |
| Example 3-37 | Pigment Dispersion 3-38 | Excellent | Good | Good |
| Example 3-38 | Pigment Dispersion 3-39 | Excellent | Good | Good |
| Example 3-39 | Pigment Dispersion 3-40 | Excellent | Good | Good |
| Example 3-40 | Pigment Dispersion 3-41 | Excellent | Good | Good |
| Comparative | Pigment Dispersion 3-42 | Good | Average | Poor |
| Example 3-1 | | | | |
| Comparative | Pigment Dispersion 3-7 | Fair | Average | Poor |
| Example 3-2 | | | | |
| Comparative | Pigment Dispersion 3-8 | Fair | Average | Poor |
| Example 3-3 | | | | |
| Comparative | Pigment Dispersion 3-9 | Fair | Average | Poor |
| Example 3-4 | | | | |
| Comparative | Pigment Dispersion 3-10 | Fair | Average | Poor |
| Example 3-5 | | | | |

Having now fully described the invention, it will be apparent to one of ordinary skill in the art that many changes and modifications can be made thereto without departing from the spirit and scope of the invention as set forth therein.

What is claimed is:

1. An ink for inkjet recording, comprising:
Water;
a water-soluble solvent;
a pigment; and
a copolymer comprising a salt of phosphonic acid group,
wherein the copolymer comprising a salt of phosphonic acid group comprises structural units having the following formulae (1) and (2) or (3): 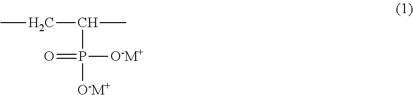
wherein not less than half or all of M⁺ represent a cation of alkali metals or an organic ammonium ion, and the rest represents proton; 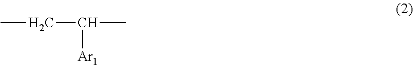
wherein Ar₁ represents a monovalent group of benzene or naphthalene; and 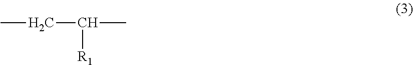
wherein R₁ represents an alkyl group having 5 to 20 carbon atoms.

2. The ink for inkjet recording of claim 1, wherein the copolymer comprising a salt of phosphonic acid group comprises the structural units having the formulae (1), (2) and (3).

3. The ink for inkjet recording of claim 1, wherein the copolymer comprising a salt of phosphonic acid group comprises the structural unit having the formula (1) in an amount of from 20 to 60% by weight.

4. The ink for inkjet recording of claim 3, wherein the copolymer comprising a salt of phosphonic acid group comprises the structural unit having the formula (1) in an amount of from 30 to 60% by weight.

5. The ink for inkjet recording of claim 1, wherein an aqueous solution comprising the copolymer comprising a salt of phosphonic acid group in an amount of 10% by weight has a viscosity of from 2.0 to 35 mPa·s at 25° C.

6. The ink for inkjet recording of claim 1, wherein the copolymer comprising a salt of phosphonic acid group is synthesized from a vinyl phosphonic acid group and a monomer having the following formula (4) or (5) as starting materials: 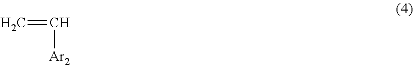
wherein Ar₂ represents a monovalent group of benzene or naphthalene; 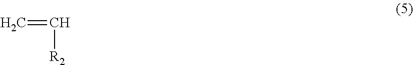
R₂ represents an alkyl group having 5 to 20 carbon atoms.

7. The ink for inkjet recording of claim 6, wherein the copolymer comprising a salt of phosphonic acid group is synthesized from a vinyl phosphonic acid group and a monomer having the formulae (4) and (5) as starting materials.

8. An ink container, comprising an ink containing unit comprising the ink for inkjet recording according to claim 1.

9. An inkjet recorder, comprising an inkjet head configured to discharge the ink for inkjet recording of claim 1 to record information or an image on a recording medium.

10. A method of preparing a recorded material, comprising:
discharging the ink for inkjet recording of claim 1 from an inkjet head to record information or an image on a recording medium.

11. A recorded material, on which information or an image is recorded with the ink for inkjet recording according to claim 1.
